(19) United States
(12) Patent Application Publication
(10) Pub. No.: US 2025/0165419 A1
(43) Pub. Date: May 22, 2025

(54) Managing In-Vehicle Ecosystems

(71) Applicant: NeoDigit LLC, Farmers Branch, TX (US)

(72) Inventor: Jugal K. Sharma, Farmers Branch, TX (US)

(73) Assignee: NeoDigit LLC, Farmers Branch, TX (US)

(21) Appl. No.: 18/733,629

(22) Filed: Jun. 4, 2024

Related U.S. Application Data
(63) Continuation of application No. 18/670,471, filed on May 21, 2024.
(60) Provisional application No. 63/601,504, filed on Nov. 21, 2023.
(60) Provisional application No. 63/553,037, filed on Feb. 13, 2024.

(51) Int. Cl. G06F 13/36

(52) U.S. Cl. CPC G06F 13/36; G06F 2213/40

(57) ABSTRACT

The present disclosure generally relates to in-vehicle entertainment systems and/or applications. In some embodiments, a vehicle system obtains an identifier corresponding to a vehicle system and a request to activate an application. In response to obtaining the identifier: according to a determination that the application is a first type of application, the vehicle system stores the application in a manner that corresponds to a first container, wherein the first container corresponds to a first set of one or more permissions; and according to a determination that the application is a second type of application, different from the first type of application, the vehicle system stores the application in a manner that corresponds to a second container, different from the first container, wherein the second container corresponds to a second set of one or more permissions different from the first set of one or more permissions.

### CROSS-REFERENCE TO RELATED APPLICATIONS

This application claims priority to U.S. Provisional Patent Application No. 63/601,504, filed on Nov. 21, 2023 and titled “Containerized Info-Entertainment & Vehicle Performance Platform”, and U.S. Provisional Patent Application No. 63/553,037, filed on Feb. 13, 2024 and titled “Managing In-Vehicle Ecosystems”, which are hereby incorporated by reference in their entireties.

### BACKGROUND

Third-party developers are often required to create different versions of an application for the application to work in different types of vehicles (e.g., different types of makes, models, and/or manufacturers). This is the case because in-vehicle application ecosystems are complex and closed systems that are controlled by original equipment manufacturers (e.g., companies that manufacture vehicles). Original equipment manufacturers develop complex and closed systems to manage the security of a vehicle, amongst other things. In addition, other software systems exist, such as Android Auto® and Apple CarPlay®, which allow users to use a mobile device to provide an in-vehicle ecosystem. However, these other software systems often do not allow original equipment manufacturers access to data obtained during a user's in-vehicle experience while using these other software systems.

### FIELD

The present disclosure relates generally to software applications and vehicles, and more specifically, to techniques for managing in-vehicle ecosystems.

### SUMMARY

Some techniques for managing an in-vehicle ecosystem, however, are generally closed and complex. Accordingly, the present technique provides in-vehicle systems with faster, more efficient techniques, methods, and interfaces. Using the techniques described below, developers can develop less versions of applications for different vehicle systems without reducing security of the vehicle system by a meaningful amount and/or increasing security of the vehicle system.

In some embodiments, a method is described. In some embodiments, the method includes receiving, from an application, a request to perform a write operation to a communication bus of a vehicle system; and in response to receiving the request to perform the write operation to the communication bus of the vehicle system: according to a determination that the application is associated with a container corresponding to a set of one or more permissions that indicate that one or more applications can write to the communication bus of the vehicle system, permitting the application to perform the write operation to the communication bus of the vehicle system, wherein performing the write operation causes the vehicle system to perform one or more vehicle operations; and according to a determination that the application is associated with a container that does not correspond to the set of one or more permissions that indicate that one or more applications can write to the communication bus of the vehicle system, forgoing permitting the application to cause the vehicle system to perform the write operation to the communication bus of the vehicle system.

In some embodiments, a non-transitory computer-readable storage medium is described. In some embodiments, the non-transitory computer-readable storage medium storing one or more programs configured to be executed by one or more processors. The non-transitory computer-readable storage medium storing one or more programs includes receiving, from an application, a request to perform a write operation to a communication bus of a vehicle system; and in response to receiving the request to perform the write operation to the communication bus of the vehicle system: according to a determination that the application is associated with a container corresponding to a set of one or more permissions that indicate that one or more applications can write to the communication bus of the vehicle system, permitting the application to perform the write operation to the communication bus of the vehicle system, wherein performing the write operation causes the vehicle system to perform one or more vehicle operations; and according to a determination that the application is associated with a container that does not correspond to the set of one or more permissions that indicate that one or more applications can write to the communication bus of the vehicle system, forgoing permitting the application to cause the vehicle system to perform the write operation to the communication bus of the vehicle system.

In some embodiments, a transitory computer-readable storage medium is described. In some embodiments, the transitory computer-readable storage medium storing one or more programs configured to be executed by one or more processors. The transitory computer-readable storage medium storing one or more programs includes receiving, from an application, a request to perform a write operation to a communication bus of a vehicle system; and in response to receiving the request to perform the write operation to the communication bus of the vehicle system: according to a determination that the application is associated with a container corresponding to a set of one or more permissions that indicate that one or more applications can write to the communication bus of the vehicle system, permitting the application to perform the write operation to the communication bus of the vehicle system, wherein performing the write operation causes the vehicle system to perform one or more vehicle operations; and according to a determination that the application is associated with a container that does not correspond to the set of one or more permissions that indicate that one or more applications can write to the communication bus of the vehicle system, forgoing permitting the application to cause the vehicle system to perform the write operation to the communication bus of the vehicle system.

In some embodiments, a vehicle system is described. In some embodiments, the vehicle system includes one or more processors; and memory storing one or more programs configured to be executed by the one or more processors, the one or more programs including instructions for: receiving, from an application, a request to perform a write operation to a communication bus of a vehicle system; and in response to receiving the request to perform the write operation to the communication bus of the vehicle system: according to a determination that the application is associated with a container corresponding to a set of one or more permissions that indicate that one or more applications can write to the communication bus of the vehicle system, permitting the application to perform the write operation to the communication bus of the vehicle system, wherein performing the write operation causes the vehicle system to perform one or more vehicle operations; and according to a determination that the application is associated with a container that does not correspond to the set of one or more permissions that indicate that one or more applications can write to the communication bus of the vehicle system, forgoing permitting the application to cause the vehicle system to perform the write operation to the communication bus of the vehicle system.

In some embodiments, a vehicle system is described. In some embodiments, the vehicle system includes means for receiving, from an application, a request to perform a write operation to a communication bus of a vehicle system; and means, responsive to receiving the request to perform the write operation to the communication bus of the vehicle system, for: according to a determination that the application is associated with a container corresponding to a set of one or more permissions that indicate that one or more applications can write to the communication bus of the vehicle system, permitting the application to perform the write operation to the communication bus of the vehicle system, wherein performing the write operation causes the vehicle system to perform one or more vehicle operations; and according to a determination that the application is associated with a container that does not correspond to the set of one or more permissions that indicate that one or more applications can write to the communication bus of the vehicle system, forgoing permitting the application to cause the vehicle system to perform the write operation to the communication bus of the vehicle system.

In some embodiments, a computer program product is described. In some embodiments, the computer program product includes receiving, from an application, a request to perform a write operation to a communication bus of a vehicle system; and in response to receiving the request to perform the write operation to the communication bus of the vehicle system: according to a determination that the application is associated with a container corresponding to a set of one or more permissions that indicate that one or more applications can write to the communication bus of the vehicle system, permitting the application to perform the write operation to the communication bus of the vehicle system, wherein performing the write operation causes the vehicle system to perform one or more vehicle operations; and according to a determination that the application is associated with a container that does not correspond to the set of one or more permissions that indicate that one or more applications can write to the communication bus of the vehicle system, forgoing permitting the application to cause the vehicle system to perform the write operation to the communication bus of the vehicle system.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a system architecture diagram for an in-vehicle computer system of a vehicle.

FIG. 2 is a system architecture diagram for an in-vehicle computer system of a vehicle in accordance with some embodiments.

FIG. 3 is a flow diagram illustrating a method for running applications within a container in accordance with some embodiments.

FIG. 4 is a block diagram illustrating a tiered data stream used by vehicle operating system in accordance with some embodiments.

FIG. 5 is a functional diagram illustrating communication between containerized application and entity within the vehicle in accordance with some embodiments.

FIG. 6 is a flow diagram illustrating a method for downloading and installing a container application to a container operating on vehicle operating system in accordance with some embodiments.

FIG. 7 is a flow diagram illustrating a process that includes operations performed by components of a vehicle in accordance with some embodiments.

FIG. 8 a block diagram illustrating containerized applications running within the container at a second mode in accordance with some embodiments.

FIG. 9 is a flow diagram illustrating a process to generate certificates for applications compatible with containers running on vehicle operating system in accordance with some embodiments.

FIG. 10 is a flow diagram illustrating a process for verifying digital certificates for applications in accordance with some embodiments.

FIGS. 11A-11B is a flow diagram illustrating a process for authenticating a user and loading a user profile for a software defined vehicle in accordance with some embodiments.

FIG. 12 is a diagram illustrating software defined vehicles and user profiles in accordance with some embodiments.

FIG. 13 is a diagram illustrating a computer architecture for permitting access to a communication bus in accordance with some embodiments.

FIG. 14 is a flow diagram illustrating a method for permitting access to a communication bus in accordance with some embodiments.

FIG. 15 is a flow diagram illustrating a method for selectively permitting the writing of data to a communication bus in accordance with some embodiments.

FIG. 16 is a flow diagram illustrating a method for selectively writing to a communication bus in accordance with some embodiments.

FIG. 17 is a flow diagram illustrating a method for selectively permitting the reading of data from a communication bus in accordance with some embodiments.

FIG. 18 is a flow diagram illustrating a method for selectively reading from a communication bus in accordance with some embodiments.

FIG. 19 is a flow diagram illustrating a method for selectively permitting one or more operations to be performed by an application in accordance with some embodiments.

FIG. 20 is a flow diagram illustrating a method for controlling output of one or more applications for vehicles systems in accordance with some embodiments.

FIG. 21 is a flow diagram illustrating a method for controlling operation of one or more applications for vehicles systems in accordance with some embodiments.

FIG. 22 is a flow diagram illustrating a method for allocating compute resources for an application executing in vehicle systems in accordance with some in accordance with some embodiments.

FIG. 23 is a flow diagram illustrating a method for allocating compute resources for an application executing in vehicle systems in accordance with some embodiments.

FIG. 24 is a flow diagram illustrating a method for storing an application for vehicle systems in accordance with some embodiments.

FIG. 25 is a flow diagram illustrating a method for connecting an application for a vehicle system after connecting a peripheral device to a vehicle system in accordance with some embodiments.

FIG. 26 is a flow diagram illustrating a method for compiling an application with one or more digital certificates for vehicle systems in accordance with some embodiments.

FIG. 27 is a flow diagram illustrating a method for managing multiple digital certificates for vehicle systems in accordance with some embodiments.

FIG. 28 is a flow diagram illustrating a method for connecting a peripheral to vehicle systems in accordance with some embodiments.

FIG. 29 is a flow diagram illustrating a method for installing one or more applications for vehicle systems in accordance with some embodiments.

FIG. 30 is a flow diagram illustrating a method for installing one or more applications for vehicle systems in accordance with some embodiments.

FIG. 31 is a flow diagram illustrating a method for generating one or more digital certificates for vehicle systems in accordance with some embodiments.

FIG. 32 is a flow diagram illustrating a method for managing one or more digital certificates for vehicle systems in accordance with some embodiments.

FIG. 33 is a system architecture diagram for an in-vehicle computer system of a vehicle in accordance with some embodiments.

FIG. 34 is a system communication diagram in accordance with some embodiments.

### DETAILED DESCRIPTION

The description described below sets forth one or more exemplary embodiments, examples, methods, parameters, etc. However, it should be understood that the description below is not intended to limit the scope of the present disclosure but to serve as a description and/or example of embodiments to achieve one or more technical advantages in the field of technology. Techniques, methods, and/or processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” “according to,” “because of a determination,” and/or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” according to [the stated condition or event],” because of a determination of [the stated condition or event],” or “in accordance with a determination that [the stated condition or event]” depending on the context.

Although the following description uses numeric terms, such as “first,” “second,” “third,” etc., to describe various elements, these elements should not be limited by the terms. In some embodiments, these terms are used to distinguish one element from another. For example, a user interface element could be termed a first user interface element, and, similarly, a user interface element could be termed a second user interface element, without departing from the scope of the various described embodiments. In some embodiments, the first user interface element and the second user interface element are two separate references to the same user interface element. In some embodiments, the first user interface element and the second user interface element are both user interface element, but they are not the same user interface element or the same type of user interface element.

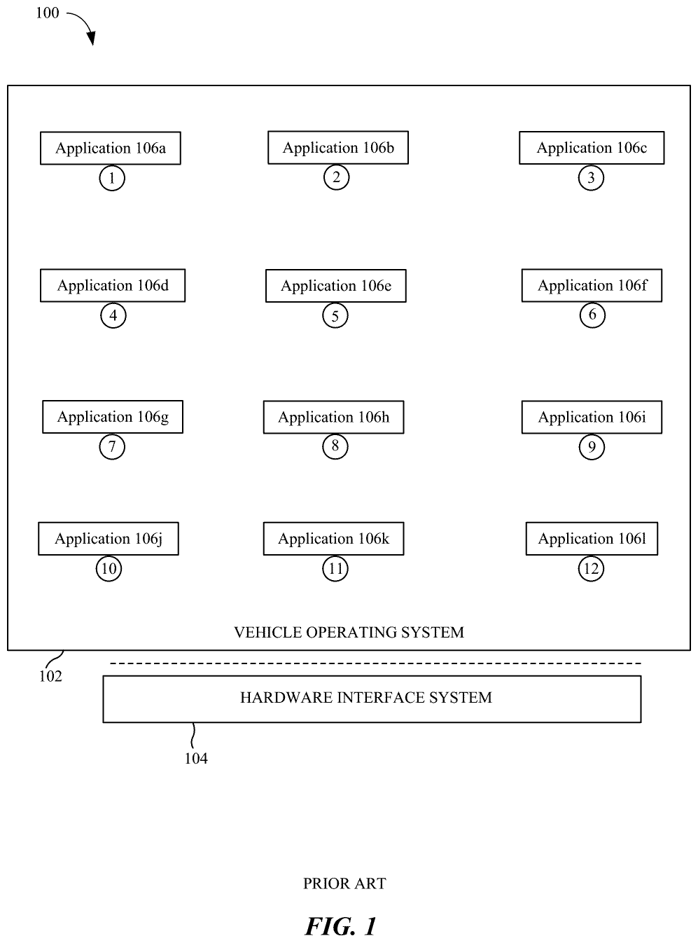

FIG. 1 is a system architecture diagram for in-vehicle computer system 100 of a vehicle (e.g., a car, sports utility vehicle, motorcycle, drone, and/or truck). As illustrated in FIG. 1, components of in-vehicle computer system 100 include vehicle operating system (OS) 102, hardware interface system 104, and applications 106a-1061. Vehicle OS 102 is an automotive operating system. In some embodiments, vehicle OS 102 is software platform that manages a variety of functions of the vehicle that rely on and/or are software (e.g., infotainment systems, navigation systems, vehicle settings, driver assistance systems, and/or vehicle user interface systems). For example, applications 106a-1061 represent different applications that are configured to be executed via vehicle OS 102. In some existing systems, applications run in the same memory space, layer, and/or container of vehicle OS 102 (and/or are otherwise stored in memory in the same manner by vehicle OS 102). In this example, applications 106a-1061 run in the same memory space, layer, and/or container of vehicle OS 102 (e.g., while being executed). However, in some existing systems, managing security and privacy of the vehicle and/or data thereof can be challenging. For example, providing fine grained and/or controlled access to vehicle data to particular applications can be complex, involve a high computational cost, and/or be limited. For example, ensuring that each application receives certain data (e.g., from one or more vehicle data streams) from hardware interface system 104 can require granting each respective application access to a larger subset of data than the certain data. For instance, providing access to an infotainment system to an application can provide the application with access to control all aspects (e.g., display output, audio output, settings, and/or controls mappings) even where only a subset of such aspects are desired to be provided. Similarly, in some existing systems, the ability to maintain security of the system once an application is deployed on vehicle OS 102 can be limited. Once the application is deployed by vehicle OS 102, there can be limited (or no) ability to monitor the application's activity, control and/or restrict access to unauthorized data, and/or ensure improper operation of the application (e.g., errors and/or malicious operations) do not affect other applications and/or vehicle systems. Because of this, applications for vehicle OS 102 can require resource-intensive development cycles in order to satisfy vehicle original equipment manufacturer (OEM) standards before an application can be deployed to a vehicle manufactured by the OEM. Many times, an OEM must write such an application on behalf of third parties to satisfy the level of trust required to deploy such an application on a vehicle, given the limitations of existing systems noted above.

There is a need for an in-vehicle OS architecture that enables functionality by the in-vehicle OS to efficiently and effectively provide highly customizable controlled access to data streams to applications in a secure manner. Such an architecture can significantly reduce development resources (e.g., time and cost) for creating applications, increase control and security of such applications when deployed, and/or enable a robust ecosystem of applications (e.g., OEM and/or third-party applications) that provide the ability to customize the user experience of a vehicle in different ways.

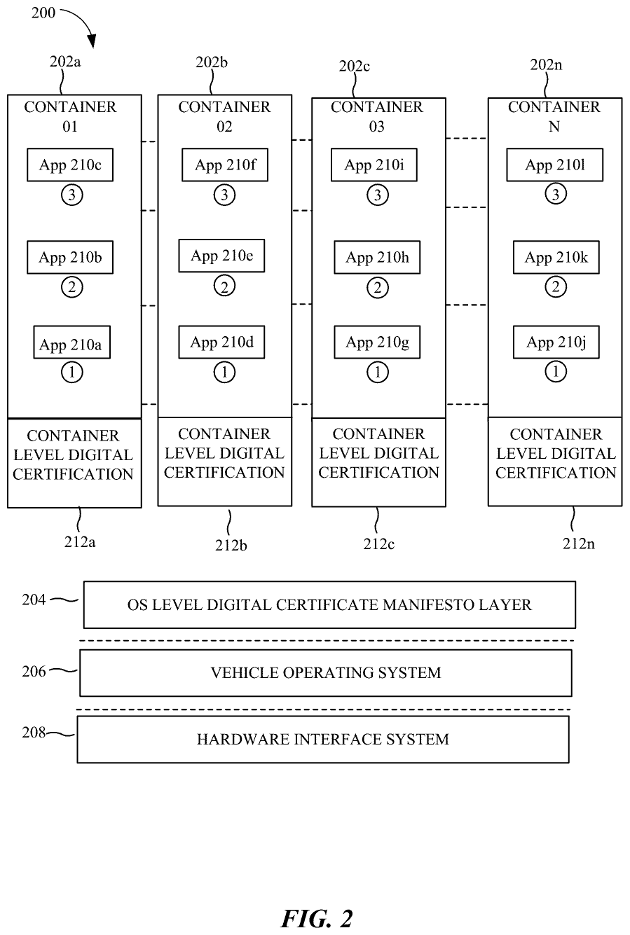

FIG. 2 is a system architecture diagram for in-vehicle computer system 200 of a vehicle. As illustrated in FIG. 2, components of in-vehicle computer system 200 include vehicle operating system (OS) 206, hardware interface system 208, containers 202a-202n, container level digital certifications 212a-212n, applications 210a-2101 (e.g., each application running within one of containers 202a-202n), and digital certificate manifesto layer 204. One or more prospective functions of these components are described in greater detail below. In some embodiments, components of in-vehicle computer system 200 work together to control presentation of, transmission of, and access to data generated by and/or associated with the vehicle. In some embodiments, data generated by and/or associated with the vehicle include information such as vehicle telemetry (e.g., speed of the vehicle, location of the vehicle, fuel and other fluid levels of the vehicle, and/or engine temperature of the vehicle), vehicle specific data (e.g., vehicle identification number (VIN) number of the vehicle, make and model of the vehicle and/or year of car of the vehicle), and/or media output from (and/or media input to) a vehicle infotainment system (e.g., search history, music playlist, and/or radio stations) used within the vehicle. In some embodiments, data is generated and/or read via a communication access network bus and/or the like for a vehicle.

As illustrated in FIG. 2, in-vehicle computer system 200 includes hardware interface system 208. In some embodiments, hardware interface system 208 includes one or more hardware interfaces and/or one or more software interfaces that enable communication between components of the vehicle and/or in-vehicle computer system 200. For example, hardware interface system 208 can include physical connections that enable communication to, from, and/or between electronic control units (ECUs) that control different functions of the vehicle. Such communication between ECUs can occur via (e.g., be facilitated and/or mediated by) vehicle OS 206. In some embodiments, hardware interface system 208 includes one or more controller area network (CAN) bus. In some embodiments, the CAN bus is a communication protocol used in vehicles to allow ECUs to communicate with each other and vehicle OS 206. For example, the CAN bus broadcasts short messages from ECUs that include information such as readings from sensors and/or control commands (e.g., read and/or write commands). The broadcasts of the CAN bus can be prioritized so that vehicle OS 206 can assign a priority level for different ECUs.

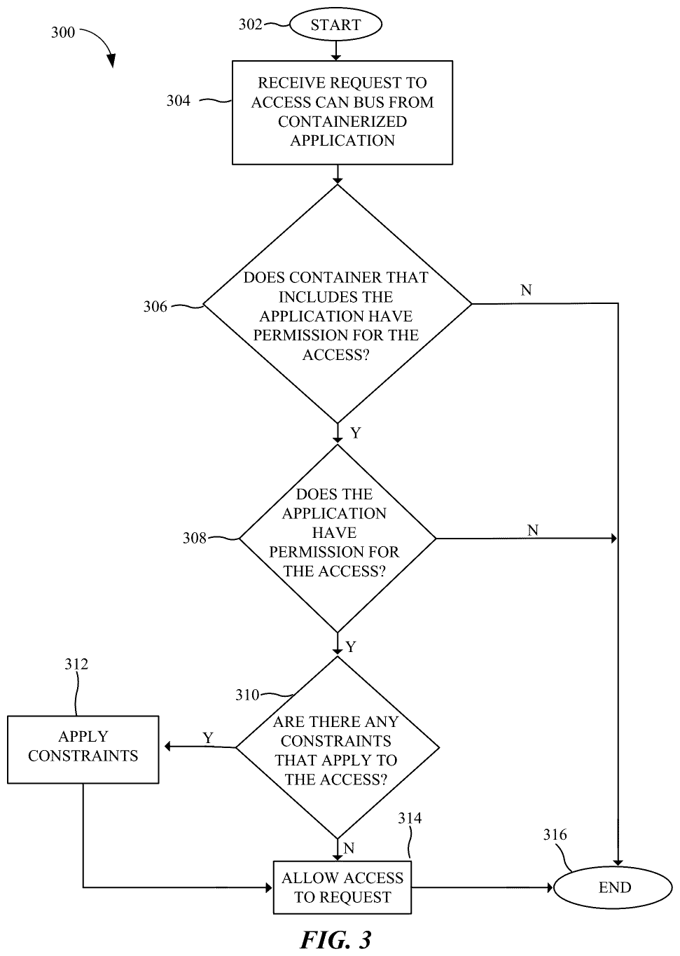

In some embodiments, vehicle OS 206 is a layered software platform that manages a variety of functions of the vehicle. In some embodiments, vehicle OS 206 includes a real-time operating layer responsible for critical functions of the vehicle such as engine control, braking, and/or autonomous driving functions. In some embodiments, vehicle OS 206 includes a middleware layer responsible for communication and data management of the vehicle. In some embodiments, vehicle OS 206 includes an interface layer responsible for user facing features like the vehicle's infotainment system or user interfaces for third party applications. In some embodiments, vehicle OS 206 transmits commands and receives information throughout the vehicle from the CAN bus. In some embodiments, vehicle OS 206 governs the resource allocation of memory, processing power, and transmission of data to and from different applications running on vehicle OS 206. The governance of memory, processing power, and transmission of data is executed using software containers 202a-202n run on a kernel of vehicle OS 206. In some embodiments, vehicle OS 206 controls the data streams and system resources that third party applications can utilize with digital certificates as discussed with regards to FIG. 3.

As illustrated in FIG. 2, containers 202a-202n are components of vehicle operating system 206. At FIG. 2, containers 202a-202n are isolated virtual environments that are governed by digital certificate manifesto layer (e.g., kernel) 204 of the vehicle OS 206. Each container is associated with a digital certificate (e.g., digital certificates 212a-212n), by digital certificate manifesto layer 204, that defines the nature of permissions of the respective container. In some embodiments, vehicle OS 206 provides each container with the digital certificate. In some embodiments, the digital certificate for a container (e.g., a container certificate) is provided by another computer system (e.g., a remote server). In some embodiments, a container is associated with a plurality of digital certificates (e.g., container certificates that cover different groups of permissions that together define a holistic set of permissions of a container). In some embodiments, the digital certificate of a respective container can define operations that are permitted (and/or not permitted) by the container (e.g., by an application stored within such container). In some embodiments, the digital certificate of a respective container can define operating contexts (e.g., vehicle states, operating conditions, and/or driver characteristics) during which some (or all) operations by the container (e.g., and/or applications therein) are permitted (and/or not permitted). In some embodiments, the digital certificate of a respective container can be updated while other digital certificates of other respective containers are not updated. It should be understood that, in some embodiments, the term “digital certificate” refers to, includes, represents, and/or is a set of permissions and/or authorizations. The set of permissions and/or authorizations can be required to perform one or more operations, as described throughout this application. One of skill in the art will recognize that the term “digital certificate” or “certificate” is often used in various contexts and is sometimes used to refer to, for example, an electronic file associated with a cryptographic key pair (e.g., used for authenticating a website or an individual). In this application, the set of permissions and/or authorizations can be required in addition to and/or in lieu of such digital certificates as used in existing contexts (e.g., electronic files associated with a cryptographic key pair). In some embodiments, the term “digital certificate” includes and/or is a blockchain, where authorization (e.g., is the application an authorized application and/or is the application a legitimate application) and control (e.g., operations that the application can be performed and/or operations attempted to be performed and/or performed by the application) are encrypted to form a block.

At FIG. 2, applications 210a-2101 (e.g., each application running within one of containers 202a-202n) are also associated with respective digital certificates (e.g., each containerized application has a corresponding digital certificate). Each application is associated with a digital certificate by digital certificate manifesto layer 204 that defines the nature of permissions of the respective application. In some embodiments, vehicle OS 206 provides each application with the digital certificate. In some embodiments, the digital certificate for an application (e.g., an application certificate) is provided by another computer system (e.g., a remote server). In some embodiments, an application is associated with a plurality of digital certificates (e.g., container certificates that cover different groups of permissions that together define a holistic set of permissions of an application). In some embodiments, the digital certificate of a respective application can define operations that are permitted (and/or not permitted) by the application (e.g., which may not be the same as operations permitted by the container and/or other applications in the container). In some embodiments, the digital certificate of a respective application can define operating contexts (e.g., vehicle states, operating conditions, and/or driver characteristics) during which some (or all) operations by the application are permitted (and/or not permitted). In some embodiments, the digital certificate is associated with a respective container due to the digital certificate having a particular format and/or parameter that indicates the respective container. In some embodiments, containers have different formats and a digital certificate that is associated with one of the containers has a format that is defined by the container.

At FIG. 2, each container 202a-202n is configured for different types of applications using digital certificates. That is each container, can be configured by a respective digital certificate to have: an allocated level of access to read from and write to the CAN bus for one or more particular data streams, a particular amount of communication bandwidth, an allocated amount of memory, and/or an allocated amount of CPU processing power for applications running within that container. In some embodiments, a container can be designed for a variety of applications with different types of functions. For example, a first container designed for car insurance applications can have a different set of permissions reflected in the first container's digital certificate than a second container designed for autonomous driving applications, or a third container designed for vehicle infotainment applications. By designing containers for different types of applications, vehicle OS 206 can govern computer resources and user privacy for multiple applications based on the functions of the applications.

In some embodiments, each container (and/or the vehicle OS) allows applications running within the container to operate in one of a plurality of modes of operation. At FIG. 2, each container 202a-202n can allow applications to operate in three modes. For example, a mode of operation can allow a different level of functionality for the application than other modes (e.g., the mode can modify what is permitted by the container or an application therein). For example, while operating in a first mode applications running within the container are allowed to collect data and perform computation on the collected data. However, while operating in the first mode, applications running within the container are not allowed to present the data to a user or to transmit the data to a third party. While operating in a second mode, applications running within the container are allowed to collect data, perform computations on the collected data, and then present the data through a user interface. However, while operating in the second mode, applications running within the container are not allowed to transmit the data to a third party. While operating in the third mode the container allows applications running within the container to collect data, perform calculations on the collected data, and present the user with data through a user interface and/or transmit data. In some embodiments, the mode in which applications are operating can be dynamically changed (e.g., controlled) by the kernel of vehicle OS 206. For example, a mode change can be based on one or more operating contexts of the vehicle, such as the location of the vehicle or current state of the vehicle (e.g., whether the vehicle is on or off, moving or stationary, and/or has been reported stolen). In some embodiments, a mode applies to two or more containers and/or applications of vehicle OS (e.g., multiple containers and/or applications are subject to operating in the second mode due to the operating state of the vehicle). In some embodiments, a mode is specific to a container and/or application (e.g., one container operates in the first mode while another container can operate in the second mode). In some embodiments, an application can operate in more than three modes. In some embodiments, an application can operate in less than three modes (and/or levels).

In some embodiments, containers (and/or applications) can be subject to different levels of importance and/or treatment by vehicle OS 206 under certain scenarios. For example, one or more containers of vehicle OS 206 can be defined as mission critical. In some embodiments, a mission-critical container can include applications, processes, and/or data that will be accessible and/or used by the vehicle OS 206 in a scenario where the vehicle is operating in a reduced feature mode. For example, vehicle OS 206 can disable all non-mission critical containers so that the vehicle falls back to operating using a set of default settings, characteristics, and/or applications (e.g., OEM-defined applications) if needed for safety and/or security (e.g., due to an error and/or unauthorized access).

FIG. 3 is a flow diagram illustrating process 300 for running applications within a container, in accordance with some embodiments. In some embodiments, process 300 is performed by one or more components of a vehicle, wherein such components can be implemented in hardware and/or software. In some embodiments, process 300 is performed by vehicle OS 206. In some embodiments, process 300 is performed by an application installed on vehicle OS 206. Some operations in process 300 are optionally combined, the orders of some operations are optionally changed, and some operations are optionally omitted.

At 302, process 300 starts. In some embodiments, process 300 starts after (and/or while) vehicle OS 206 is booted up (e.g., initialized, started, and/or operating in a normal state) and the vehicle is turned on. In some embodiments, vehicle OS 206 is booted up when vehicle OS 206 wakes up from a hibernation/sleep mode. In some embodiments, vehicle OS 206 is booted up when the vehicle is remotely started by command from an external device received while the vehicle is in an off state.

At 304, vehicle OS 206 receives a request to access the CAN bus from a containerized application (e.g., an application stored in a container, such as one of containers 202a-202n). In some embodiments, the request includes a request to read from and/or write to one or more data stream of the vehicle's CAN bus. In some embodiments, permission (e.g., to read from and/or to write to data streams) is granted (or denied) by vehicle OS 206 based on a determination made by (and/or using) an OS level digital certificate manifesto layer. For example, the OS level digital certificate manifesto layer 204 can assess permissions based on the digital certificate assigned to the containerized application, the digital certificate assigned to the container of the container holding the application, and/or a manifesto (e.g., maintained by vehicle OS 206) corresponding to the containerized application and/or container. In some embodiments, the digital certificates (and/or a manifesto maintained by the vehicle OS) that correspond to a containerized application reflect a vehicle OS 206 governance policy for the containerized application, whereby different containerized applications can be subject to different governance policies. For example, a containerized application running within insurance container 202b can correspond to digital certificates which grant access to read from data streams associated with the engine ECU and braking ECU (e.g., and that do not necessarily grant access to write to the same data streams), while a containerized application running in info-content container 202c can correspond to digital certificates that grant access to read from and write to data streams associated with a network communication ECU, a speaker ECU, and a display ECU. That is, digital certificates corresponding to a containerized application (e.g., the application certificate and/or the container certificate) can be determinative of whether or not a particular request from the containerized application to access a specific data stream of the CAN bus is granted or denied. In some embodiments, digital certificates (and/or the manifesto) indicate the amount and/or type data accessible to the containerized application. In some embodiments, digital certificates indicate (and/or are used to determine) resource allocations (e.g., CPU and memory usage) designated for the containerized application. In some embodiments, a container may request access to the CAN bus, and vehicle OS 206 determines whether to grant the request based on digital certificates of the requesting container.

At 306, vehicle OS 206 determines whether the container running the containerized application has permission for the requested access. In some embodiments, digital certificate manifesto layer 204 makes the determination of whether each container's request is granted permission by verifying if the requesting container has the appropriate digital certificate. The digital certificate of the container indicates the requests to the CAN bus that are allowed for the requesting container and subsequently the applications running with the requesting container. In some embodiments, vehicle OS 206 creates and distributes digital certificates to each container. In some embodiments, the digital certificate manifesto layer 204 creates and distributes digital certificates to the containers. In some embodiments, the digital certificates can expire and no longer be recognized by vehicle OS 206 (e.g., based on a predetermined number of uses by the container, cancellation of permissions, and/or after a lapse of a predetermined period time from the issuance of the digital certificate).

If digital certificate manifesto layer 204 determines that the requesting container does not have the appropriate digital certificate, vehicle OS 206 denies the requested access for the containerized application and proceeds to 316 to end the process. On the other hand, if digital certificate manifesto layer 204 determines that the requesting container does have the appropriate digital certificate, vehicle operating system 206 proceeds to 308.

At 308, vehicle OS 206 determines whether the requesting containerized application has permission for the requested access. In some embodiments, digital certificate manifesto layer 204 determines (and/or is used to determine) whether the requesting containerized application has permission by verifying whether the requesting containerized application has the appropriate digital certificate. In some embodiments, containerized applications request access to CAN bus data streams. The containerized applications running within the container can request access to data streams that are accessible to the container. In some embodiments, containerized applications are not allowed permissions for features (e.g., access to data streams) which the corresponding containers on which the applications are running within have not been granted. In some embodiments, the containerized application can have less and/or fewer permissions than the permissions granted to the container. For example, if insurance container 202b has permission to access certain data streams from the engine ECU and braking ECU but no data streams from the communication ECU, then an application running within insurance container 202b would not be granted permission to obtain access to a data stream corresponding to communication ECU. However, an application running within insurance container 202b could be granted permission (e.g., depending on the application's own permissions reflected in its certificate and/or a manifesto) to access to all or some of the data streams to the container in which the application is running. In this example, the application running within the insurance container is granted permission to access the data streams from the engine ECU and the braking ECU.

In some embodiments, the containerized application requests permission after the containerized application is initiated (e.g., has been created, exists, and/or has been verified by the vehicle OS). In some embodiments, the containerized application requests permission after the container is granted permission from vehicle OS 206 (e.g., a certificate and/or permission for the container is checked before the containerized application's certificate and/or permission is checked). In some embodiments, the containerized application requests permission in conjunction with requesting permission for the container (e.g., permissions for both the container and the containerized application are requested in and/or checked in response to the same request).

In some embodiments, a digital certificate for the container is provided to (and/or to the vehicle OS 206 on behalf of) the container by an entity. In some embodiments, the entity is the manufacturer of the vehicle and/or a third-party certification entity.

At 308, if digital certificate manifesto layer 204 determines that the requesting containerized application does not have the appropriate digital certificate, vehicle OS 206 denies permission to the containerized application and the process ends at 316. On the other hand, if digital certificate manifesto layer 204 determines that the requesting containerized application has the appropriate digital certificate, vehicle OS 206 proceeds to 310.

In some embodiments, a digital certificate for the containerized application is provided to (and/or the vehicle OS 206 on behalf of) the containerized application by an entity (e.g., as described above with respect to the digital certificate for the container). In some embodiments, the entity is the manufacturer of the vehicle and/or a third-party certification entity. In some embodiments, the certificate is provided only after the containerized application has been approved or certified by the entity. For example, using an entity to provide digital certificates for the container, the manufacturer is able to enforce governance, security, privacy, and/or safety policies on containerized applications run on the manufacturer's vehicles. Additionally, manufacturers can provide application developers with different levels (e.g., tiers) of data from the vehicle based on the manufacturer's agreements with the application developers. At 310, vehicle OS 206 determines if there are any constraints that apply to the access requested by the containerized application. In some embodiments, an additional constraint is a current mode (e.g., operating mode) that the vehicle and/or vehicle OS is operating under. As discussed above, a container (and/or an application within a container) can operate in one of a plurality of modes of operation that can allow a different level of functionality for the container than other modes. For example, each mode allows the container, and applications therein, to perform a set of one or more functions (e.g., a predetermined amount and/or type of functions). In some embodiments, vehicle OS 206 can dynamically change the mode in which one or more containers operates. This, in turn, can affect the ability of containerized applications running within a container to perform certain functions and/or have access to certain data from CAN bus (e.g., functions that are permitted by the application in one mode may be restricted in another mode). In some embodiments, vehicle OS 206 can change the mode in which a container operates based on one or more factors, such as an operating state of the vehicle and/or vehicle OS 206, the time of day, identity of the driver, number of passengers, weather conditions, vehicle location, and/or a command by an external device. In some embodiments, if the vehicle is detected to be driving below a threshold speed (e.g., 25 miles per hour (mph), 35 mph, or 50 mph) vehicle OS 206 can cause a container to operate in a particular mode which allows the container (and/or applications therein) to perform all of its permitted functions (permitted by the certificates and/or a manifesto) without additional constraints due to the operating mode (e.g., the application can read and/or write to data streams from CAN bus, present data on a user display, and/or communicate with an entity outside of the vehicle via a communication ECU). For example, the particular mode can be a third mode (e.g., out of three modes) that allows an application in the container full control over the vehicle's infotainment display (e.g., can display any content and/or display content in a full screen layout). In some embodiments, if the vehicle, starts to drive over the threshold speed, vehicle OS 206 changes the operating mode of the container to a different mode than the particular mode (e.g., changes to a first mode or a second mode) in which the application in the container no longer has full control over the function of the vehicle's infotainment display unit (e.g., the application is limited in the type of content that can be displayed and/or is not permitted to display content in a full screen layout). For example, containerized applications running within the container can lose the ability to fully control the infotainment display unit while the vehicle is driving over 50 mph. In such example, vehicle OS 206 can reduce potential distractions to the driver that may be caused by the full feature set of containerized applications by switching the operating mode (or modes) of containers 202a-202n. In some embodiments, if a vehicle is reported stolen, vehicle OS 206 can change the mode in which one or more containers operate (e.g., in response to receiving a corresponding message and/or instruction). For example, vehicle OS 206 can allow the containers to operate in a mode in which the vehicle (e.g., via a containerized application) can display messages such as warnings to the driver from law enforcement officials and/or in which the vehicle can disable certain functionality (e.g., disable the ability to drive above a certain speed, disable any third-party application features, and/or enable an anti-theft containerized application to override driver inputs by writing to an ECU).

At 310, if vehicle OS 206 determines that a constraint is applicable, process 300 proceeds to 312. At 312, vehicle OS 206 applies the constraints (e.g., change the operating mode of applications) and proceeds to 314. In some embodiments, if applying the constraints results in the requesting access not being permitted, process 300 proceeds to 316 and ends. On the other hand, if vehicle OS 206 determines that no constraints are applicable, process 300 proceeds to 314 and vehicle OS 206 allows the containerized application to access the request as shown at 314. At 314, after allowing the access of the request, process 300 proceeds to 316 and ends.

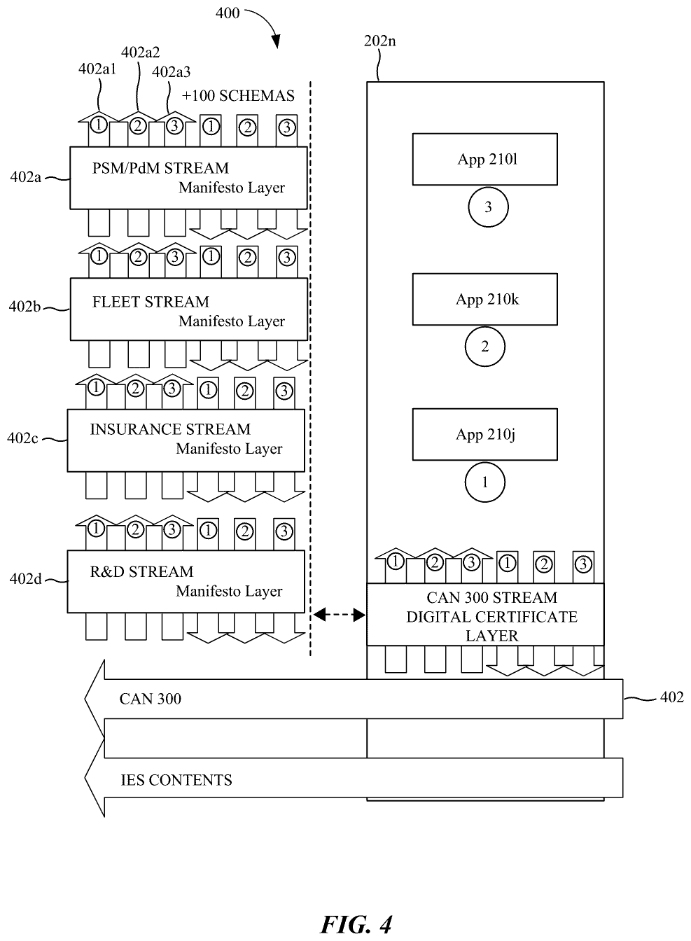

FIG. 4 illustrates diagram 400 which depicts a tiered data stream used by vehicle OS 206 to provide a customized data stream consisting of data from multiple ECUs of the vehicle to container 202n and containerized applications 210j-2101. As shown in FIG. 4 and discussed earlier, applications within container 202n (and/or containers) are configured to operate in three modes with varying levels of functionality. As illustrated in FIG. 4, container 202n is in communication with CAN bus 402. In some embodiments, CAN bus 402 enables vehicle OS 206 to provide access to (e.g., to read and/or write) data of vehicle ECUs to containers and/or containerized applications. In some embodiments, vehicle OS 206 can bundle data from different ECUs to create a customized data stream that consists of data from multiple ECUs. These customized data streams are made available to select containers and/or containerized applications by vehicle OS 206 by digital certificates.

As illustrated in FIG. 4, vehicle OS 206 utilizes the following bundled data streams: powertrain system management/propulsion data management (PSM/PdM) data stream 402a, fleet data stream 402b, insurance data stream 402c, and research and development (R&D) data stream 402d. In some embodiments, PSM/PdM stream 402a includes data from multiple ECUs such as an engine ECU, transmission ECU, anti-lock brake system (ABS) ECU, ignition system ECU, and powertrain ECU. Vehicle OS 206 selects data from ECUs that would provide a container with the appropriate data needed for containerized applications running within the container. For example, PSM/PdM is a bundled data stream that aggregates data that is used by containerized applications that provide autonomous driving features like steering, changing lanes, braking, and accelerating. As another example, fleet data stream 402b can include access to data streams from ECUs that are of interest to the owner of a fleet vehicle. As another example, insurance data stream 402c can include data from multiple ECUs that provide a container having insurance applications with data needed to calculate a safe driving score for a driver, which can be used to determine insurance rates for the driver. The amount of data provided to an application and/or container can be controlled by the vehicle OS 206.

As shown in FIG. 4, data stream 402a is comprised of tiered data including tier one data 402a1, tier two data 402a2, and tier three data 402a3. In some embodiments, a data stream (and/or a bundled data stream) is comprised of tiered data including tier one data, tier two data, and tier three data (e.g., can be less or more than three tiers). In some embodiments, the tiered data classification with a stream enables vehicle OS 206 to provide containerized applications running within a container access to the same data streams, but where the scope of such access is differentiated based on which tier the containerized application has permission for (e.g., is subscribed to and/or validated for). In some embodiments, different tiers of the same data stream (and/or bundled data stream) include different types of data, amounts of data, level of detail of data, sets (e.g., subsets) of data, and/or permitted uses of data from the set of data in the data stream. For example, container 202n may have a first application that monitors only the consumption and efficiency of gas use in a vehicle. As such, the first application may only need data included in the tier one data from data stream 402d which includes information related the vehicle gas consumption. Likewise, container 202n may also have a second application that monitors the consumption and efficiency of oil usage in vehicles. As such, the second application may require access to the tier two data from data stream 402d which includes information related to vehicle oil consumption. In some embodiments, the tiered data can be incremental. For example, each tier would include data included in the pervious tier. In some embodiments, vehicle OS 206 provides (e.g., mediates and/or verifies) access to a specific tier of data using digital certificate manifesto layer 204 (e.g., checking digital certificates (e.g., corresponding to the containerized application and/or the container) and/or a manifesto). In some embodiments, vehicle OS 206 provides (e.g., mediates and/or verifies) access to a specific tier of data using another technique for verifying access (e.g., in addition to and/or instead of via digital certificate manifesto layer 204). This configuration ensures that containers can securely provide the requested data to different containerized applications and prevent containerized applications from accessing unauthorized data.

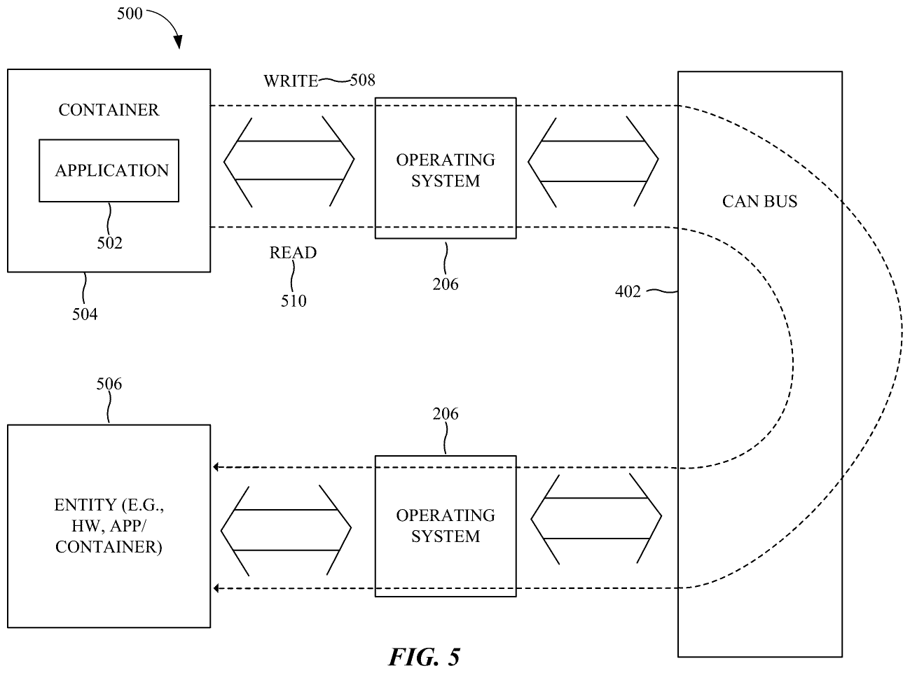

FIG. 5 illustrates functional diagram 500 that depicts communication between containerized application 502 (e.g., running within container 504) and entity 506 within a vehicle. In some embodiments, entity 506 is an application running within container 504, an application in another container, a container, or an ECU within the vehicle. In some embodiments, vehicle OS 206 acts as intermediary between communications occurring between application 502 and entity 506. For example, vehicle OS 206 validates requests (e.g., such as request 508 and/or request 510) at the digital certificate manifesto layer.

At FIG. 5, application 502 transmits write request 508 to entity 506. In some embodiments, write request 508 is to an ECU and includes commands such as a command to brake or accelerate. As illustrated in FIG. 5, write request 508 is intermediated by vehicle OS 206. After vehicle OS 206 confirms (e.g., at the digital certificate manifesto layer) that both application 502 and container 504 are permitted to perform write request 508, write request 508 is allowed. Vehicle OS 206 utilizes digital certificate manifesto layer 204 and digital certificates of application 502 and container 504 (and, optionally, the digital certificate of entity 506) to verify that the request from application 502 to write to (e.g., a data stream of) entity 502 (via CAN bus 406) is allowed. As described above with respect to FIG. 3, after digital certificate manifesto layer 204 determines the appropriate digital certificates are verified, vehicle OS 206 allows application 502 to write to entity 506 through CAN bus 402. In some embodiments, to execute write request 508, application 502 provides data (e.g., as part of a request) to vehicle OS 206. Vehicle OS 206 translates the data provided by application 502 and writes the data to CAN bus 406. In some embodiments, to execute write request 508, application 502 provides data to vehicle OS 206. Vehicle OS 206 writes the data provided by application 502 to CAN bus 406. In some embodiments, to execute write request 508, application 502 writes the data provided by application 502 directly to CAN bus 406.

At FIG. 5, application 502 transmits read request 510 to entity 506. In some embodiments, read request 510 is for computational data used by application 502 to perform operations, such as crash detection or a distance calculation for objects on a road. Vehicle OS 206 utilizes digital certificate manifesto layer 204 and digital certificates of application 502 and container 504 (and, optionally, the digital certificate of entity 506) to verify that the request from application 502 to read from (e.g., a data stream of) entity 506 (via CAN bus 406) is allowed. As described above with respect to FIG. 3, after digital certificate manifesto layer 204 determines the appropriate digital certificates are verified, vehicle OS 206 allows application 502 to write to entity 506 through CAN bus 402. In some embodiments, to execute the read request 510, application 502 transmits a request to read data, from entity 506, to vehicle OS 206. Vehicle OS 206 obtains the data from CAN bus 406, translates the data, and provides the data to application 502. In some embodiments, to execute the read request 510, application 502 transmits a request to read data, from entity 506, to vehicle OS 206. Vehicle OS 206 obtains the data from CAN bus 406 and provides the data to application 502. In some embodiments, to execute read request 510, application 502 transmits a request to read data from application 502 to entity 506. Entity 506 provides the data to application 502.

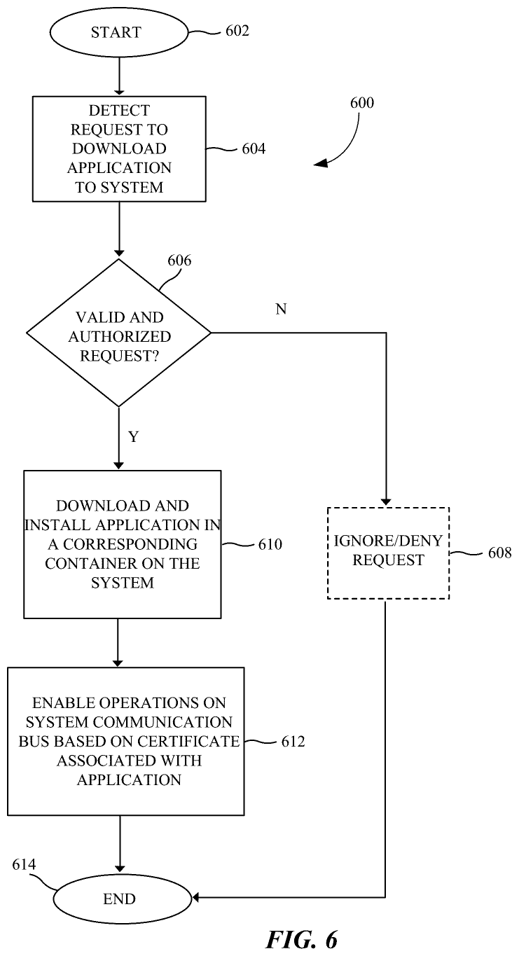

FIG. 6 is a flow diagram illustrating process 600 for downloading and installing an application to a container operating on vehicle OS 206, in accordance with some embodiments. In some embodiments, process 600 is performed by one or more components of a vehicle, wherein such components can be implemented in hardware and/or software. In some embodiments, process 600 is performed by vehicle OS 206. In some embodiments, process 600 is performed by an application installed on vehicle OS 206. Some operations in process 600 are optionally combined, the orders of some operations are optionally changed, and/or some operations are optionally omitted.

At 602, process 600 starts. At 604, vehicle OS 206 detects a request to download an application to vehicle OS 206. In some embodiments, the request to download the application also includes the request to download the application to the appropriate container. In some embodiments, the request originates from a user (e.g., passenger, driver, and/or owner) of the vehicle through a user interface of the vehicle. In some embodiments, the request originates from the user of the vehicle through a remote device. In some embodiments, the request originates from an external source such as manufacturer of the vehicle. In some embodiments, the user causes (e.g., via input) the creation of the request to download the application to the vehicle through an application store (e.g., marketplace) operated by a trusted source such as the manufacturer of the vehicle. After detecting the request, process 600 proceeds to 606.

At 606, vehicle OS 206 determines whether the request to download an application is valid (e.g., properly formed request) and is an authorized request from an authorized user and/or device (e.g., request is from an authenticated user account). In some embodiments, vehicle OS 206 determines whether the request is valid and authorized, through an authorization process such as single-factor authentication (SFA), multi-factor authentication (MFA), biometric authentication, token-based authentication, and/or certificate-based authentication. If vehicle OS 206 determines the request is valid and authorized, the process proceeds to 610. If the authorization process fails, process 600 proceeds to 608 and vehicle OS 206 ignores or denies the request to download the application (and then proceeds to 614 where process 600 ends). In some embodiments, vehicle OS 206 provides a notification of the denial.

At 610, vehicle OS 206 downloads and installs the requested application in a corresponding container of vehicle OS 206. In some embodiments, in conjunction with (e.g., before, during, and/or after) downloading the requested application, vehicle OS 206 determines which container the application will be installed to. In some embodiments, the determination of which container to install the application to is based on one or more digital certificates corresponding to the requested application. In some embodiments, digital certificate manifesto layer 204 determines which container the downloaded application will be running within based on the digital certificate corresponding to the requested application. For example, a digital certificate associated with (e.g., that accompanies and/or is created for) the requested application can indicate which container (and/or the requirements for a new container) that will store the requested application. In some embodiments, the digital certificate will not be valid if the requested application is stored in a different container than what was determined. After downloading and installing the requested application, process 600 proceeds to 612.

At 612, vehicle OS 206 enables operation on a system communication bus (e.g., CAN bus 402) based on certificates associated with the application. For example, vehicle OS 206 configures the application based on the digital certificates that correspond to the application. Vehicle OS 206, via digital certificate manifesto layer 204, verifies that there are no conflicts between the container digital certificates and the application digital certificate. This double verification ensures that the governance policy of the vehicle OS 206 is maintained for the downloaded application. Vehicle OS 206 also configures the application so that the application has access to the appropriate data stream as indicated in the digital certificates of both the container and the application. Additionally, vehicle OS 206 also provides the appropriate read and/or write access to the CAN bus 402 based on the digital certificates of the container and the application. After 612 is completed, process 600 proceeds to 614 and ends. In some embodiments, the vehicle OS 206 looks for updates to the downloaded application at predetermined intervals or in response to receiving an input.

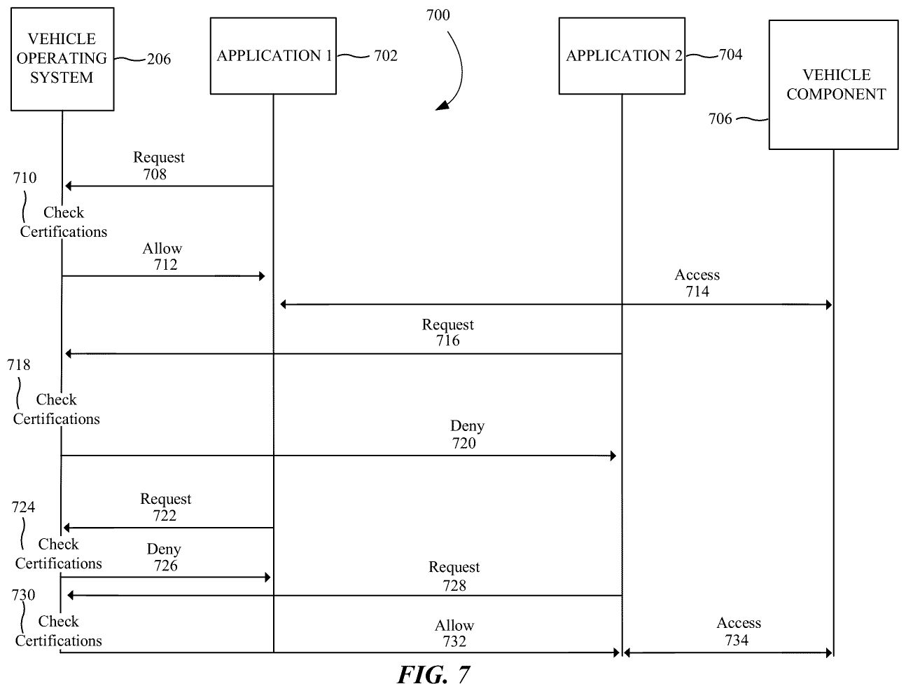

FIG. 7 is a flow diagram illustrating process 700 that includes operations performed by components of a vehicle, in accordance with some embodiments. In some embodiments, process 700 is performed by one or more components of a vehicle, wherein such components can be implemented in hardware and/or software. In some embodiments, process 700 is performed by vehicle OS 206. In some embodiments, process 700 is performed by an application installed on vehicle OS 206. Some operations in process 700 are optionally combined, the orders of some operations are optionally changed, and/or some operations are optionally omitted.

At 708, first application 702 transmits a request to vehicle OS 206. For example, the request is for access to control (e.g., write to) a display of the vehicle. The request can include a command to control the display for entertainment features such as game play, video chat, and/or movies. At 710, vehicle OS 206 checks certifications of first application 702 (and a corresponding container) by having digital certificate manifesto layer 204 verify that first application 702 and its corresponding container have the appropriate digital certificates and permissions. In some embodiments, after checking certifications, vehicle OS 206 may consider a mode and/or operating state of the vehicle before allowing requests, such as whether the vehicle is in a parked state before permitting an application request. At 712, vehicle OS 206 sends an allow command to permit first application 702 to communicate with vehicle component 706 (e.g., display). At 714, first application 702 and vehicle component 706 communicate (e.g., via a CAN bus) to carry out the access requested in request 708 by first application 702. In some embodiments, vehicle OS 206 passes the request to vehicle component 706 after the certifications are checked at 710 (e.g., instead of sending an allow command at 712 described above).

At 716, second application 704, which runs within a container operating in vehicle OS 206, transmits a request to vehicle OS 206. In this example, the request is for second application 704 to perform a function not permitted by second application's 704 digital certificate (and/or by a certificate of the container storing second application 704). At 718, vehicle OS 206 checks certifications of the container and second application 704 by having digital certificate manifesto layer 204 verify that second application 704 and its corresponding container have the appropriate digital certificates. However, since vehicle OS 206 does not permit second application 704 to perform the requested task, vehicle OS 206 sends a deny message 720 to second application 704. In some embodiments, second application's 704 access to certain data streams or data is based on agreements with the vehicle manufacturer. For example, second application 704 may be running within an insurance container which has digital certificates that permit applications to monitor data streams associated with vehicle usage data such braking, acceleration, mileage, and/or speed. However, second application 704 may only have access to some of the data in the data streams provided to the container such as vehicle mileage and speed. As such, in response to second application 704 not having the correct certification, vehicle OS 206 denies the request to application 704. In some embodiments, updates to the agreement result in a change in permissions (e.g., and a new and/or updated certificate for an application and/or container).

At 722, first application 702 transmits a request to vehicle OS 206. In this example, the request is for access to control a display of the vehicle. The request includes a command to control the display for entertainment features such as game play, video chat, and/or movies. At 724, vehicle OS 206 checks certifications of the container and first application 702 by having digital certificate manifesto layer 204 verify that first application 702 and its corresponding container have the appropriate digital certificates. At 726, vehicle OS 206 denies the request from application 704, even though application 704 and the container inside of which application 704 runs both have the appropriate digital certificates for the requested function. In this example, vehicle OS 206 denies application 702 request after checking certifications because of the current state of the vehicle. In this example, vehicle OS 206 may place constraints that limit permissions granted even with the appropriate digital certificates. In some embodiments, these constraints may be temporary. In this example, because the vehicle is moving at speed greater 35 miles per hour, the vehicle OS 206 denies request 718, because vehicle OS 206 is configured to reduce distraction to drivers when the vehicle is driving speeds greater than 35 mph.

At 728, second application 704 requests access to vehicle speed and mileage after a vehicle trip is completed. At 730, vehicle OS 206 checks certifications of the container and second application 704 by having digital certificate manifesto layer 204 verify that second application 704 and its corresponding container have the appropriate digital certificates. At 732, after verifying with digital certificate manifesto layer 204 that second application 704 and its corresponding container have the appropriate digital certificates, vehicle OS 206 proceeds to 732. At 732, vehicle OS 206 sends an allow command to second application 704 to communicate with vehicle component to 706. At 734, second application 704 and vehicle component 706 communicate to execute second application's 704 request.

In some embodiments, first application 702 may be an insurance application running in a first container and second application 704 is a food delivery application running in a second container. The first container is designed for insurance applications and has digital certificates that enable the container to read certain driving data such as vehicle acceleration, driving speed, and braking data from the CAN bus. The insurance application also has digital certificates that enable the application to read driving data such as vehicle acceleration, driving speed, and braking data from the CAN bus. The second container is designed for autonomous driving applications (such as food delivery applications) and has digital certificates that enable the container to write driving data such as acceleration data, driving speed data, and braking data to the CAN bus. In this example, the food delivery application, second application 704, has a digital certificate that enables it to write driving data such as acceleration data, driving speed data, and braking data to the CAN bus. For example, if the food delivery application was incorrectly downloaded to the insurance container, the food delivery application would be denied access to write to the CAN bus (despite that the application certificate permitted it to do so) because the insurance container merely has a digital certificate permitted to read operations for the relevant data streams. Requiring digital certificates for the container and the application to both have the correct permissions can prevent an application downloaded into an incorrect container from exceeding the permission level of the container to access data streams from a CAN bus.

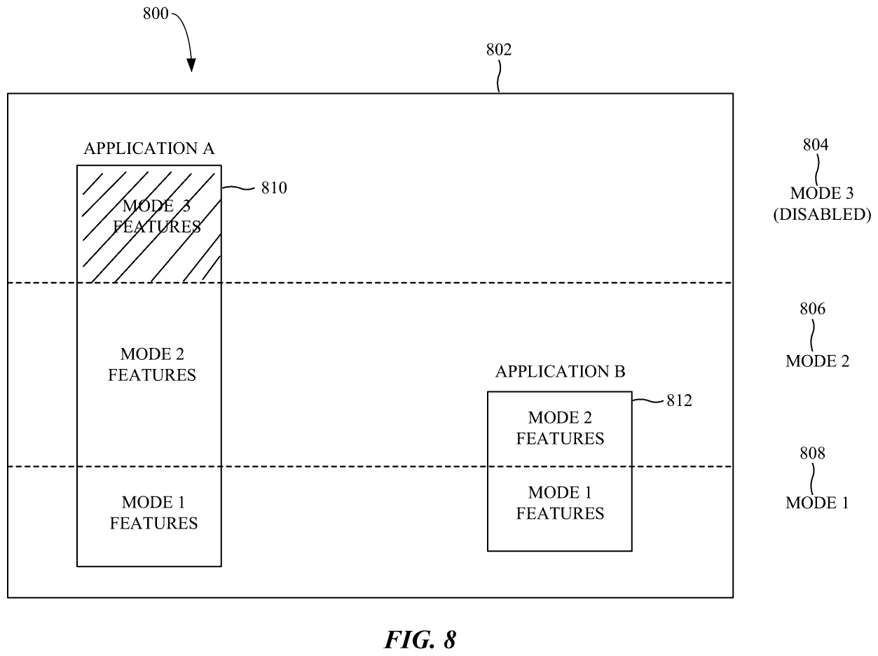

FIG. 8 is a block diagram 800 that illustrates a container and containerized applications running at second mode 806, in accordance with some embodiments. As discussed with respect to FIG. 2, containers and/or applications can operate in a variety of modes (e.g., controlled by the container and/or a vehicle OS). For example, container 802 enables containerized applications to operate in three modes: a third mode 804, a second mode 806, and a first mode 808. In this example, the vehicle OS 206 enables containerized applications to perform a different set of functions (e.g., different numbers of, different sets of, and/or different types of functions). For example, in third mode 804, containerized applications are permitted to monitor and calculate data from data streams of the CAN bus. In second mode 806, containerized applications are permitted to monitor and calculate data from data streams of the CAN bus and to present (e.g., via a user interface and/or audio output) the data within the vehicle. In third mode 804, containerized applications are permitted to calculate, present, and also transmit data to a third party. In some embodiments, vehicle OS 206 dynamically changes the operating mode in which a container can operate while maintaining the same permissions provided in the digital certificate. That is, the container maintains the permissions to the data streams provided in the digital certificate. However, the operations by containerized applications allowed on the data from the data stream are changed.

As illustrated in FIG. 8, Application A 810 and Application B 812 both run within container 802. Container 802 is assigned digital certificates which enable containerized applications running within container 802 to access certain data streams and ECUs of the vehicle. For example, container 802 may be a smart city container that allows the vehicle to interact with smart city initiatives like toll payments and/or traffic monitoring. Container 802 has a digital certificate which permits the container access to data stream related to vehicle's location and speed and to ECUs that enable payment functions. Application A 810 is designed with features that utilize all three operating modes. For example, in the first mode, Application A 810 may collect and calculate information such as the vehicle's speed and location. In the second mode Application A 810 may present data to the user via a user interface while collecting data. In the third mode, Application A 810 may transmit data to a source such as a server. For example, while in a third mode, Application A 810 may be able to pay tolls to a payment server or provide the collected vehicle data to smart city server which utilizes the data to provide traffic patterns for a geographic area. However, since vehicle OS 206 can dynamically change the operating mode of Application A 810 (and/or container 802) certain functions of the application can be dynamically controlled by vehicle OS 206.

As illustrated in FIG. 8, Application A 810 and Application B 812 are operating in second mode 806. As such, features corresponding to third mode of Application A 810 are disabled by vehicle OS 206. That is, vehicle OS 206 prevents the container from transmitting data or making payments through any containerized applications running within container. In some embodiments, vehicle OS 206 may decide which mode an application in a container operates in based on the identity (e.g., represented by an account) of the driver. This way, vehicle OS 206 can customize functionality to certain drivers. For example, a younger driver may be subject to a rule that disables all interactive controls for media when the vehicle is moving at any speed, while a more experienced driver may have access to such controls up to a certain speed (e.g., 30 mph).

As shown in FIG. 8, Application B 812 is designed with features that are available in second mode 806 and first mode 808. In some embodiments, applications can be designed to operate in fewer than all possible modes. The ability for designers to select the modes in which applications work enables the manufacturer of a vehicle to provide programmers of applications with different design options. In this example, Application B 812 does not lose functionality by virtue of container 802 operating in second mode 806 (e.g., which stands in contrast to Application A 810).

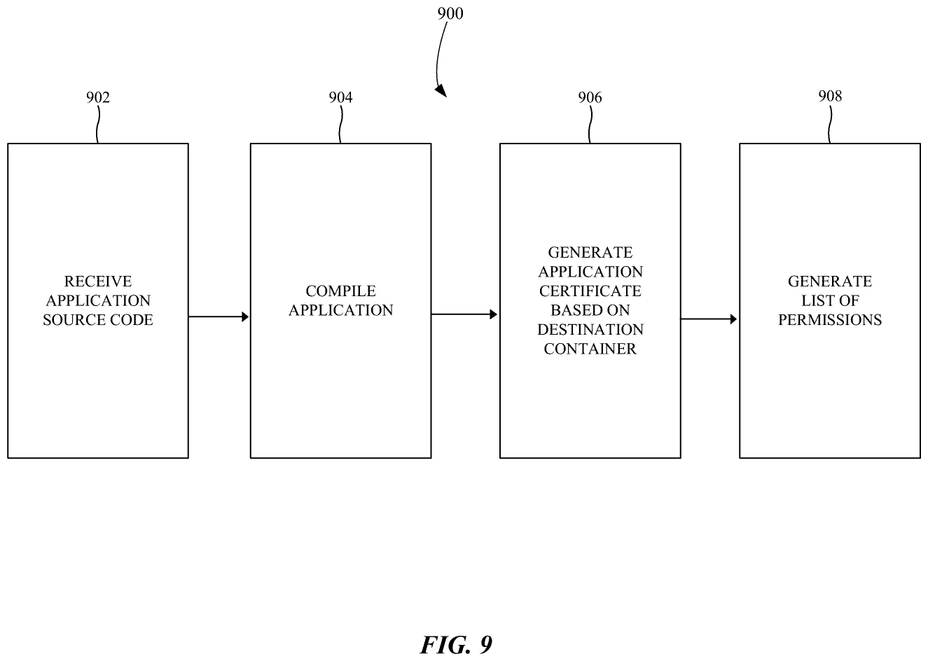

FIG. 9 is a flow diagram illustrating process 900 to generate certificates for applications compatible with containers running on vehicle OS 206, in accordance with some embodiments. In some embodiments, process 900 is performed by one or more components of a vehicle, wherein such components can be implemented in hardware and/or software. In some embodiments, process 900 is performed by vehicle OS 206. In some embodiments, process 900 is performed by an application installed on vehicle OS 206.

In some embodiments, applications are published and available for download to vehicle OS 206 through an application store (e.g., marketplace) managed by a vehicle manufacturer or a third party. For example, the application store offers downloadable applications that are certified by the application store and meet certain performance and privacy requirements to be available to owners and/or users of the vehicle. Such performance and privacy requirements include, for example, the ability to be containerized and a valid certificate for the application.

A programmer can design and code an application for vehicle OS 206 through platform software. Additionally, programmers can select from a variety of software development kits (SDKs) approved by the vehicle manufacture or application store which are designed for specific containers. That is, SDKs can provide a package of tools and libraries to develop features compatible with a corresponding container. For example, a programmer working on developing an application for a media content playback container may use an SDK which provides tools to set up communications for streaming networks, encoding and decoding media content, outputting audio and video. In some embodiments, SDKs can be set up so that certain features (e.g., data streams, bundled data streams, and/or tiers) can be bought by developers while others are provided for free. In some embodiments, SDKs provide a simulation (and/or virtualization) environment in which the application can be run and tested. After the developer has developed and tested the application, the developers can submit the source code of the application to an application store and/or a vehicle manufacturer, for certification.

At 902, the SDK (e.g., a local computer system and/or a remote computer system such as one or more servers) receives application source code submitted by the developer. For example, a developer provides (e.g., enters and/or writes) source code to the SDK tool for creating a desired application that is downloadable to, for example, a vehicle running a vehicle OS as described herein.

At 904, the SDK compiles the application. That is, SDK submits or compiles the source code in a compiler to produce machine code. In some embodiments, the machine code (and/or the source code) is tested and/or evaluated by the SDK, the publisher of the SDK, the application store that will host the application for download, and/or the vehicle manufacturer. During this testing, the testers/evaluator(s) can ensure that the submitted application meets certain standards (e.g., indicated by terms and conditions of a license and/or agreement, by government standards, and/or by industry standards).

At 906, after the SDK compiles and tests the source code, the SDK generates an application certificate based on a destination container. In some embodiments, the digital certificate memorializes functions permitted to be performed by the application. In some embodiments, the SDK coordinates with one or more remote computer systems (e.g., servers) to generate the certificates (e.g., requests that a trusted server generate the certificates). Additionally, the application store can confirm that there is not a conflict between digital certificates of the container and the application.

At 908, the SDK generates a list of permissions (e.g., permitted functions) to the application. For example, this list of permissions can accompany and/or be included in a digital certificate such as a certificate generated at 906. Once the application is associated with a valid certificate, it can be made available (e.g., published) through the application store for download to a container managed by vehicle OS 206.

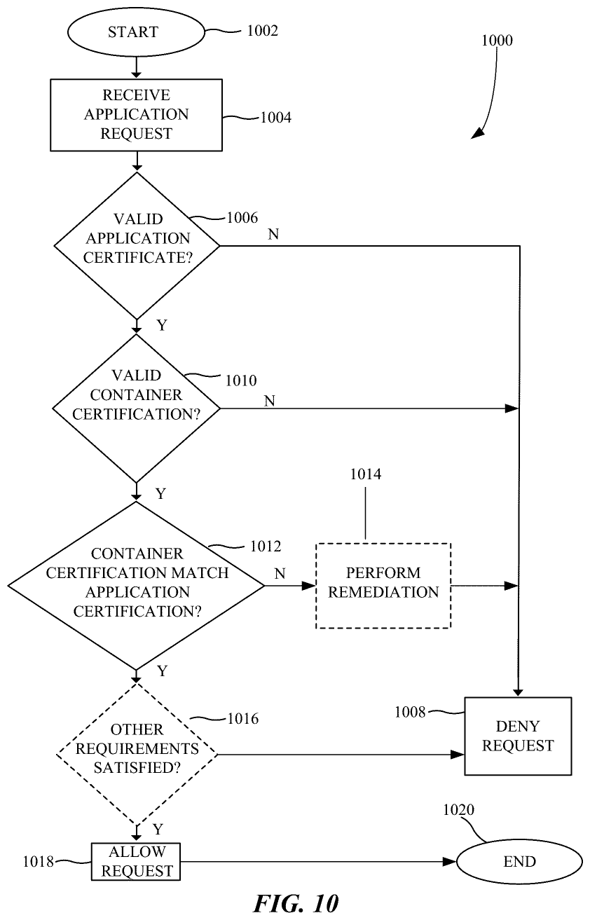

FIG. 10 is a flow diagram illustrating process 1000 for verifying digital certificates for applications, in accordance with some embodiments. In some embodiments, process 1000 is performed by one or more components of a vehicle, wherein such components can be implemented in hardware and/or software. In some embodiments, process 1000 is performed by vehicle OS 206. In some embodiments, process 1000 is performed by an application installed on vehicle OS 206.

At 1002, process 1000 starts. At 1004, vehicle OS 206 receives an application request to initiate and/or perform a function. After receiving the request, process 1000 proceeds to 1006. At 1006, vehicle OS 206 determines whether the application has a valid application certificate. That is, vehicle OS 206 checks to see whether the application has the appropriate digital certificate to perform the requested function of the application. In some embodiments, the determination is performed through digital certificate manifesto layer 204. If it is determined that the application does not have the appropriate digital certificate, vehicle OS 206 proceeds to 1008 and denies the request. Alternatively, if at 1006, vehicle OS determines that application possesses the appropriate digital certificate, vehicle OS 206 proceeds to 1010. In some embodiments, the determination is performed through digital certificate manifesto layer 204.

At 1010, vehicle OS 206 determines whether the container has a valid container certification. That is, vehicle OS 206 checks whether the container in which the application resides has the appropriate digital certificate needed to perform the requested function of the application. In some embodiments, the determination is performed through digital certificate manifesto layer 204. In some embodiments, the determination of whether the container possesses the right digital certificate is performed before and/or in conjunction with the determination that the application possesses the correct digital certificate for the requested function. If it is determined that the container does not have the appropriate digital certificate, process 1000 proceeds to 1008 and denies the request. Alternatively, if at 1010 vehicle OS determines that container possesses the appropriate digital certificate, process 1000 proceeds to 1012. In some embodiments, the determination is performed through digital certificate manifesto layer 204.

At 1012, vehicle OS 206 determines whether the container's certification matches the application's certification. That is, vehicle OS 206 checks to see if the container's digital certificate and application digital certificate match (e.g., are not in conflict and/or are not inconsistent). If it is determined that the container's digital certificate and the application digital certificate do not match, vehicle OS 206 optionally proceeds to 1014. For example, the application digital certificate provides for a function not provided in the container digital certificate or the respective certificates indicate mismatched version numbers. At 1014, vehicle OS 206 performs a remedial (e.g., corrective) action. For example, as result of mismatch between digital certificates, vehicle OS 206 may uninstall the application, look for a later version of the application, and/or report the discrepancy to the application store. Additionally, if the application is found to have been hacked or contains a virus, vehicle OS 206 can proceed with quarantining the application, alerting the user, removing the application, and/or continuously monitoring the system to see if any other applications or containers have been affected. After performing the remediation, vehicle OS 206 proceeds to 1008 and denies the request to perform the application's requested function.

If vehicle OS 206 determines that the digital certificate for the application and the container are not in conflict (e.g., match), process 1000 proceeds to 1016. At 1016, vehicle OS 206 optionally determines whether other requirements are satisfied (e.g., how other criteria such as the container's operating mode affects the requested application). If such requirements are satisfied, process 1000 proceeds to 1018. At 1018, vehicle OS 206 allows the request. After allowing the request, the process terminates at 1020. If the requirements at 1016 are not satisfied, the process proceeds to 1008 where the request is denied. After denying the request at 1008, the process terminates at 1020.

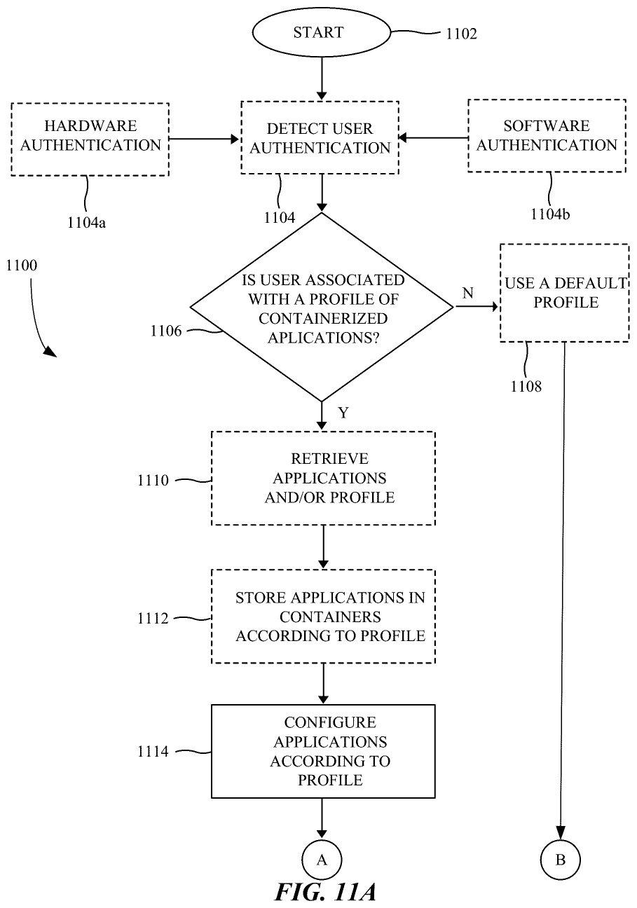

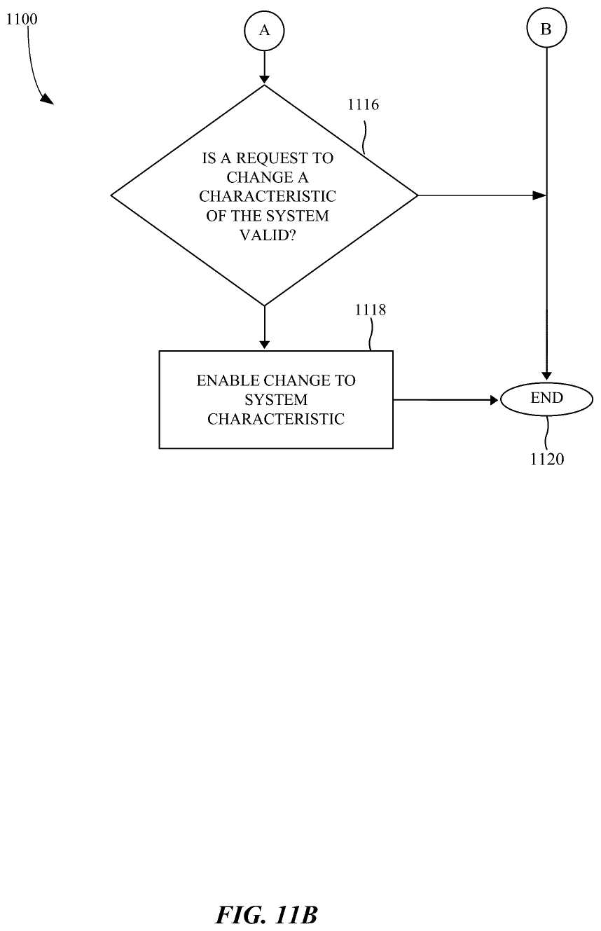

FIGS. 11A-11B illustrate a flow diagram depicting process 1100 for configuring a software defined vehicle, in accordance with some embodiments. In some embodiments, process 1100 is performed by one or more components of a vehicle, wherein such components can be implemented in hardware and/or software. In some embodiments, process 1100 is performed by vehicle OS 206. In some embodiments, process 1100 is performed by an application installed on vehicle OS 206.

A software defined vehicle can dynamically customize a vehicle's ecosystem (e.g., components and electronics). In some embodiments, a software defined vehicle can customize a vehicle's settings, functions, operations, and/or features using software (e.g., using software to affect the change and/or software combined with hardware to affect the change). In some embodiments, customization is based on a driver profile (e.g., a user account and/or stored profile of a driver) (and/or one or more passenger profiles). For example, using a driver profile, vehicle OS 206 can customize aspects of the vehicle to the user's preferred settings. A driver profile enables a driver (and/or passenger) to carry customizations across different vehicles (e.g., different vehicle makes and/or models). In some embodiments, these customizations can include customizing a vehicle so that it imports a driver's preferred seat settings, temperature conditions, radio stations, and/or load the user's preferred applications on vehicle OS 206. The driver profile feature is particularly useful in fleet management system, where a business can manage a plurality of vehicles and drivers efficiently. For example, a software defined vehicle can allow a driver to customize any vehicle in fleet to driver's preference. As such, if a driver's vehicle is undergoing maintenance or repair, the driver can continue their tasks on another vehicle and customize the vehicle to the driver's profile (e.g., by loading and/or accessing their profile through any of the vehicles, even if the driver has never used a particular vehicle that is selected for driving).

At 1102, process 1100 starts. At 1104, vehicle OS 206 detects user authentication. In some embodiments, the user authentication can be an authentication performed via hardware authentication 1104a and/or via software authentication 1104b. For example, detecting a user authentication can include detecting that a user account has successfully been authenticated and/or logged into (e.g., using a software password input by a user and/or a piece of hardware such as a biometric scanner, a physical key, and/or a key fob). In some embodiments, user authentication includes biometric authentication that is performed using a plug-in device. In some embodiments, vehicle OS 206 allows data from the plug-in device to be distributed to the CAN bus. In some embodiments, vehicle OS 206 enables one or more applications running within one or more containers to access the data input into the plug-in device (e.g., via a CAN bus data stream from the plug-in device). In some embodiments, vehicle OS 206 enables access, via the CAN bus, to data streams from plug-in devices (such as an exterior camera (e.g., for facial recognition) and/or fingerprint scanner) by containerized applications that correspond to the plug-in device. For example, vehicle OS can allow access to the data stream originating from an aftermarket camera that is plugged into the vehicle to an application that corresponds to the aftermarket camera. Access to this data stream can be used by the application to control opacity of windows in the vehicle and/or be used to perform autonomous driving functions (e.g., the aftermarket camera can provide additional vision input that enables more advanced autonomous driving features than the vehicle was capable of before the aftermarket camera was connected). After detecting the user authentication, process 1100 proceeds to 1106.

At 1106, vehicle OS 206 determines if the authenticated user is associated with a profile of containerized applications. In some embodiments, determining if the authentication user is associated with a profile of containerized application includes determining that the profile is accessible (e.g., available) to vehicle OS 206, compatible with vehicle OS 206, and/or otherwise of a type that can be used to import and/or customize settings. For example, vehicle OS 206 determines if the authenticated user's profile includes settings for applications running on vehicle OS 206. However, an authenticated profile can include settings for applications that are not installed on vehicle OS 206. In some embodiments, vehicle OS 206 can be caused to download and/or install such applications if the authenticated user profile is used. If vehicle OS 206 determines that the authenticated user does not have a user profile for the containerized applications, process 1100 proceeds to 1108. At 1108, vehicle OS 206 uses a default profile to apply to the containerized applications. For example, this could be a guest profile, the last used profile, and/or other preselected profile to use when no specific account is authenticated.

Alternatively, if at 1106, vehicle OS 206 determines that the authenticated user does have a user profile to apply to the containerized applications, process 1100 proceeds to 1110. At 1110, vehicle OS 206 retrieves containerized applications and/or settings profiles for the containerized applications. For example, vehicle OS 206 can download and install applications that are not currently installed and/or import settings for applications that are installed but that will be customized. After these items are retrieved, process 1100 proceeds to 1112. At 1112, vehicle OS 206 stores applications according to the authenticated user's profile. For example, newly downloaded and installed applications are placed into containers according to the authenticated profile. After the applications are stored, process 1100 proceeds to 1114. At 1114, vehicle OS 206 configures the applications according to the user profile. In some embodiments, configuring the applications according to the user profile includes applying settings profiles to applications (and/or any other software and/or hardware settings of the vehicle). For example, an authenticated user profile can use an application that provides driving assistance features (e.g., adaptive cruise control, automatic lane changing, and/or automatic parking) that is configured in a manner customized to the corresponding user's preferences (e.g., default following distance, speed of lane change, and/or minimum parking spot size), wherein such settings may be different from the existing settings and/or involve a different application (and/or process) than what exists on the vehicle before loading the authenticated user profile. After configuring the applications according to the profile, process 1100 proceeds to 1116.

At 1116, vehicle OS 206 detects a request to change a characteristic of vehicle OS 206, such as a setting for a containerized application. For example, configuring applications according to the profile at 1114 can involve a request to change a system characteristic (e.g., existing setting of the vehicle, the vehicle OS, and/or application). In some embodiments, such requests are processed to determine whether such changes are valid (e.g., allowed and/or possible). For example, a settings change can require re-mapping the functions of hardware buttons of a vehicle. However, if the vehicle OS 206 does not include the same number, type, and/or configuration of buttons, the request (or a portion thereof) may be considered invalid. As another example, some configuration changes may not be valid for other reasons such as applicable restrictions placed on the vehicle (e.g., restrictions by the manufacturer, by the vehicle OS, and/or by the owner of the vehicle that apply globally to features and/or applications of the vehicle). If vehicle OS 206 determines that the request is invalid, process 1110 proceeds to 1120 and ends. Alternatively, if vehicle OS 206 determines that the request (and/or some portion thereof) is valid, process 1100 proceeds to 1118. At 1118, vehicle OS 206 enables changes to system characteristics (e.g., changes to one or more settings, movement characteristics, and/or operational states of the vehicle). After enabling the changes to system characteristics, process 1100 proceeds to 1120 and ends.

In some embodiments, updates are made to the user profile while it is loaded and/or being used by vehicle OS 206. In some embodiments, these updates are caused to be stored with the user profile such that they will be reflected when the user profile is loaded in the future (e.g., by another vehicle). In some embodiments, causing these updates to be stored include updating a database (e.g., remote and/or cloud-based database) to reflect the changes (e.g., application, settings, and/or preferences changes). In this way, the changes to containerized applications will be maintained next time the user utilizes the user profile. In some embodiments, vehicle OS 206 outputs a prompt requesting permission to update the user profile to reflect one or more updates made to the user's profile (e.g., within a certain application and/or globally in a manner applicable to multiple applications).

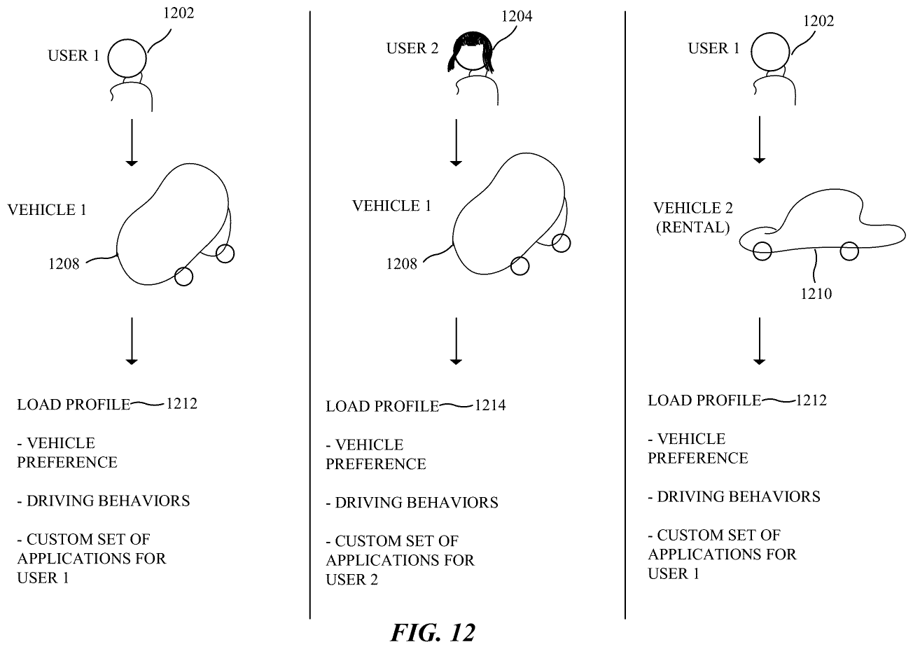

FIG. 12 illustrates diagram 1200 that illustrates software defined vehicles and user profiles, in accordance with some embodiments. Diagram 1200 may be useful for understanding concepts described above with respect to process 1100 in FIGS. 11A-11B.

FIG. 12 depicts first vehicle 1208 which is used by first user 1202. First user 1202 has profile 1212 that includes vehicle preferences of first user 1202 (e.g., vehicle settings and/or customizations), information on driving behaviors of the user, and a custom set of applications (and parameters (e.g., settings) for the custom set of applications) to customize the ecosystem of a vehicle. After first user 1202 authenticates themselves to first vehicle 1208, vehicle OS 206 loads the profile 1212 and configures the vehicle to first user's profile 1212.

After first user 1202 has finished using the first vehicle 1208, a second user 1203 uses first vehicle 1208. After second user 1204 authenticates herself to the first vehicle 1208, vehicle OS 206 loads profile 1214 and configures the first vehicle 1208 to second user's profile 1214.

As shown in FIG. 12, first user 1202 may decide to rent second vehicle 1210. By authenticating himself at the second vehicle 1210, a vehicle OS of the rental vehicle loads the same (and/or similar) profile 1212 that first user 1202 uses with first vehicle 1208 (e.g., which first user 1202 owns). Loading profile 1212 allows the rental vehicle to be customized to the user's preferences without excessive input required from first user 1202 upon entering second vehicle 1210. Loading a user's actual profile can also enable additional features within second vehicle 1210. For example, third parties such as insurance companies can obtain an accurate profile of the user to tailor products to the user's needs and driving habits. For example, an insurance company can provide an accurate insurance rate based on information in the profile such as the user's driving history.

In some embodiments, a user profile can be utilized to alert users of differences between previously driven vehicles (e.g., historical data) and new vehicles to be driven by the user. In some embodiments, a user profile can be utilized to alert users of geographic driving customs. For example, first user 1202 can live in the United States and as such be familiar with vehicle configuration (e.g., steering wheel location and/or a mirror location) and driving regulations for vehicles in the United States. When first user 1202 rents a vehicle in a country other than the United States and loads their profile onto the rented vehicle, the vehicle can output (e.g., based on the user's profile) an alert regarding local driving rules and/or differences in the vehicle (e.g., to the user's prior vehicle and/or to vehicles from the United States). In some embodiments, the vehicle can provide an appropriate tutorial describing basic functions of the vehicle and/or rules of the current country.

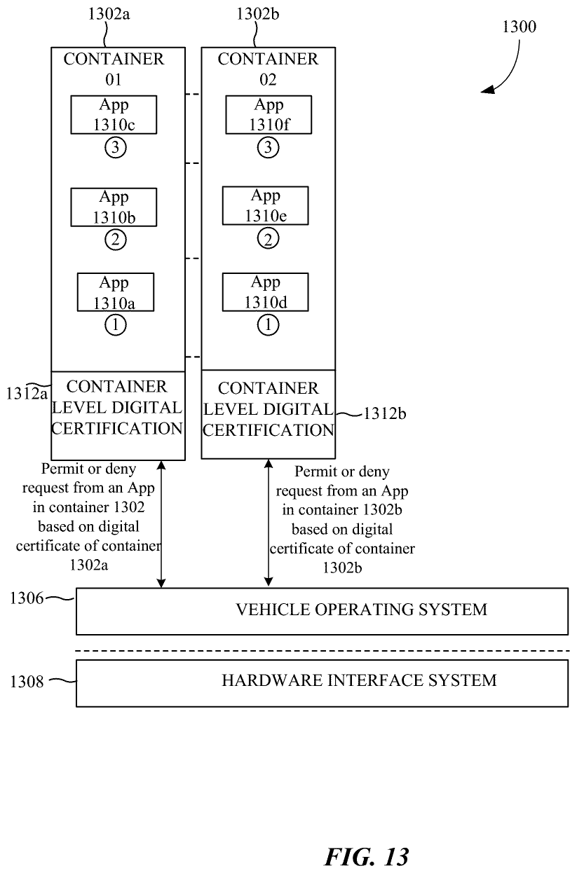

FIG. 13 is a diagram that illustrates a computer architecture for permitting access to a communication bus (e.g., 1308) in accordance with some embodiments. The vehicle system (e.g., 1300) (e.g., an electric vehicle, a car, a boat, a truck, a van, an aircraft, a bike, and/or a motorcycle) comprises one or more processors; memory; an operating system (e.g., 1306) (e.g., an automotive grade Linux operating system and/or a real-time operating system) stored into the memory.

The vehicle system (e.g., 1300) comprises a first container (e.g., 1302a and/or 1302b) (e.g., an application container) (e.g., a package of one or more applications, code, and/or one or more instructions, and/or a space and/or allocation of memory) (e.g., a container associated with one or more particular types of applications (e.g., insurance applications, rental applications (and, in some embodiments, the vehicle system is being rented), applications associated with operation, ownership, and/or control over a vehicle)) stored into memory; a second container (e.g., 1302a and/or 1302b) stored into memory different from (e.g., separate from, stored in a different place in memory, and/or stored with a different reference and/or identifier) the first container (e.g., 1302a and/or 1302b) stored into memory; a first set of one or more applications (e.g., 1310a-1310c and/or 1310d-1310f) (e.g., one or more insurance applications, mission critical applications, vehicle control applications, enterprise application, payment applications, and/or mobile game applications) (e.g., one or more processes, code, and/or sets of instructions) stored with respect to (e.g., associated with, stored in, stored into memory designated as belonging to, and/or corresponds to a memory location of) the first container (e.g., 1302a and/or 1302b). In some embodiments, the first container (e.g., 1302a and/or 1302b) corresponds to a first digital certificate (e.g., 1312a and/or 1312b) (e.g., a set of one or more permissions (e.g., permission to read from other applications and/or components (e.g., speaker, tires, wheel, and/or windshield wipers) of the vehicle system)). In some embodiments, the operating system (e.g., an operating system developed by a car manufacturer, original equipment manufacturer, and/or an entertainment system and/or head unit manufacturer) permits (e.g., 1314 and/or 1316) (e.g., enables, restricts, does not restrict, blocks, and/or does not block) the first set of one or more applications to perform a first set of one or more operations (e.g., read operations and/or write operations (e.g., via a communication bus, a controller area network bus, and/or an electronic bus)) according to the first digital certificate.

The vehicle system (e.g., 1300) comprises a second set of one or more applications (e.g., 1310a-1310c and/or 1310d-1310f) stored with respect to the second container (1302a and/or 1302b). In some embodiments, the second container (1302a and/or 1302b) corresponds to a second digital certificate (e.g., 1312a and/or 1312b) different from the first digital certificate (e.g., 1312a and/or 1312b). In some embodiments, the operating system (e.g., 1306) permits (e.g., 1314 and/or 1316) the second set of one or more applications (e.g., 1310a-1310c and/or 1310d-1310f) to perform a second set of one or more operations, different from the first set of one or more operations, according to the second digital certificate (e.g., 1312a and/or 1312b). In some embodiments, the plurality of containers (e.g., 1302a and/or 1302b) is separate from the operating system (e.g., 1306), different from the operating system, and/or stored in a different place in memory than the operating system. In some embodiments, the operating system (e.g., 1306) does not permit (e.g., 1314 and/or 1316) the first set of one or more applications (e.g., 1310a-1310c and/or 1310d-1310f) to perform a set of one or more operations different from the first set of one or more applications (e.g., 1310a-1310c and/or 1310d-1310f) and/or does not permit (e.g., 1314 and/or 1316) the first set of one or more applications (e.g., 1310a-1310c and/or 1310d-1310f) to perform an operation that is restricted according to the first digital certificate. In some embodiments, the operating system does not permit the second set of one or more applications to perform a set of one or more operations different from the second set of one or more applications and/or does not permit the second set of one or more applications to perform an operation that is restricted according to the second digital certificate. In some embodiments, the first set of one or more applications is a first type of application and the second set of one or more applications are a second type of application. In some embodiments, the first type of application is defined and/or associated with the first container and not the second container. In some embodiments, the second type of application is defined and/or associated with the second container and not the first container. In some embodiments, the operating system does not permit the second set of one or more applications to perform the second set of one or more operations according to the first digital certificate. In some embodiments, the operating system does not permit the first set of one or more applications to perform the first set of one or more operations according to the second digital certificate.

In some embodiments, the vehicle system comprises a plurality of vehicle components (e.g., one or more vehicle hardware components (e.g., engine, windshield wipers, speakers, a braking system, an acceleration system, and/or a steering system)). In some embodiments, the vehicle system comprises a communication bus that permits the plurality of vehicle components to send and receive data. In some embodiments, the operating system allows one or more of the first set of one or more applications and/or the second set of one or more applications to communicate with the plurality of vehicle components by allowing the first set of one or more applications and/or second set of one or more applications to access, read, and/or write to the communication bus. In some embodiments, the communication bus is a controller access area network. In some embodiments, the communication bus is an ethernet based controller access area network and/or a non-ethernet based controller area access network.

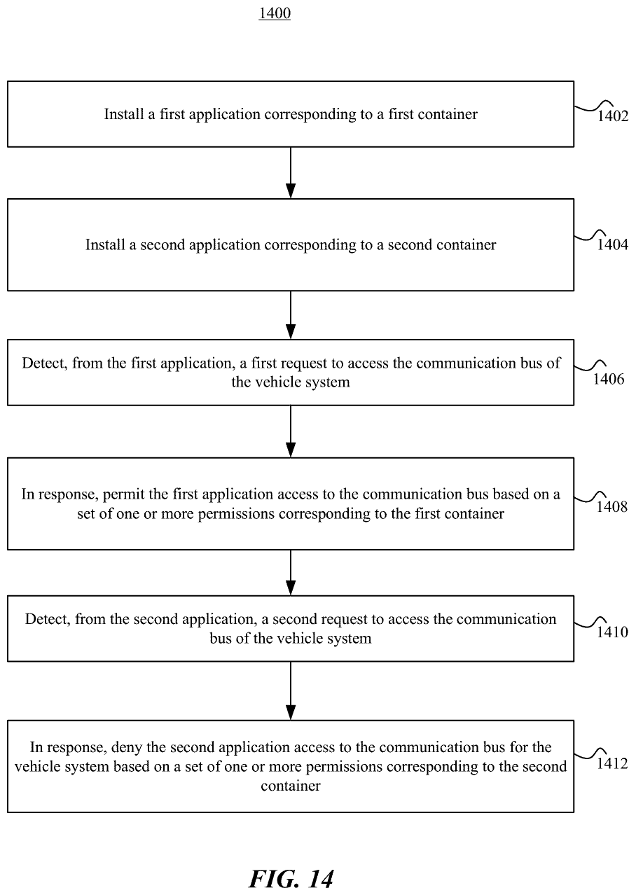

In some embodiments, the vehicle system comprises a manifesto layer (e.g., a security layer, a layer that interacts with and/or stores one or more digital certificates, a layer between one or more applications and the communication bus, a layer between one or more applications and the operating system, and/or a layer between the operating system and the communications bus), wherein the operating system permits an application to communicate via the communication bus using the manifesto layer based on one or more digital certificates (e.g., as described below in relation to FIGS. 14-17).

In some embodiments, permitting the application to communicate via the communication bus using the manifesto layer includes permitting data to be obtained by the application. In some embodiments, permitting data to be obtained by the application includes permitting the application to be read by the application and/or sent by the operating system to the application. In some embodiments, permitting data to be obtained by the application includes permitting the application to read data from the communication bus.

In some embodiments, permitting the application to communicate via the communication bus using the manifesto layer includes permitting the application to write data to the communication bus. In some embodiments, permitting the application to be written to the communication bus by the application causes a change to the operational state (e.g., change in a movement characteristic (e.g., acceleration, speed, direction, and/or velocity) of the vehicle, change as to whether the vehicle is off, on, and/or idle, and/or change in a repair status, such as an engine malfunction and/or a malfunction and/or maintenance to one or more other components of the vehicle system) of the vehicle system.

In some embodiments, the first container has a first application layer (e.g., an operating mode and/or execution mode corresponding to an application). In some embodiments, the first container has a second application layer different from the first application layer. In some embodiments, an application executing (and/or stored) with respect to the first application layer has a first set of restrictions (and/or abilities) (and/or permissions). In some embodiments, an application executing (and/or stored) with respect to the second application layer has a second set of restrictions (and/or permissions) different from the first set of restrictions (and/or abilities). In some embodiments, a respective set of restrictions corresponds to functionalities and/or operations that are restricted for a respective application to perform. In some embodiments, an application layer is a contextual layer, such that an application executes with respect to a respective application layer based on a context in which the vehicle is operating in and/or the context of data being processed by an application that corresponds to the respective application layer. In some embodiments, application layers are tiered, such as a container having a basic application layer, a premium application layer, and/or an elite application layer, where the data that can be accessed by the application is restricted or not restricted based on the tiered application layers.

In some embodiments, the first container is associated with a first type of application (e.g., insurance applications, mission critical applications, car rental applications, delivery applications, taxi services applications, vehicle sharing applications, ride sharing applications, vehicle ownership applications, and/or car maintenance applications). In some embodiments, the second container is associated with a second type of application different from the first type of application. In some embodiments, the first container is not associated with the second type of application. In some embodiments, the second container is not associated with the first type of application.

FIG. 14 is a flow diagram illustrating a method (e.g., method 1400) for permitting access to a communication bus in accordance with some embodiments. In some embodiments, one or more operations described in reference to method 1400 are, optionally, combined, changed, and/or replaced by one or more operations. In some embodiments, the order of one or more operations described in reference to method 1400 are, optionally, changed. In some embodiments, one or more operations described in reference to method 1400 are optionally combined with one or more other methods and/or operations for one or more other methods described herein.

In some embodiments, method 1400 is performed at a vehicle system (e.g., an electric vehicle, a car, a boat, a truck, a van, an aircraft, a bike, and/or a motorcycle), comprising: a communication bus (e.g., controller area network bus, an ethernet bus, and/or a wired communication bus) (e.g., as described above in relation to FIG. 13); one or more processors; and memory storing one or more programs configured to be executed by the one or more processors.

Method 1400 includes installing (1402) a first application (e.g., as described above in relation to FIG. 13) corresponding to (e.g., in and/or at a memory location that corresponds to and/or is associated with) a first container (e.g., as described above in relation to FIG. 13) of a plurality of containers; In some embodiments, the plurality of containers is stored in memory.

Method 1400 includes installing (1404) a second application (e.g., as described above in relation to FIG. 13), different from the first application, corresponding to (e.g., in and/or at a memory location that corresponds to and/or is associated with) a second container (e.g., as described above in relation to FIG. 13), different from the first container, of the plurality of containers. In some embodiments, the first application is not associated with and/or does not correspond to the second container. In some embodiments, the second application is not associated with and/or does not correspond to the first container.

Method 1400 includes detecting (1406) (e.g., in conjunction with (e.g., after, before, and/or while) installing the first application and, in some embodiments, in conjunction with installing the second application), from the first application (and not the second application), a first request to access (e.g., read from, write to, and/or update data) the communication bus of the vehicle system. In some embodiments, as a part of detecting the first request, the first application and/or the vehicle system detects an input directed to a user interface corresponding to the first application and/or a user interaction (e.g., voice interaction, gaze interaction, and/or another type of interaction).

Method 1400 includes, in response to detecting the first request to access the communication bus of the vehicle system, permitting (1408) (e.g., as described above in relation to FIG. 13) the first application access to the communication bus based on a set of one or more permissions corresponding to the first container (and/or the first application) (and not corresponding to the second container) (and not corresponding to the second application). In some embodiments, the set of one or more permissions corresponding to the first container is embodied in an application digital certificate for the first application and/or container digital certificate for the first container (and, in some embodiments, is not embodied in an application digital certificate for the second application and/or container digital certificate for the second container).

Method 1400 includes detecting (1410) (e.g., in conjunction with (e.g., after, before, and/or while) installing the second application and, in some embodiments, in conjunction with installing the first application), from the second application (and not the second application), a second request to access the communication bus of the vehicle system. Method 1400, as a part of detecting the second request, the second application and/or the vehicle system detects an input directed to a user interface corresponding to the second application and/or a user interaction (e.g., voice interaction, gaze interaction, and/or another type of interaction).

Method 1400 includes, in response to detecting the second request to access the communication bus of the vehicle system, denying (1412) the second application access to the communication bus of the vehicle system based on a set of one or more permissions corresponding to the second container (and/or the second application) (and not corresponding to the first container) (and not corresponding to the first application). In some embodiments, the set of one or more permissions corresponding to the second container is embodied in an application digital certificate for the second application and/or container digital certificate for the second container (and, in some embodiments, is not embodied in an application digital certificate for the first application and/or container digital certificate for the first container). In some embodiments, the vehicle system comprises one or more features and/or characteristics of the vehicle system described above in relation to FIG. 13. In some embodiments, the first container is different from the second container. In some embodiments, the first container is the same as the second container.

In some embodiments, the first container and the second container are the same. In some embodiments, the first container is combined with the second container and/or stored within, in, and/or referencing the same memory space and/or in adjacent memory spaces.

In some embodiments, the first container and the second container are different. In some embodiments, the first container and the second container are separate from each other and/or are not combined with the second container and/or stored within, in, and/or referencing the same memory space and/or in adjacent memory spaces.

In some embodiments, the set of one or more permissions corresponding to the first container includes (and/or obtained from and/or read from) a first digital certificate (e.g., as described above in relation to FIG. 13). In some embodiments, the set of one or more permissions corresponding to the second container includes a second digital certificate (e.g., as described above in relation to FIG. 13). In some embodiments, the first digital certificate is the same as the second digital certificate. In some embodiments, the first digital certificate is different from the second digital certificate. In some embodiments, the first digital certificate references and/or is stored with respect to the second digital certificate.

In some embodiments, the first digital certificate is stored with respect to the first container. In some embodiments, the second digital certificate is stored with respect to the second container. In some embodiments, a third digital certificate is stored with respect to the first application. In some embodiments, a fourth digital certificate is stored with respect to the second application. In some embodiments, the first digital certificate, the second digital certificate, the third digital certificate. In some embodiments, the fourth digital certificate are different from each other.

In some embodiments, the first request to access the communication bus of the vehicle system and the second request to access the communication bus of the vehicle system is the same type of request (e.g., two request that is a part of another request and/or request that is a part of the same data stream). In some embodiments, the first request and/or the second request is a request to perform the same operation and/or the same type of operation (e.g., display content, change movement of vehicle, change one or more movements characteristics and/or operational states of the vehicle (e.g., as described above in relation to FIG. 13)).

In some embodiments, method 1400 includes detecting (e.g., in conjunction with (e.g., after, before, and/or while) installing the first application and, in some embodiments, in conjunction with installing the second application), from the first application (and not the second application), a third request, different from the first request, to access the communication bus of the vehicle system. In some embodiments, method 1400 includes, in response to detecting the third request to access the communication bus of the vehicle system, denying the first application access to the communication bus based on the set of one or more permissions corresponding to the first container. In some embodiments, method 1400 includes detecting (e.g., in conjunction with (e.g., after, before, and/or while) installing the second application and, in some embodiments, in conjunction with installing the first application), from the second application, a fourth request, different from the second request, to access the communication bus of the vehicle system. In some embodiments, method 1400 includes, in response to detecting the fourth request to access the communication bus of the vehicle system, permitting the second application access to the communication bus of the vehicle system based on the set of one or more permissions corresponding to the second container. In some embodiments, the fourth request is different from third request and/or the second request. In some embodiments, the third request is different from the fourth request and/or the first request.

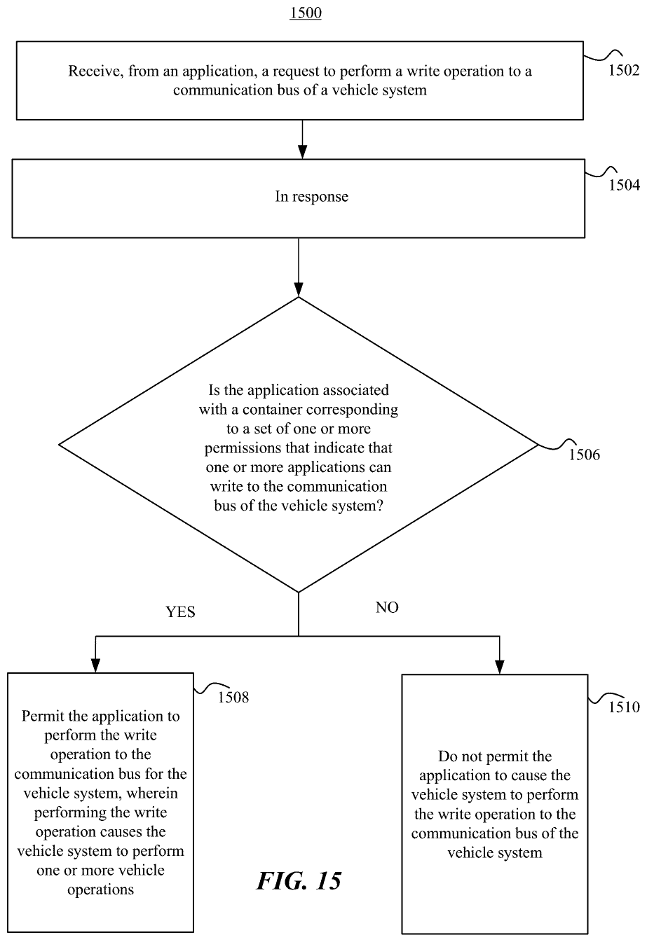

FIG. 15 is a flow diagram illustrating a method (e.g., method 1500) for selectively permitting the writing of data to a communication bus in accordance with some embodiments. In some embodiments, one or more operations described in reference to method 1500 are, optionally, combined, changed, and/or replaced by one or more operations. In some embodiments, the order of one or more operations described in reference to method 1500 are, optionally, changed. In some embodiments, one or more operations described in reference to method 1500 are optionally combined with one or more other methods and/or operations for one or more other methods described herein.

Method 1500 includes receiving (1502), from an application (and, in some embodiments, at a vehicle operating system (e.g., as described above in relation to FIGS. 13-14)) (e.g., at an operating system, at an operating system of a vehicle system, and/or at a vehicle system), a request to perform a write operation to a communication bus (e.g., as described above in relation to FIGS. 13-14) of a vehicle system (e.g., as described above in relation to FIGS. 13-14) (e.g., while performing one or more vehicle operations (e.g., causing or not causing one or more components of the vehicle to move in a certain manner (e.g., speed, direction, and/or intensity), changing (e.g., turning, adjusting, moving, and/or positioning) one or more vehicle hard ware components (e.g., engine, windshield wipers, and/or lights) on and/or off, and/or changing the setting (e.g., air flow setting, brightness setting, sound level setting, and/or navigation setting) of one or more vehicle hardware components).

Method 1500 communication bus of the vehicle system, according to (1506) (e.g., in response to, in accordance with, because of, as a result, and/or after) a determination (e.g., by a vehicle operating system and/or by one or more instructions stored on the vehicle system) that the application is associated with (e.g., installed with, points to in memory, and/or references) a container (e.g., as described above in relation to FIG. 13) corresponding to a set of one or more permissions (e.g., as described above in relation to FIG. 14) that indicate that one or more applications can write to the communication bus of the vehicle system, permitting (1508) (e.g., as described above in relation to FIGS. 13-14) the application to perform the write operation to the communication bus of the vehicle system, wherein performing the write operation causes the vehicle system (and/or causes one or more components (e.g., hardware and/or software components, such as an engine, battery, windshield wipers, speakers, one or more vehicle accessory components, seats, heating system, cooling system, motion system, and/or window tinting and/or window movement systems (e.g., a pulley and/or arm that moves a window in a direction (e.g., up, down, left, right, and/or any combination thereof) of the vehicle system)) to perform one or more vehicle operations (e.g., change one or more movement characteristics and/or operational states, as described above in relation to FIGS. 13-14).

Method 1500 includes, in response to (1504) receiving the request to perform the write operation to the communication bus of the vehicle system, according to (1506) a determination (e.g., by a vehicle operating system and/or by one or more instructions stored on the vehicle system) that the application is associated with (e.g., installed with, points to in memory, and/or references) a container (e.g., as described above in relation to FIG. 13) that does not correspond to the set of one or more permissions that indicate that one or more applications can write to the communication bus of the vehicle system, forgoing permitting (1508) the application to cause the vehicle system to perform the write operation to the communication bus of the vehicle system. In some embodiments, according to a determination that the application is associated with that does not correspond to the set of one or more permissions that indicate that one or more applications can write to the communication bus of the vehicle system, the vehicle system does not perform one or more vehicle operations and/or a change one or more vehicle hardware component in communication with the vehicle system.

In some embodiments, performing the write operation includes broadcasting a controller area network data frame (e.g., a data frame having a set number of fields (e.g., start of frame (SOF), arbitration, control, data, cyclical redundancy check (CRC), acknowledge (ACK), and/or end of frame (EOF)), a set header, and/or a set footer, and/or a data frame designed for use in vehicle systems and/or via a communication bus for a vehicle system) via the communication bus (e.g., to one or more vehicle hardware components (e.g., speakers, doors, engines, sensors, and/or windshield wipers) of the vehicle system) (e.g., as described above in relation to FIG. 13). In some embodiments, the application writes and/or broadcasts the controller area network data frame directly to the communication bus. In some embodiments, an operating system of the vehicle system passes the controller area network data frame from the application to the communication bus. In some embodiments, the operation system constructs the controller area network data frame after receiving data and/or one or more instructions from the applications that indicate that the vehicle system should be caused to perform a particular operation.

In some embodiments, the application is stored with respect to (e.g., as described above in relation to FIG. 13) the container.

In some embodiments, the container is a first container. In some embodiments, the application is not stored with respect to a second container different from the first container. In some embodiments, the second container includes a different application. In some embodiments, the different application is a different type of application (e.g., as described in relation to FIGS. 13-15) than the application.

In some embodiments, the application is a first application. In some embodiments, after permitting the first application to perform the write operation to the communication bus of the vehicle system, method 1500 includes receiving, from a second application different from the first application, a second request to perform a second write operation to the communication bus of the vehicle system, wherein the second application is associated with a third container, and wherein the third container corresponds to a second set of one or more permissions different from the set of one or more permissions (e.g., the first set of one or more permissions). In some embodiments, method 1500 includes, in response to receiving the second request to perform the second write operation to the communication bus of the vehicle system, according to a determination (e.g., by a vehicle operating system and/or by one or more instructions stored on the vehicle system) that the second set of one or more permissions indicate that one or more applications can write to the communication bus of the vehicle system, permitting the second application to perform the write operation to the communication bus of the vehicle system. In some embodiments, according to a determination that the second set of one or more permissions indicate that one or more applications cannot write to the communication bus of the vehicle system, the second application is not permitted to perform the write operation to the communication bus of the vehicle system.

In some embodiments, the application is a third application. In some embodiments, method 1500 includes, after permitting the third application to perform the write operation to the communication bus of the vehicle system, receiving, from a fourth application different from the third application, a third request to perform a third write operation to the communication bus of the vehicle system, wherein the fourth application is associated with a fourth container, and wherein the fourth container corresponds to a third set of one or more permissions different from the set of one or more permissions. In some embodiments, in response to receiving the third request to perform the third write operation to the communication bus of the vehicle system, method 1500 includes according to a determination (e.g., by a vehicle operating system and/or by one or more instructions stored on the vehicle system) that the third set of one or more permissions indicate that one or more applications cannot write to the communication bus of the vehicle system, forgoing permitting the fourth application to perform the write operation to the communication bus of the vehicle system. In some embodiments, according to a determination that the third set of one or more permissions indicate that one or more applications can write to the communication bus of the vehicle system, method 1500 includes permitting the fourth application to perform the write operation to the communication bus of the vehicle system.

In some embodiments, method 1500 includes receiving, from the application, a request to perform a different write operation to the communication bus of the vehicle system. In some embodiments, method 1500 includes, in response to receiving the request to perform a different write operation to the communication bus of the vehicle system, according to a determination that the application is associated with the container corresponding to the set of one or more permissions that indicate that one or more applications can write to the communication bus of the vehicle system and the different write operation corresponds to an operation that is a type of operation that is permitted by the set of one or more permissions, permitting the application to perform the different write operation to the communication bus of the vehicle system. In some embodiments, method 1500 includes, in response to receiving the request to perform a different write operation to the communication bus of the vehicle system, according to a determination that the application is associated with the container corresponding to the set of one or more permissions that indicate that one or more applications can write to the communication bus of the vehicle system and the different write operation corresponds to an operation that is not a type of operation that is permitted by the set of one or more permissions, forgoing permitting the application to perform the different write operation to the communication bus of the vehicle system. In some embodiments, the vehicle system allows the application to cause one or more operations to be performed (e.g., by the vehicle system) while not requiring one or more other operations to be performed. In some embodiments, the vehicle system allows the application to perform one or more write operations without allowing the vehicle system to perform other write operations. In some embodiments, a respective application is permitted and/or not permitted to perform certain operations based on an application digital certificate corresponding to the respective application. In some embodiments, one or more applications that are in a container are restricted and/or permitted to perform one or more of the same operations and not restricted and/or not permitted to perform one or more of the same operations.

In some embodiments, performance of the write operation causes one or more options characteristics (e.g., vehicle characteristics affected and/or controlled by one or more options and/or settings) (e.g., state characteristics and/or motion characteristics) of the vehicle system to change. In some embodiments, one or more state characteristics include one or more characteristics of a vehicle ignition state (e.g., whether vehicle is on, off, transitioning to standby mode, in a standby mode, a lock mode, an accessory mode, and/or a start mode), a user interface state (e.g., state of a display component (e.g., instrumentation cluster, vehicle head unit, and/or infotainment system), an audio component (e.g., amplifier and/or speakers), and/or a lighting component (e.g., interior and/or exterior lighting)), and/or a communication state (e.g., transmitting data to an external system, receiving data from an external system, enabling and/or disabling communication, and/or communication settings (e.g., supported bands, channels, frequencies, protocols, mediums/media, message length, message content, permissible communication time period and/or frequency of messages)). In some embodiments, motion characteristics include one or more of speed, acceleration, direction of travel, wheel angle, destination of travel, a navigation route, and/or vehicle dynamics that affect motion (e.g., of the vehicle and/or a component thereof) (e.g., ride height, suspension stiffness, throttle mapping, shift points, steering mapping, autonomous driving behavior settings, and/or actuation of a mechanical component (e.g., moving an aerodynamic component, a window wiper, and/or a windscreen)).

In some embodiments, the vehicle system includes a manifesto layer, and wherein the operating system permits or does not permit the application to perform the write operation using the manifesto layer based on one or more digital certificates (e.g., as described below in relation to FIGS. 13-14).

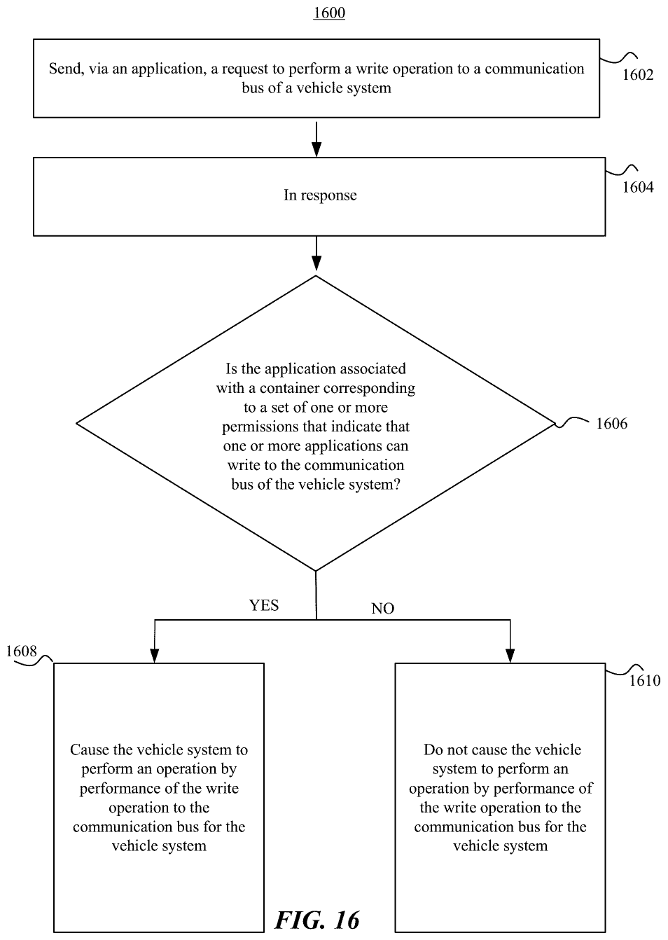

FIG. 16 is a flow diagram illustrating a method (e.g., method 1600) for selectively writing to a communication bus in accordance with some embodiments. In some embodiments, one or more operations described in reference to method 1600 are, optionally, combined, changed, and/or replaced by one or more operations. In some embodiments, the order of one or more operations described in reference to method 1600 are, optionally, changed. In some embodiments, one or more operations described in reference to method 1600 are optionally combined with one or more other methods and/or operations for one or more other methods described herein.

Method 1600 includes sending (1602), via an application (and, in some embodiments, at a vehicle operating system (e.g., as described above in relation to FIG. 13), a request to perform a write operation to a communication bus (e.g., as described above in relation to FIG. 13) of a vehicle system (e.g., as described above in relation to FIG. 13) (e.g., while performing one or more vehicle operations (e.g., causing or not causing one or more components of the vehicle to move in a certain manner (e.g., speed, direction, and/or intensity), turning one or more components (e.g., engine, windshield wipers, and/or lights) on and/or off and/or changing the setting (e.g., air flow setting, brightness setting, sound level setting, and/or navigation setting) of one or more components). In some embodiments, the method is performed by the application. In some embodiments, sending the request to perform the write operation includes the application attempting to write information and/or data to the communication bus. In some embodiments, the method is performed at the application and/or by the application.

Method 1600 includes, in response to (1604) sending the request to perform the write operation to the communication bus of the vehicle system, according to (1606) a determination (e.g., by a vehicle operating system and/or by one or more instructions stored on the vehicle system) that the application is associated with (e.g., installed with, points to in memory, and/or references) a container (e.g., as described above in relation to FIGS. 13-15) corresponding to a set of one or more permissions that indicate that one or more applications can write to the communication bus of the vehicle system, causing (1708) the vehicle system to perform an operation (e.g., a movement operation, a change of status to one or more components and/or settings) by performance of the write operation to the communication bus of the vehicle system. In some embodiments, performing the write operation causes the vehicle system (and/or causes one or more components (e.g., hardware and/or software components, such as an engine, battery, windshield wipers, speakers, one or more vehicle accessory components, seats, heating system, cooling system, motion system, and/or window tinting and/or window movement systems (e.g., a pulley and/or arm that moves a window in a direction (e.g., up, down, left, right, and/or any combination thereof) of the vehicle system)) to perform one or more vehicle operations directed by the application.

Method 1600 includes, in response to (1604) sending the request to perform the write operation to the communication bus of the vehicle system, according to (1606) a determination (e.g., by a vehicle operating system and/or by one or more instructions stored on the vehicle system) that the application is associated with (e.g., installed with, points to in memory, and/or references) a container (e.g., as described above in relation to FIGS. 13-15) that does not correspond to the set of one or more permissions that indicate that one or more applications can write to the communication bus of the vehicle system, forgoing causing (1610) the vehicle system to perform an operation by performance of the write operation to the communication bus of the vehicle system. In some embodiments, according to a determination (e.g., by a vehicle operating system and/or by one or more instructions stored on the vehicle system) that the application is associated with (e.g., installed with, points to in memory, and/or references) a container (e.g., as described above in relation to FIGS. 13-15) that does not correspond to the set of one or more permissions that indicate that one or more applications can write to the communication bus of the vehicle system, the application attempts to perform the write operation but the vehicle system does not perform an operation based on the write operation. In some embodiments, according to a determination (e.g., by a vehicle operating system and/or by one or more instructions stored on the vehicle system) that the application is associated with (e.g., installed with, points to in memory, and/or references) a container (e.g., as described above in relation to FIGS. 13-15) that does not correspond to the set of one or more permissions that indicate that one or more applications can write to the communication bus of the vehicle system, the application does not perform the write operation and the vehicle system does not perform the operation based on the write operation.

In some embodiments, performance of the write operation includes broadcasting a controller area network data frame (e.g., a data frame having a set number of fields (e.g., start of frame (SOF), arbitration, control, data, cyclical redundancy check (CRC), acknowledge (ACK), and/or end of frame (EOF)), a set header, and/or a set footer, and/or a data frame designed for use in vehicle systems and/or via a communication bus for a vehicle system) via the communication bus (e.g., to one or more vehicle hardware components (e.g., speakers, doors, engines, sensors, and/or windshield wipers) of the vehicle system). In some embodiments, the application writes and/or broadcasts the controller area network data frame directly to the communication bus. In some embodiments, an operating system of the vehicle system passes the controller area network data frame from the application to the communication bus. In some embodiments, the operation system constructs the controller area network data frame after receiving data and/or one or more instructions from the applications that indicate that the vehicle system should be caused to perform a particular operation.

In some embodiments, method 1600 includes sending, via the application, a second request to perform a second write operation to the communication bus of the vehicle system. In some embodiments, in response to sending the second request to perform the second write operation to the communication bus of the vehicle system, method 1600 includes according to a determination that the application is associated with the container corresponding to the set of one or more permissions that indicate that one or more applications cannot write to the communication bus of the vehicle system and the application is associated with a set of one or more application permissions, different from the set of one or more permissions that indicate that one or more applications can write to the communication bus of the vehicle system, that indicate that one or more applications can write to the communication bus of the vehicle system, forgoing causing the vehicle system to perform an operation by performance of the second write operation to the communication bus of the vehicle system. In some embodiments, the set of one or more applications permissions are indicated in an application digital certificate. In some embodiments, the application digital certificate is stored with respect to the application. In some embodiments, the application digital certificate is not stored with respect to and/or does not restrict and/or have an impact on the performance of operation from other applications, irrespective of rather the other application is stored with respect to the same container as the application or not. In some embodiments, an application digital certificate is more restrictive than a container digital certificate.

In some embodiments, method 1600 includes sending, via the application, a third request to perform a third write operation to the communication bus of the vehicle system. In some embodiments, method 1600 includes, in response to sending the third request to perform the third write operation to the communication bus of the vehicle system, according to a determination that the application is associated with the container corresponding to the set of one or more permissions that indicate that one or more applications can write to the communication bus of the vehicle system and the application is associated with a set of one or more application permissions, different from the set of one or more permissions that indicate that one or more applications can write to the communication bus of the vehicle system, that indicate that one or more applications cannot write to the communication bus of the vehicle system, causing the vehicle system to perform an operation by performance of the third write operation to the communication bus of the vehicle system.

In some embodiments, method 1600 includes sending, via the application, a fourth request to perform a fourth write operation to the communication bus of the vehicle system. In some embodiments, method 1600 includes, in response to sending the fourth request to perform the fourth write operation to the communication bus of the vehicle system, according to a determination that the application is associated with the container corresponding to the set of one or more permissions that indicate that one or more applications can write to the communication bus of the vehicle system and the application is associated with a set of one or more application permissions, different from the set of one or more permissions that indicate that one or more applications can write to the communication bus of the vehicle system, that indicate that one or more applications cannot write to the communication bus of the vehicle system, forgoing causing the vehicle system to perform an operation by performance of the fourth write operation to the communication bus of the vehicle system.

In some embodiments, method 1600 includes sending, via the application, a fifth request to perform a fifth write operation to the communication bus of the vehicle system. In some embodiments, method 1600 includes, in response to sending the fifth request to perform the fifth write operation to the communication bus of the vehicle system, according to a determination that the application is associated with the container corresponding to the set of one or more permissions that indicate that one or more applications can write to the communication bus of the vehicle system and the fifth write operation corresponds to an operation that is a type of operation that is permitted by the set of one or more permissions, causing the vehicle system to perform an operation by performance of the fifth write operation to the communication bus of the vehicle system. In some embodiments, method 1600 includes, in response to sending the fifth request to perform the fifth write operation to the communication bus of the vehicle system, according to a determination that the application is associated with the container corresponding to the set of one or more permissions that indicate that one or more applications can write to the communication bus of the vehicle system and the fifth write operation corresponds to an operation that is not a type of operation that is permitted by the set of one or more permissions, forgoing causing the vehicle system to perform the operation by performance of the fifth write operation to the communication bus of the vehicle system (e.g., as described above in relation to FIG. 15).

In some embodiments, according to a determination that the application is associated with the container corresponding to the set of one or more permissions that indicate that one or more applications can write to the communication bus of the vehicle system, a motion characteristic of the vehicle system is changed by performance of the write operation to the communication bus of the vehicle system (e.g., whether vehicle is on, off, and/or transitioning to standby mode; whether the navigation path of the vehicle has changed; and/or the speed, direction, and/or acceleration of the vehicle changing) (e.g., as described above in relation to FIG. 15). In some embodiments, performing the operation includes causing an operation state (e.g., as described above in relation FIGS. 13-15) to change.

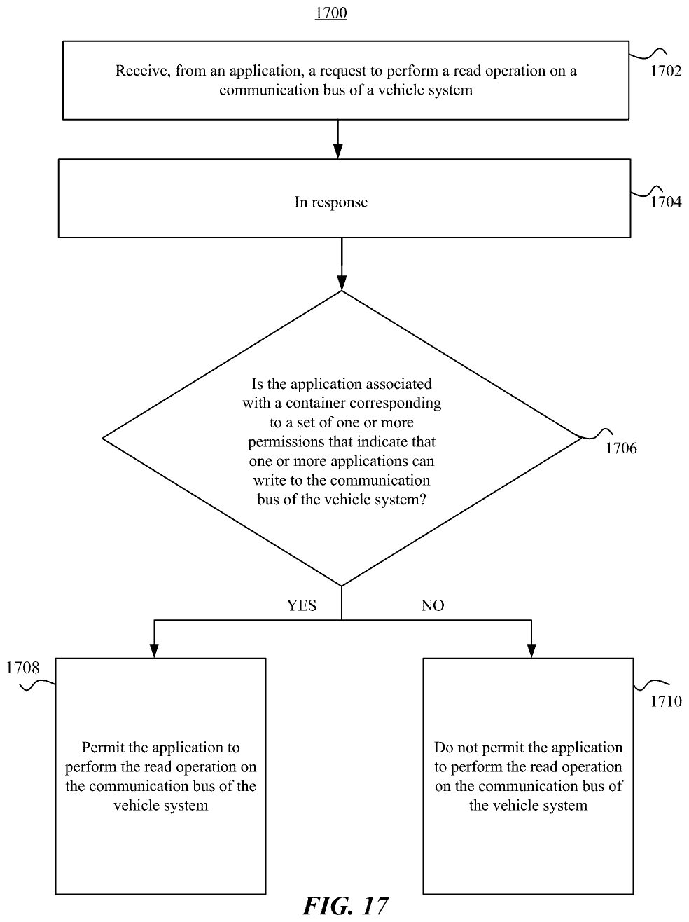

FIG. 17 is a flow diagram illustrating a method (e.g., method 1700) for selectively permitting the reading of data from a communication bus in accordance with some embodiments. In some embodiments, one or more operations described in reference to method 1700 are, optionally, combined, changed, and/or replaced by one or more operations. In some embodiments, the order of one or more operations described in reference to method 1700 are, optionally, changed. In some embodiments, one or more operations described in reference to method 1700 are optionally combined with one or more other methods and/or operations for one or more other methods described herein.

Method 1700 includes receiving (1702), from an application (and, in some embodiments, at a vehicle operating system and/or a vehicle system (e.g., as described above in relation to FIG. 13)), a request to perform a read operation on a communication bus (e.g., as described above in relation to FIG. 13) of a vehicle system (e.g., as described above in relation to FIG. 13).

Method 1700 includes, in response to (1704) receiving the request to perform the read operation on the communication bus of the vehicle system, according to (1706) a determination (e.g., by a vehicle operating system and/or by one or more instructions stored on the vehicle system) that the application is associated with (e.g., installed with, points to in memory, and/or references) a container (e.g., as described above in relation to FIG. 13) corresponding to a set of one or more permissions that indicate that one or more applications can read from the communication bus of the vehicle system, permitting (1808) the application to perform the read operation on the communication bus of the vehicle system (e.g., read data, such as emissions data, engine status data, headlight status data, vehicle motion data, camera data, LiDAR data, radar data, maintenance status data, windshield wiper data, fluid level data, and/or navigation data).

Method 1700 includes, in response to (1704) receiving the request to perform the read operation on the communication bus of the vehicle system, according to (1706) a determination (e.g., by a vehicle operating system and/or by one or more instructions stored on the vehicle system) that the application is associated with (e.g., installed with, points to in memory, and/or references) a container (e.g., as described above in relation to FIG. 13) that does not correspond to the set of one or more permissions that indicate that one or more applications can read from the communication bus of the vehicle system, forgoing permitting (1710) the application to perform the read operation on the communication bus of the vehicle system.

In some embodiments, permitting the application to perform the read operation on the communication bus of the vehicle system includes transmitting data from the communication bus to the application.

In some embodiments, permitting the application to perform the read operation on the communication bus of the vehicle system includes obtaining (e.g., by the application and/or by the operating system) (e.g., reading, acquiring, and/or extracting) a controller area network data frame (e.g., a data frame having a set number of fields (e.g., start of frame (SOF), arbitration, control, data, cyclical redundancy check (CRC), acknowledge (ACK), and/or end of frame (EOF)), a set header, and/or a set footer, and/or a data frame designed for use in vehicle systems and/or via a communication bus for a vehicle system) via the communication bus (e.g., to one or more vehicle hardware components (e.g., speakers, doors, engines, sensors, and/or windshield wipers) of the vehicle system). In some embodiments, the application writes and/or broadcasts the controller area network data frame directly to the communication bus. In some embodiments, an operating system of the vehicle system passes the controller area network data frame from the application to the communication bus. In some embodiments, the operation system constructs the controller area network data frame after receiving data and/or one or more instructions from the applications that indicate that the vehicle system should be caused to perform a particular operation.

In some embodiments, performing the read operation on the communication bus of the vehicle system includes obtaining data via the communication bus of the vehicle system from one or more vehicle hardware components (e.g., steering wheel, engine, engine module, braking system, head unit, one or more seats, one or more mirrors, and/or one or more other systems in one or more cars, trucks, and/or sports utility vehicles).

In some embodiments, the application is stored with respect to (e.g., as described above in relation to FIG. 13) a respective container (e.g., the container corresponding to the set of one or more permissions that indicate that one or more applications can read to the communication bus of the vehicle system or the container that does not correspond to the set of one or more permissions that indicate that one or more applications can read to the communication bus of the vehicle system).

In some embodiments, the application is a first application. In some embodiments, while the application is associated with the container corresponding to a set of one or more permissions that indicate that one or more applications can read from the communication bus of the vehicle system, the application is not stored with respect to (e.g., as described above in relation to FIG. 13) a different container. In some embodiments, a second application is stored with respect to the different container. In some embodiments, the different container corresponds to a respective set of one or more permissions that is different from the set of one or more permissions. In some embodiments, a first respective application is not sored in a respective container, and a second respective application, different from the first respective application, the respective container includes a different application.

In some embodiments, method 1700 includes receiving, from the second application, a second request to perform a second read operation on (and/or for and/or from) the communication bus of the vehicle system. In some embodiments, method 1700 includes, in response to receiving the second request to perform the second read operation on the communication bus of the vehicle system, according to a determination that the respective set of one or more permissions indicates that one or more applications can read from the communication bus of the vehicle system (e.g., via an indicator, flag, and/or status indication) (e.g., using similar techniques as described above in relation to FIGS. 14-15), permitting the second application to perform the read operation on the communication bus of the vehicle system (e.g., and, in some embodiments, after, while, and/or before, forgoing permitting the application to perform the read operation on the communication bus of the vehicle system (e.g., according to a determination that the application is associated with the container that does not correspond to the set of permissions that indicate that one or more applications can read from the communication bus of the vehicle system).

In some embodiments, method 1700 includes, in response to receiving the second request to perform the second read operation on the communication bus of the vehicle system, according to a determination that the respective set of one or more permissions does not indicate that one or more applications can read from the communication bus of the vehicle system, forgoing permitting the second application to perform the read operation on the communication bus of the vehicle system (e.g., and, in some embodiments, after, while, and/or before, permitting the application to perform the read operation on the communication bus of the vehicle system (e.g., according to a determination that the application is associated with the container that corresponds to the set of permissions that indicate that one or more applications can read from the communication bus of the vehicle system)).

In some embodiments, method 1700 includes receiving, from the second application, a third request to perform a third read operation on the communication bus of the vehicle system. In some embodiments, method 1700 includes, in response to receiving the third request to perform the third read operation on the communication bus of the vehicle system, according to a determination that the different set of one or more permissions indicates that one or more applications can read a type of data associated with the third read operation on the communication bus of the vehicle system, permitting the second application to perform the read operation on the communication bus of the vehicle system (e.g., and, in some embodiments, after, while, and/or before, forgoing permitting the application to perform the read operation on the communication bus of the vehicle system (e.g., according to a determination that the application is associated with the container that does not correspond to the set of permissions that indicate that one or more applications can read from the communication bus of the vehicle system)) (e.g., via an indicator, flag, and/or status indication) (e.g., using similar techniques as described above in relation to FIGS. 14-15).

In some embodiments, method 1700 includes, in response to receiving the third request to perform the third read operation on the communication bus of the vehicle system, according to a determination that the different set of one or more permissions does not indicate that one or more applications can read the type of data associated with the third read operation on the communication bus of the vehicle system, forgoing permitting the second application to perform the read operation on the communication bus of the vehicle system (e.g., and, in some embodiments, after, while, and/or before, permitting the application to perform the read operation on the communication bus of the vehicle system (e.g., according to a determination that the application is associated with the container that corresponds to the set of permissions that indicate that one or more applications can read from the communication bus of the vehicle system)). In some embodiments, the operating system permits the application to read some types of data and/or some data without permitting the application to read other types of data.

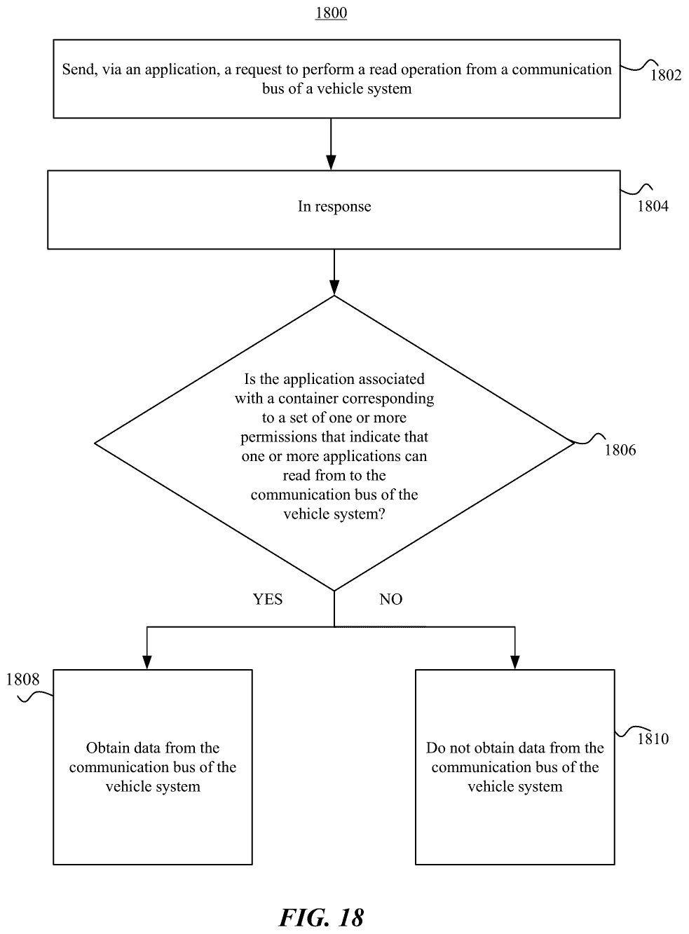

FIG. 18 is a flow diagram illustrating a method (e.g., method 1800) for selectively reading from a communication bus in accordance with some embodiments. In some embodiments, one or more operations described in reference to method 1800 are, optionally, combined, changed, and/or replaced by one or more operations. In some embodiments, the order of one or more operations described in reference to method 1800 are, optionally, changed. In some embodiments, one or more operations described in reference to method 1800 are optionally combined with one or more other methods and/or operations for one or more other methods described herein.

Method 1800 includes sending (1802), via an application (and, in some embodiments, at a vehicle operating system (e.g., as described above in relation to FIG. 13), a request to perform a read operation on a communication bus (e.g., as described above in relation to FIG. 13) of a vehicle system (e.g., as described above in relation to FIG. 13) (e.g., while performing one or more vehicle operations (e.g., causing or not causing one or more components of the vehicle to move in a certain manner (e.g., speed, direction, and/or intensity), turning one or more components (e.g., engine, windshield wipers, and/or lights) on and/or off and/or changing the setting (e.g., air flow setting, brightness setting, sound level setting, and/or navigation setting) of one or more components). In some embodiments, the method is performed by the application. In some embodiments, sending the request to perform the read operation includes the application attempting to read and/or listen to information and/or data from the communication bus.

Method 1800 includes, in response to (1804) sending the request to perform the read operation on the communication bus of the vehicle system, according to (1806) a determination (e.g., by a vehicle operating system and/or by one or more instructions stored on the vehicle system) that the application is associated with (e.g., installed with, points to in memory, and/or references) a container (e.g., as described above in relation to FIG. 13) corresponding to a set of one or more permissions that indicate that one or more applications can read from the communication bus of the vehicle system, obtaining (1808) data from the communication bus of the vehicle system (e.g., by performing a read operation on the communication bus).

Method 1800 includes, in response to (1804) sending the request to perform the read operation on the communication bus of the vehicle system, according to (1806) a determination (e.g., by a vehicle operating system and/or by one or more instructions stored on the vehicle system) that the application is associated with (e.g., installed with, points to in memory, and/or references) a container (e.g., as described above in relation to FIG. 13) that does not correspond to the set of one or more permissions that indicate that one or more applications can read from the communication bus of the vehicle system, forgoing obtaining (1810) data from the communication bus of the vehicle system.

In some embodiments, obtained data from the communication bus of the vehicle system includes (e.g., by the application and/or by the operating system) a controller area network data frame (e.g., a data frame having a set number of fields (e.g., start of frame (SOF), arbitration, control, data, cyclical redundancy check (CRC), acknowledge (ACK), and/or end of frame (EOF)), a set header, and/or a set footer, and/or a data frame designed for use in vehicle systems and/or via a communication bus for a vehicle system) (e.g., transmitted via the communication bus) (e.g., to one or more vehicle hardware components (e.g., speakers, doors, engines, sensors, and/or windshield wipers) of the vehicle system). In some embodiments, the application reads from the controller area network data frame directly to the communication bus. In some embodiments, an operating system of the vehicle system passes the controller area network data frame from the communication bus to the applications. In some embodiments, the operation system constructs the controller area network data frame after receiving data from the communication bus.

In some embodiments, obtained data from the communication bus of the vehicle system is generated at (and/or sent by, calculated by, detected by, and/or acquired by) one or more vehicle hardware components (e.g., steering wheel, engine, engine module, braking system, head unit, one or more seats, one or more mirrors, and/or one or more other systems in one or more cars, trucks, and/or sports utility vehicles) (e.g., generated via one or more sensors of the one or more vehicle hardware components)

In some embodiments, method 1800 includes sending, via the application, a second request to perform a second read operation on the communication bus of the vehicle system. In some embodiments, method 1800 includes, in response to sending the second request to perform the second read operation on the communication bus of the vehicle system, according to a determination that the application is associated with the container corresponding to the set of one or more permissions that indicate that one or more applications cannot read from the communication bus of the vehicle system and the application is associated with a set of one or more application permissions, different from the set of one or more permissions that indicate that one or more applications can read from the communication bus of the vehicle system, that indicate that one or more applications can read from the communication bus of the vehicle system, forgoing obtaining data from the communication bus of the vehicle system (and/or forgoing performing a read operation on the communication bus and/or forgoing attempting to read from the communication bus).

In some embodiments, method 1800 includes sending, via the application, a third request to perform a third read operation on the communication bus of the vehicle system. In some embodiments, method 1800 includes, in response to sending the third request to perform the third read operation on the communication bus of the vehicle system, according to a determination that the application is associated with the container corresponding to the set of one or more permissions that indicate that one or more applications can read from the communication bus of the vehicle system and the application is associated with a set of application permissions, different from the set of one or more permissions that indicate that one or more applications can read from the communication bus of the vehicle system, that indicate that one or more applications cannot read from the communication bus of the vehicle system, obtaining data from the communication bus of the vehicle system (and/or performing a read operation on the communication bus and/or attempting to read from the communication bus).

In some embodiments, method 1800 includes sending, via the application, a fourth request to perform a fourth read operation on the communication bus of the vehicle system. In some embodiments, method 1800 includes, in response to sending the fourth request to perform the fourth read operation on the communication bus of the vehicle system, according to a determination that the application is associated with the container corresponding to the set of one or more permissions that indicate that one or more applications can read from the communication bus of the vehicle system and the application is associated with a set of application permissions, different from the set of one or more permissions that indicate that one or more applications can read from the communication bus of the vehicle system, that indicate that one or more applications cannot read from the communication bus of the vehicle system, forgoing obtaining data from the communication bus of the vehicle system (and/or forgoing performing a read operation on the communication bus and/or forgoing attempting to read from the communication bus).

In some embodiments, method 1800 includes sending, via the application, a fifth request to perform a fifth read operation on the communication bus of the vehicle system. In some embodiments, method 1800 includes, in response to sending the fifth request to perform the fifth read operation on the communication bus of the vehicle system, according to a determination that the application is associated with the container corresponding to the set of one or more permissions that indicate that one or more applications can read from the communication bus of the vehicle system and the fifth read operation corresponds to an operation that is a type of operation that is permitted by the set of one or more permissions, obtaining data from the communication bus of the vehicle system. In some embodiments, method 1800 includes, in response to sending the fifth request to perform the fifth read operation on the communication bus of the vehicle system, according to a determination that the application is associated with the container corresponding to the set of one or more permissions that indicate that one or more applications can read from the communication bus of the vehicle system and the fifth read operation corresponds to an operation that is a type of operation that is not permitted by the set of one or more permissions, forgoing obtaining data from the communication bus of the vehicle system (and/or forgoing performing a read operation on the communication bus and/or forgoing attempting to read from the communication bus).

In some embodiments, obtained data from the communication bus of the vehicle system includes a motion characteristic of the vehicle system (e.g., whether vehicle is on, off, and/or transitioning to standby mode; whether the navigation path of the vehicle has changed; and/or the speed, direction, and/or acceleration of the vehicle changing) (e.g., using one or more similar techniques to those described above in relation to FIG. 15).

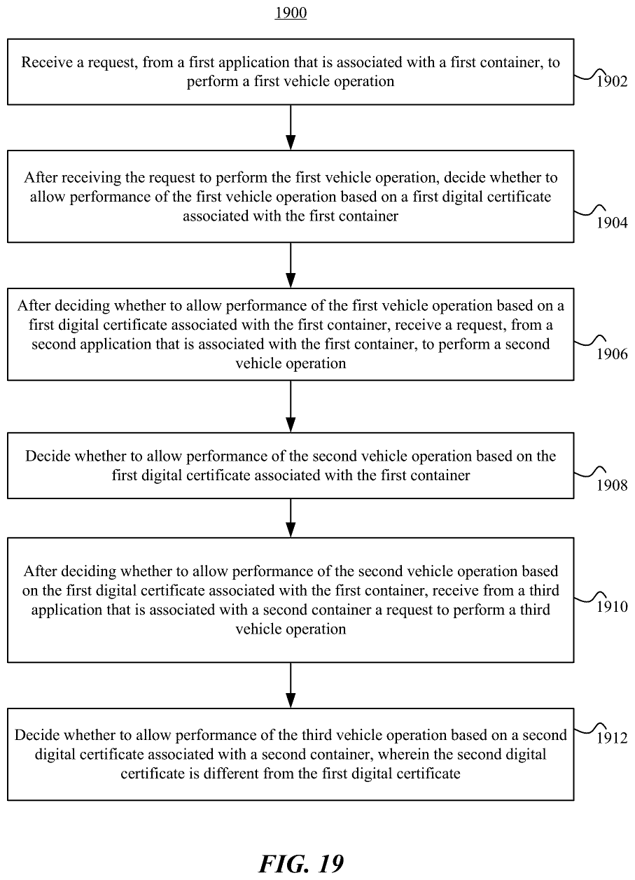

FIG. 19 is a flow diagram illustrating a method (e.g., method 1900) for selectively permitting one or more operations to be performed by an application in accordance with some embodiments. In some embodiments, one or more operations described in reference to method 1900 are, optionally, combined, changed, and/or replaced by one or more operations. In some embodiments, the order of one or more operations described in reference to method 1900 are, optionally, changed. In some embodiments, one or more operations described in reference to method 1900 are optionally combined with one or more other methods and/or operations for one or more other methods described herein.

Method 1900 includes receiving (1902) a request, from a first application that is associated with a first container, to perform a first vehicle operation.

Method 1900 includes, after receiving (1904) the request to perform the first vehicle operation, deciding whether to permit performance of the first vehicle operation (e.g., by the first application and/or by an operation system (e.g., as described in relation to FIG. 13) in communication with the first application) (e.g., as described above in relation to FIGS. 13-18) based on a first digital certificate associated with the first container (and/or permitting or not permitting performance of the first vehicle operation).

Method 1900 includes, after deciding (1906) whether to permit performance of the first vehicle operation based on a first digital certificate associated with the first container (and/or after permitting or not permitting performance of the first vehicle operation), receiving a request, from a second application that is associated with the first container, to perform a second vehicle operation.

Method 1900 includes deciding (1908) whether to permit performance of the second vehicle operation (e.g., by the first application and/or by an operation system (e.g., as described in relation to FIG. 13) in communication with the first application) based on the first digital certificate associated with the first container (and/or permitting or not permitting performance of the second vehicle operation).

Method 1900 includes, after deciding (1910) whether to permit performance of the second vehicle operation based on the first digital certificate associated with the first container (and/or after permitting or not permitting performance of the second vehicle operation), receiving, from a third application that is associated with a second container and that is not associated with the first container, a request to perform a third vehicle operation.

Method 1900 includes deciding (1912) whether to permit performance of the third vehicle operation based on a second digital certificate associated with a second container (e.g., different from the first container) and not the first container (and/or permitting or not permitting performance of the third vehicle operation). In some embodiments, the second digital certificate is different from the first digital certificate.

In some embodiments, the first application being associated with the first container includes the first application being stored with respect to (e.g., as described above in relation to FIG. 13) the first container and not the second container. In some embodiments, the second application being associated with the first container includes the second application being stored with respect to the first container and not the second container. In some embodiments, the third application being associated with the second container includes the third application being stored with respect to the second container and not the first container.

In some embodiments, deciding whether to permit performance of the first vehicle operation based on the first digital certificate associated with the first container includes: according to a determination that the first application is associated with a first application digital certificate that is different from the first application certificate associated with the first container, the first application digital certificate indicates that the first vehicle operation is permitted to be performed, and the first digital certificate indicates that the first vehicle operation is permitted to be performed, permitting (and/or permitting) the first application to perform the first vehicle operation; and according to a determination that the first application is associated with the first application digital certificate that is different from the first application certificate associated with the first container, the first application digital certificate indicates that the first vehicle operation is not permitted to be performed, and the first digital certificate indicates that the first vehicle operation is permitted to be performed, forgoing permitting (and/or permitting) the first application to perform the first vehicle operation. In some embodiments, deciding whether to permit performance of the second vehicle operation based on the first digital certificate associated with the first container includes: according to a determination that the second application is associated with a second application digital certificate that is different from the first application certificate associated with the first container and the first application digital certificate, the second application digital certificate indicates that the first vehicle operation is permitted to be performed (e.g., irrespective of whether the first application digital certificate indicates that the first vehicle operation is permitted to be performed), and the first digital certificate indicates that the first vehicle operation is permitted to be performed, permitting (and/or permitting) the second application to perform the second vehicle operation; and according to a determination that the second application is associated with the second application digital certificate that is different from the first application certificate associated with the first container and the first application digital certificate, the second application digital certificate indicates that the first vehicle operation is permitted to be performed (e.g., irrespective of whether the first application digital certificate indicates that the first vehicle operation is permitted to be performed), permitting (and/or permitting) the first application to perform the first vehicle operations; forgoing permitting (and/or permitting) the second application to perform the second vehicle operation. In some embodiments, an operation is performed for first application and another operation is not performed for the second application (or vice-versa) because the first application is stored with respect to a different application digital certificate that indicates that different operations can be performed than the application digital certificate stored with respect to the second application.

In some embodiments, the first vehicle operation and the second vehicle operation are performed (e.g., and/or permitted to be performed) (e.g., according to a determination that the first digital certificate includes a set of one or more permissions corresponding to an allowance of a vehicle operation that is the same type of vehicle operation as the first vehicle operation and the second vehicle operation, the first vehicle operation and the second vehicle operation are performed). In some embodiments, the third vehicle operation is not performed (e.g., and/or allowed to not be performed) (e.g., according to a determination that the second digital certificate does not include a set of one or more permissions corresponding to an allowance of the third vehicle operation) the third vehicle operation is not performed). In some embodiments, an operation is performed for first application, an operation performed for the second application, and another operation is performed for the third application because the first application and second application is stored with respect to a different container digital certificate that indicates that different operations can be performed than the container digital certificate stored with respect to the third application.

In some embodiments, the first vehicle operation and the second vehicle operation are not performed (e.g., and/or not allowed to be performed) (e.g., according to a determination that the first digital certificate does not include a set of one or more permissions corresponding to an allowance of a vehicle operation that is the same type of vehicle operation as the first vehicle operation and the second vehicle operation, the first vehicle operation and the second vehicle operation are not performed). In some embodiments, the third vehicle operation is performed (e.g., and/or allowed to not be performed) (e.g., according to a determination that the second digital certificate includes a set of one or more permissions corresponding to an allowance of the third vehicle operation) the third vehicle operation is performed).

In some embodiments, method 1900 includes receiving a request to update the first digital certificate. In some embodiments, method 1900 includes, in response to receiving the request to update the first digital certificate, updating the first digital certificate without updating the second digital certificate. In some embodiments, a digital certificate (e.g., a container digital certificate) that impacts a set of applications and/or that corresponds to set of application (and/or a container storing the set of applications) is updated without updating a digital certificate that impacts another set of applications (e.g., third-party applications and/or applications that were not originally installed (e.g., out of the box)).

In some embodiments, deciding whether to permit performance of the first operation based on the first digital certificate associated with the first container includes permitting performance of the first vehicle operation. In some embodiments, after updating the first digital certificate without updating the second digital certificate and permitting performance of the first vehicle operation, method 1900 includes receiving, from the first application, a request to perform a vehicle operation that is the same as the first vehicle operation. In some embodiments, method 1900 includes, in response to receiving the request to perform the vehicle operation that is the same as the first vehicle operation, forgoing permitting perform of the vehicle operation that is the same as the first vehicle operation based on the first digital certificate (e.g., the updated digital certificate). In some embodiments, the vehicle system changes whether an application is permitted to be performed and/or not performed (e.g., switch from perform to not perform) after a digital certificate for a particular application is updated.

In some embodiments, permitting a respective vehicle operation (e.g., first vehicle operation, second vehicle operation, and/or third vehicle operation) to be performed includes permitting a respective application to access a communication bus of a vehicle system (e.g., as described above in relation to FIGS. 13-18). In some embodiments, the respective application s request to perform the respective vehicle operation.

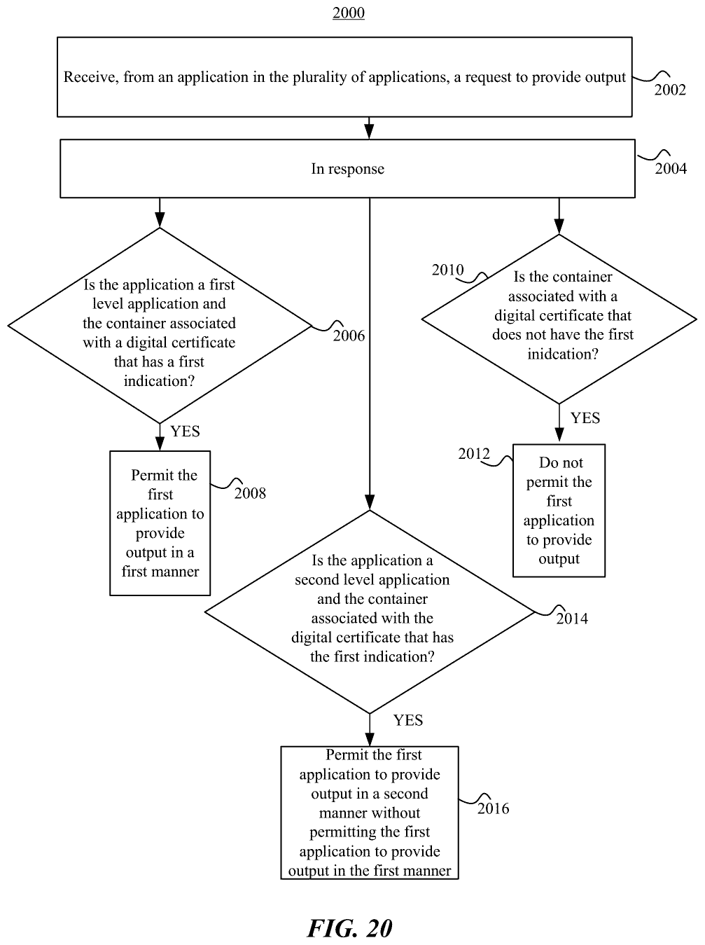

FIG. 20 is a flow diagram illustrating a method (e.g., method 2000) for controlling output of one or more applications for vehicles systems in accordance with some embodiments. In some embodiments, one or more operations described in reference to method 2000 are, optionally, combined, changed, and/or replaced by one or more operations. In some embodiments, the order of one or more operations described in reference to method 2000 are, optionally, changed. In some embodiments, one or more operations described in reference to method 2000 are optionally combined with one or more other methods and/or operations for one or more other methods described herein.

In some embodiments, method 2000 is performed at a vehicle system including a container (e.g., as described above in relation to FIG. 13) corresponding to a plurality of applications: In some embodiments, the compute system includes an operating system (e.g., as described above in relation to FIG. 13).

Method 2000 includes receiving (2002), from an application in the plurality of applications, a request to provide output.

Method 2000 includes, in response to (2004) receiving the request to provide output and according to (2006) a determination that the application is a first level application and the container is associated with a digital certificate that has a first indication (e.g., a status, a flag, and/or a text and/or a symbol that indicates that output is allowed or not allowed to be provided in one or more manners for a particular application), permitting (2008) (e.g., via an operating system (e.g., as described above in relation to FIG. 13)) the first application to provide output in a first manner (e.g., a combination of one or more of audio, visual, and/or haptic output) (e.g., providing output and/or allowing output to be provided with a certain level, a minimum level, and/or maximum level, such as a volume level, brightness level, notification level (e.g., how a notification is output, such as notifications can be displayed only while driving, only while the vehicle system is not moving, and/or only while the vehicle system is operating in a certain mode (e.g., standby mode and/or ride sharing mode)) (e.g., permitting the first application to provide visual output via a head unit display, a windshield and/or mirror display, and/or another display, permitting the first application to provide output via one or more speakers, and/or permitting the first application to provide haptic output via a steering wheel and/or a seat) (e.g., cause output to be generated and/or output).

Method 2000 includes, in response to (2004) receiving the request to provide output and according to (2014) a determination that the application is a second level application and the container is associated with the digital certificate that has the first indication, permitting (2018) (e.g., via an operating system (e.g., as described above in relation to FIG. 13)) the first application to provide output in a second manner (e.g., a different combination of one or more of audio, visual, and/or haptic output) without permitting the first application to provide output in the first manner.

Method 2000 includes, in response to (2004) receiving the request to provide output and according to (2010) a determination that the container is associated with a digital certificate that does not have the first indication, forgoing permitting (2012) (e.g., via an operating system (e.g., as described above in relation to FIG. 13)) the first application to provide output (e.g., forgoing permitting the first application to provide any output and/or forgoing permitting the first application to provide output in the first manner and the second manner).

In some embodiments, the vehicle system includes a display device (e.g., a display screen, a projector, a head-unit of a car entertainment system, and/or a touch-sensitive display). In some embodiments, providing output in the first manner includes displaying, via the display device, information (e.g., visual content, text, symbols, and/or user interface elements). In some embodiments, according to a determination that the application is the first level application, and the container is associated with a digital certificate that has the first indication, the display device is caused to output new information and/or some information. In some embodiments, providing output in the second manner does not include displaying, via the display device, information. In some embodiments, according to a determination that the application is the second level application and the container is associated with a digital certificate that has the second indication, the display device is not caused to output different information and/or some information and/or the display device is turned off and/or in standby mode.

In some embodiments, providing output in the first manner (and/or the second manner) includes causing output to change in response to detecting one or more inputs detected via a second modality without causing output to change in response to detecting one or more inputs detected via a first modality (e.g., detected via a touch sensor, a voice sensor, a sound sensor, and/or a camera sensor). In some embodiments, providing output in different manners includes not providing output in response detecting some inputs.

In some embodiments, the container is a first container. In some embodiments, method 2000 includes, after (and, in some embodiments, before and/or while) permitting (e.g., via an operating system (e.g., as described above in relation to FIG. 13)) the first application to provide output in a first manner, receiving, from a second application in the plurality of applications, a second request to provide output. In some embodiments, in response to receiving the second request to provide output, method 2000 includes according to a determination that the second application (and, in some embodiments, the second application is different from the application) is associated with a second container, different from the first container, and the second container is associated with a different digital certificate (e.g., that has the first indication and/or that does not have the first indication), permitting the second application to provide output in a manner different from the first manner. In some embodiments, in response to receiving the second request to provide output, method 2000 includes according to a determination that the second application is associated with the first container and the first continent is associated with the digital certificate that has the first indication, permitting the second application to provide output in the first manner.

In some embodiments, while permitting the first application to provide output in the first manner, method 2000 includes detecting that the vehicle system is changing from operating in a first context to operating in a second context different from the first context (e.g., based on the operational state of the vehicle (e.g., whether the vehicle is on, off, and/or in standby mode, the speed at which the vehicle is operating, the acceleration at which the vehicle is operating, and/or the mode at which the vehicle is operating)). In some embodiments, in response to detecting that the vehicle system is changing from operating in the first context to operating in the second context, method 2000 includes continuing to permit the first application to provide output in the first manner.

In some embodiments, while permitting the first application to provide output in the first manner, method 2000 includes detecting that the vehicle system is changing from operating in a third context to operating in a fourth context different from the third context (e.g., based on the operational state of the vehicle (e.g., whether the vehicle is on, off, and/or in standby mode, the speed at which the vehicle is operating, the acceleration at which the vehicle is operating, and/or the mode at which the vehicle is operating)). In some embodiments, in response to detecting that the vehicle system is changing from operating in the third context to operating in the fourth context, method 2000 includes ceasing to permit the first application to provide output in the first manner.

In some embodiments, permitting the first application to provide output includes permitting the first application to access a communication bus (e.g., as described above in relation to FIG. 13).

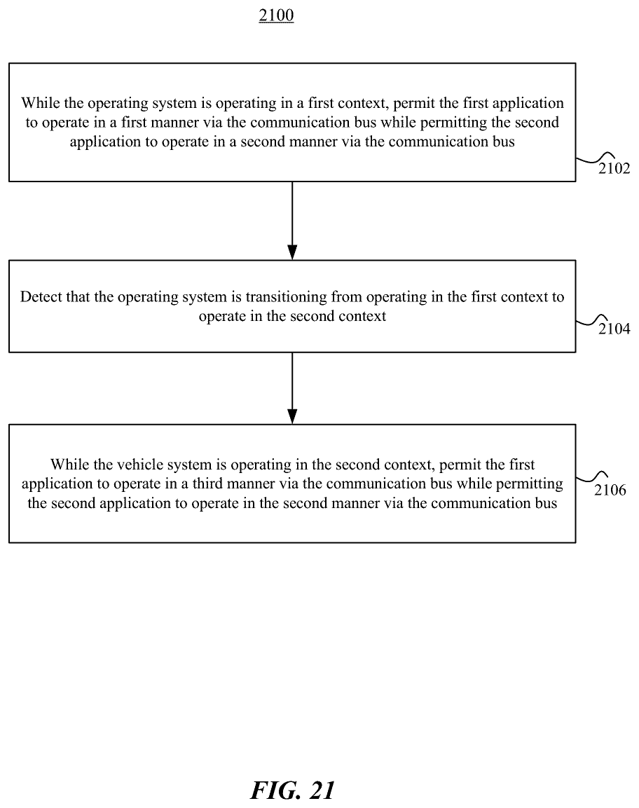

FIG. 21 is a flow diagram illustrating a method (e.g., method 2100) for controlling operation of one or more applications for vehicles systems in accordance with some embodiments. In some embodiments, one or more operations described in reference to method 2100 are, optionally, combined, changed, and/or replaced by one or more operations. In some embodiments, the order of one or more operations described in reference to method 2100 are, optionally, changed. In some embodiments, one or more operations described in reference to method 2100 are optionally combined with one or more other methods and/or operations for one or more other methods described herein.

In some embodiments, the method is performed at a vehicle system including an operating system (e.g., as described above in relation to FIG. 13), a container (e.g., as described above in relation to FIG. 13) corresponding to a first application and a second application different from the first application, and a communication bus (e.g., as described above in relation to FIG. 13)

Method 2100 includes, while the vehicle system is operating (2102) in a first context (e.g., only a level three application is allowed, only level one and two applications are allowed, only level two applications are allowed, all level applications are allowed expect from level two applications, etc.), permitting the first application to operate in a first manner (e.g., output via one or more output modalities, such as visual, audio, and/or haptic) (e.g., read the communication bus, write to the communication bus, and/or write certain operations and/or data to the communication bus without writing other operations and/or data to the communication bus) via (e.g., using and/or by way of) the communication bus while permitting the second application to operate in a second manner via the communication bus; In some embodiments, the first manner is the same as the second manner. In some embodiments, the first manner is different from the second manner.

Method 2100 includes detecting (2104) that the vehicle system is transitioning from operating in the first context to operating in the second context.

Method 2100 includes, while the vehicle system (2106) is operating in the second context, permitting the first application to operate in a third manner, different from the first manner, via (e.g., using and/or by way of) the communication bus (e.g., without permitting the first application to operate in the first manner) while permitting the second application to operate in the second manner via the communication bus.

In some embodiments, the first application is permitted to operate in a first respective manner based on (e.g., using one or more similar techniques to those described above in relation to FIG. 20) a first digital certificate. In some embodiments, the second application is permitted to operate in a second respective manner based on a second digital certificate. In some embodiments, the second digital certificate is the same as or different from the first digital certificate. In some embodiments, the first application is not permitted to operate in the first respective manner based on the second digital certificate. In some embodiments, the second application is not permitted to operate in the second respective manner based on the first digital certificate.

In some embodiments, the first application and the second application are operating according to a same application level while the vehicle system is operating in the first context. In some embodiments, the first application and the second application are operating according to different application levels while the vehicle system is operating in the second context.

In some embodiments, method 2100 includes, while the vehicle system is operating in the first context, permitting a third application, different from the first application and the second application, to operate in a fourth manner, different from the first manner and the second manner, via the communication bus. In some embodiments, method 2100 includes, while the vehicle system is operating in the second context, permitting the third application to operate in the second manner via the communication bus (and, in some embodiments, ceasing permitting and/or not permitting the fourth application to operate in the fourth manner). In some embodiments, the third application is stored with respect to the same container or different container than the second application.

In some embodiments, method 2100 includes, while the vehicle system is operating in the first context, permitting a fourth application, different from the first application and the second application, to operate in a fifth manner, different from the first manner and the second manner, via the communication bus. In some embodiments, method 2100 includes, while the vehicle system is operating in the second context, permitting the fourth application to operate in a sixth manner, different from the third manner and the second manner, via the communication bus (and ceasing permitting the fourth application to operate in the fifth manner). In some embodiments, the fourth application is stored with respect to the same container or different container than the second application and/or the first application.

In some embodiments, method 2100 includes, while the vehicle system is operating in the first context, permitting a fifth application, different from the first application and the second application, to operate in a seventh manner, different from the first manner and the second manner, via the communication bus. In some embodiments, method 2100 includes, while the vehicle system is operating in the second context, continuing permitting the fourth application to operate in the seventh manner. In some embodiments, operation of (e.g., including output of) the fourth application does not change based on the change in context.

In some embodiments, method 2100 includes detecting that the operating system is transitioning from operating in the second context to operating in a third context. In some embodiments, method 2100 includes, in response to detecting that the operating system is transitioning from operating in the second context to operate in the third context, permitting the first application to operate in the first manner (and/or ceasing to permitting the first application to operate in a previous manner, such as the third manner).

In some embodiments, method 2100 includes, in response to detecting that the operating system is transitioning from operating in the second context to operate in the third context, continuing permitting the second application to operate in the second manner via the communication bus.

In some embodiments, method 2100 includes, in response to detecting that the operating system is transitioning from operating in the second context to operate in the third context, permitting the second application to operate in an eighth manner, different from the second manner (and, in some embodiments, the first manner and/or the third manner) via the communication bus.

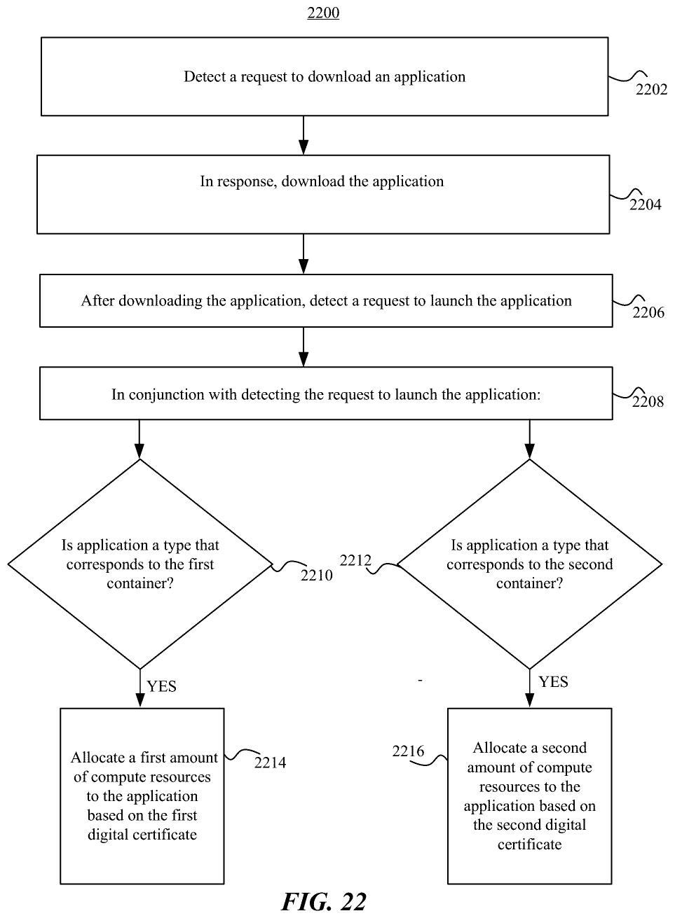

FIG. 22 is a flow diagram illustrating a method (e.g., method 2200) for allocating compute resources for an application executing in vehicle systems in accordance with some embodiments. in accordance with some embodiments. In some embodiments, one or more operations described in reference to method 2200 are, optionally, combined, changed, and/or replaced by one or more operations. In some embodiments, the order of one or more operations described in reference to method 2200 are, optionally, changed. In some embodiments, one or more operations described in reference to method 2200 are optionally combined with one or more other methods and/or operations for one or more other methods described herein.

Method 2200 is performed at a vehicle system including an operating system (e.g., as described above in relation to FIGS. 13-21), a first container (e.g., as described above in relation to FIGS. 13-21), a second container, a first digital certificate (e.g., as described above in relation to FIGS. 13-21) corresponding to the first container, and a second digital certificate (e.g., as described above in relation to FIGS. 13-21) corresponding to the second container.

Method 2200 includes detecting (2202) a request to download an application, wherein the first container is different from the second container. In some embodiments, the second digital certificate is different from the first digital certification; In some embodiments, detecting a request to download the application is detecting that installation of the application is being push to the vehicle system, detecting an input directed to the vehicle system, detecting an input that is not directed to the vehicle system, and/or automatically detecting the request without detecting an input.

Method 2200 includes, in response to (2204) detecting the request to download the application, downloading the application.

Method 2200 includes, after downloading (2206) the application, detecting a request (e.g., and/or an input directed to an application icon and/or an input directed to launching an application) to launch the application. In some embodiments, the request to launch the application is different from the request to download the application. In some embodiments, the request to launch the application is separate from the request to download the application. In some embodiments, the request to launch the application is the same as and/or a part of the request to download the application.

Method 2200 includes, in conjunction with (after, while, and/or before) detecting (2208) the request to launch the application, according to (2210) a determination that the application is an application type that corresponds to the first container, allocating (2214) first compute resources to (e.g., memory (e.g., random access memory and/or storage memory (e.g., solid state storage memory and/or non-solid state storage memory)), processing speed, and/or minimum and/or maximum CPU usage) (the operation of) the application based on the first digital certificate (and not based on the second digital certificate).

Method 2200 includes, in conjunction with (after, while, and/or before) detecting (2208) the request to launch the application, according to (2212) a determination that the application is an application type that corresponds to the second container, allocating (2216) a second amount, different from the first amount, of compute resources to (the operation of) the application based on the second digital certificate (and not based on the first digital certificate).

In some embodiments, compute resources include one or more selected from a group comprising memory, storage, processing speed, processing time, and priority. In some embodiments, the application type is an application category (e.g., an insurance application, a productivity application, a payment processing application, and/or a mission critical application).

In some embodiments, according to a determination that the application is stored with respect to (e.g., as described above in relation to FIGS. 13-21) the first container, the application is the application type that corresponds to the first container. In some embodiments, according to a determination that the application is stored with respect to the second container, the application is the application type that corresponds to the second container.

In some embodiments, according to a determination that the application is the application type that corresponds to the first container and the application is executing with respect to (e.g., as described above in relation to FIG. 13) a first application level, the first compute resources is a third amount. In some embodiments, according to a determination that the application is the application type that corresponds to the first container and the application is executing with respect to a second application level, different from the first application level, the first compute resources is a fourth amount different from the third amount.

In some embodiments, method 2200 includes receiving an instruction (e.g., a set of one or more commands, one or more operations, and/or a request to perform one or more operations) from the application. In some embodiments, method 2200 includes, in response to receiving the instruction from the application, performing one or more operations based on current compute resources allocated for the application (e.g., first amount, type, and/or kind of compute resources, second amount, type, and/or kind of compute resources, and/or another amount, type, and/or kind of compute resources).

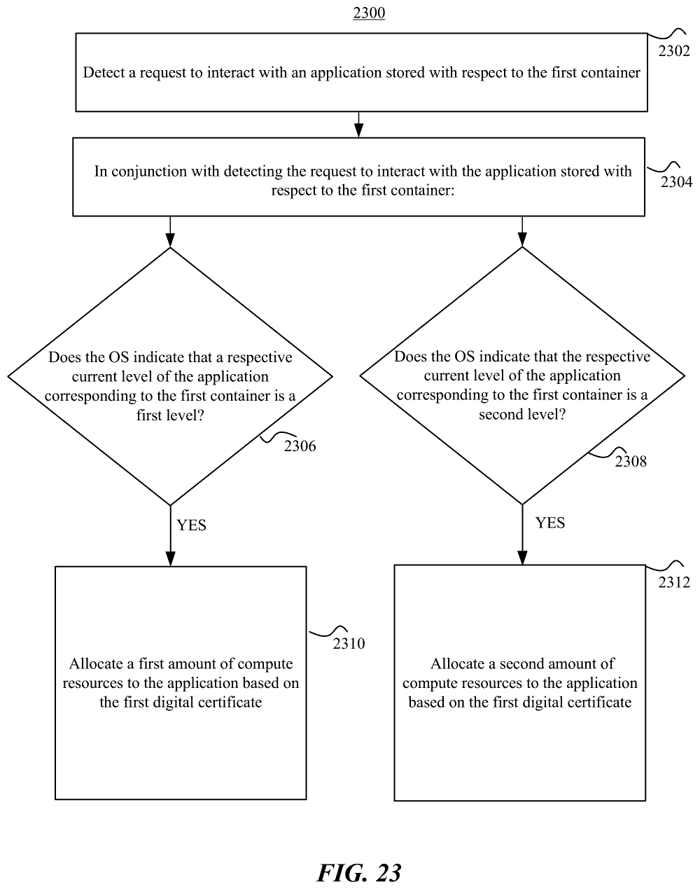

FIG. 23 is a flow diagram illustrating a method (e.g., method 2300) for allocating compute resources for an application executing in vehicle systems in accordance with some embodiments. In some embodiments, one or more operations described in reference to method 2300 are, optionally, combined, changed, and/or replaced by one or more operations. In some embodiments, the order of one or more operations described in reference to method 2300 are, optionally, changed. In some embodiments, one or more operations described in reference to method 2300 are optionally combined with one or more other methods and/or operations for one or more other methods described herein.

In some embodiments, method 2300 is performed at a vehicle system including an operating system (e.g., as described above in relation to FIG. 13), a first container (e.g., as described above in relation to FIG. 13), and a first digital certificate corresponding to the first container.

Method 2300 includes detecting (2302) a request to interact with an application (e.g., as described above in relation to FIGS. 13-22) stored with respect to (e.g., as described above in relation to FIG. 13) the first container. In some embodiments, detecting a request to interact with an application stored with respect to the first container includes detecting a request (e.g., and/or an input directed to an application icon and/or an input directed to launching an application) to launch the application.

Method 2300 includes, in conjunction with (e.g., after, before, while, and/or in response to) detecting (2304) the request to interact with the application stored with respect to (e.g., in, pointing to, and/or referencing) the first container, according to (2306) a determination that the operating system has indicated that a respective current level of the application corresponding to the first container is a first level (e.g., an execution level, an application level, a level of priority, importance, and/or security), allocating (2310) first compute resources (e.g., as described above in relation to FIG. 22) (e.g., a first amount of compute resource, a first type of compute resources, and/or a first kind of compute resources) to (the operation of) the application based on the first digital certificate.

Method 2300 includes, in conjunction with (e.g., after, before, while, and/or in response to) detecting (2304) the request to interact with the application stored with respect to (e.g., in, pointing to, and/or referencing) the first container, according to (2308) a determination that the operating system has indicated that the respective current level of the application corresponding to the first container is a second level (e.g., an execution level, an application level, a level of priority, importance, and/or security), different from the first level, allocating (2312) second compute resources (e.g., a second amount of compute resource, a second type of compute resources, and/or a second kind of compute resources), different from the first compute resources, to (the operation of) the application based on the first digital certificate.

In some embodiments, compute resources include one or more selected from a group comprising memory, storage, processing speed, processing time, and priority. In some embodiments, the application is stored in the first container. In some embodiments, the application is stored outside of the first container and references and/or identifies the first container. In some embodiments, the first container identifies and/or references the application.

In some embodiments, according to a determination that operating system has indicated that the respective current level of the application corresponding to the first container is the first level, the first compute resources is a third amount. In some embodiments, according to a determination that operating system has indicated that the respective current level of the application corresponding to the first container is the second level, the first compute resources is a fourth amount different from the third amount. In some embodiments, the operating system and/or the vehicle system allocates resources to executing and/or performance of a respective application based on an application digital certificate corresponding to the respective application.

In some embodiments, after detecting the request to interact with the application stored with respect to (e.g., as described above in relation to FIG. 13) the first container, method 2300 includes receiving an instruction (e.g., as described above in relation to FIG. 22) from the application. In some embodiments, in response to receiving the instruction from the application and while the first compute resources are allocated to the application based on the first digital certificate, method 2300 includes processing a response to the instruction in a first manner (e.g., as described above in relation to FIG. 22). In some embodiments, in response to receiving the instruction from the application and while the second compute resources is allocated to the application based on the first digital certificate, method 2300 includes processing a response to the instruction in a second manner (e.g., as described above in relation to FIG. 22) different from the first manner (e.g., without processing the response to the instruction in the first manner). In some embodiments, processing a response to the instruction in the first manner includes using a first amount of memory and/or other compute resources and processing a response to the instruction in the second manner includes using an amount of memory and/or compute resources different from the first amount of memory and/or compute resources.

In some embodiments, method 2300 includes, while the first compute resources is allocated to the application based on the first digital certificate, detecting a change in an operational state (e.g., change in a movement characteristic (e.g., acceleration, speed, direction, and/or velocity) of the vehicle, change as to whether the vehicle is off, on, and/or idle, and/or change in a repair status, such as an engine malfunction and/or a malfunction and/or maintenance to one or more other components of the vehicle system) of the vehicle system. In some embodiments, method 2300 includes, in response to detecting the change in the operational state of the vehicle system (and, in some embodiments, according to a determination that the operating system has indicated that the respective current level of the application corresponding to the first container has changed), allocating third compute resources (e.g., different from (e.g., different in kind, amount, and/or type) the first compute resources and/or the second compute resources) to the application based on the first digital certificate. In some embodiments, in response to detecting the change in the operational state of the vehicle system and according to a determination that the operating system has indicated that the respective current level of the application corresponding to the first container has not changed, the allocation of the first compute resources to the application does not change (and/or the third compute resources is not allocated to the application based on the first digital certificate).

In some embodiments, the application is a first application. In some embodiments, method 2300 includes, in response to detecting the change in the operational state of the vehicle system, forgoing changing an allocation of compute resources for a second application different from the first application.

In some embodiments, method 2300 includes, in response to detecting the change in the operational state of the vehicle system, allocating a fourth amount, different from the first compute resources, of compute resources to a third application different from the first application.

In some embodiments, method 2300 includes, in response to detecting the change in the operational state of the vehicle system, allocating the third compute resources to a fourth application different from the first application.

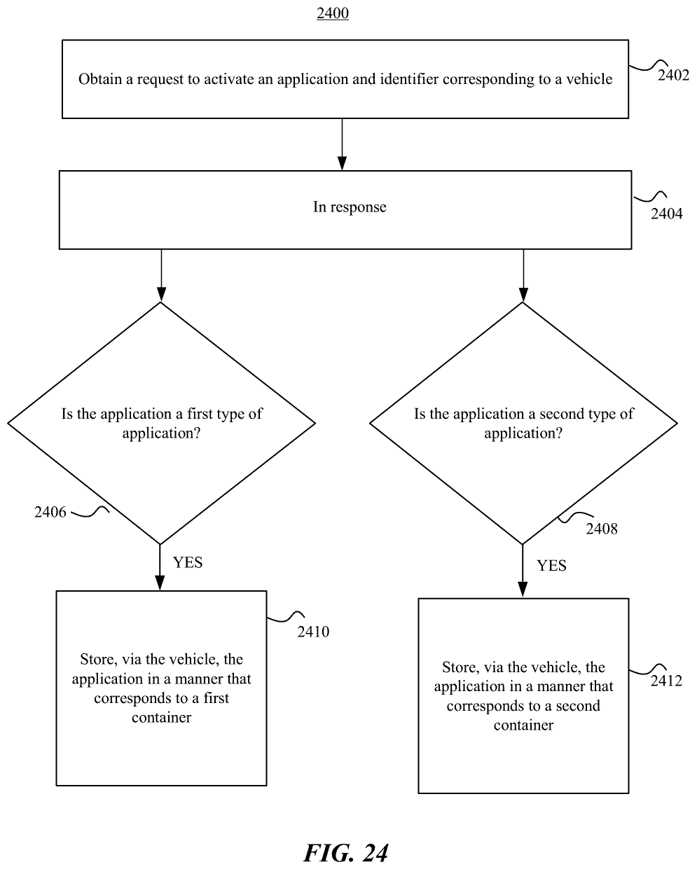

FIG. 24 is a flow diagram illustrating a method (e.g., method 2400) for storing an application for vehicle systems in accordance with some embodiments. In some embodiments, one or more operations described in reference to method 2400 are, optionally, combined, changed, and/or replaced by one or more operations. In some embodiments, the order of one or more operations described in reference to method 2400 are, optionally, changed. In some embodiments, one or more operations described in reference to method 2400 are optionally combined with one or more other methods and/or operations for one or more other methods described herein.

Method 2400 includes obtaining (2402) (e.g., acquiring, receiving, and/or detecting) an identifier corresponding to a vehicle system (e.g., by a cloud server, via a cloud server, via a cloud service that corresponds to the application) (e.g., irrespective of the mode in which the vehicle system is operating (e.g., irrespective of whether the vehicle system was turned on and/or off when the request to activate the application was sent and/or initially requested and/or established)) (e.g., as described above in relation to FIG. 13) and a request to activate (e.g., download, bring out of hibernation, and/or re-install) an application.

Method 2400, in response to (2404) obtaining the identifier corresponding to the vehicle system and the request to activate the application, according to (2406) a determination that the application is a first type of application, storing (2410), via the vehicle system, the application in a manner that corresponds to a first container (e.g., storing in a manner that references, inside of a memory location of the first container and/or referencing the first container, and/or pointing to the first container), wherein the first container corresponds to a first set of one or more permissions (e.g., defined in a digital certificate and/or programmatically defined) (e.g., as described above in relation to FIGS. 13-22).

Method 2400 includes, in response to (2404) obtaining the identifier corresponding to the vehicle system and the request to activate the application, according to (2408) a determination that the application is a second type of application, different from the first type of application, storing (2412), via the vehicle system, the application in a manner that corresponds to a second container, different from the first container. In some embodiments, the second container corresponds to a second set of one or more permissions (e.g., defined in a different digital certificate and/or programmatically defined) different from the first set of one or more permissions. In some embodiments, storing the application in the manner that corresponds to the first container does not include storing the application in the manner that corresponds to the second container, and vice-versa. In some embodiments, the identifier corresponding to the vehicle system is a vehicle identifier number (VIN).

In some embodiments, the vehicle system includes a communication bus. In some embodiments, method 2400 includes, while the application in the manner that corresponds to the first container, receiving, from the application, a request to perform an operation (e.g., as described above in relation to FIG. 13) via the communication bus. In some embodiments, method 2400 includes, in response to receiving the request to perform the operation via the communication bus and according to a determination that the first set of one or more permissions (e.g., irrespective of the second set of one or more permissions) is in a first state (e.g., a certain configuration, a certain arrangement, and/or indicates that a certain permissions are permitted and/or not permitted) with respect to (e.g., as described above in relation to FIG. 13) performance of the operation, permitting transmission of data between the application and the communication bus (e.g., permitting the application to write to the communication bus (e.g., as described above in relation to FIG. 13) and/or permitting the application to read from the communication bus). In some embodiments, method 2400 includes, in response to receiving the request to perform the operation via the communication bus and according to a determination that the first set of one or more permissions (e.g., irrespective of the second set of one or more permissions) is in a second state, different from the first state, with respect to performance of the operation, forgoing permitting transmission of data between the application and the communication bus.

In some embodiments, the operation is a write operation. In some embodiments, the first set of one or more permissions is in the first state when a determination is made that the write operation is a first type of write operation. In some embodiments, the second set of one or more permissions is in the second state, different from the first state, when a determination is made that the write operation is a second type of write operation different from the first type of write operation.

In some embodiments, performance of the write operation causes the vehicle system to perform a vehicle operation (e.g., moving the vehicle, turning on, turning off, changing direction, speeding up, slowing down, accelerating, deaccelerating, and/or changing an intended destination) (e.g., as described above in relation to FIGS. 13-23).

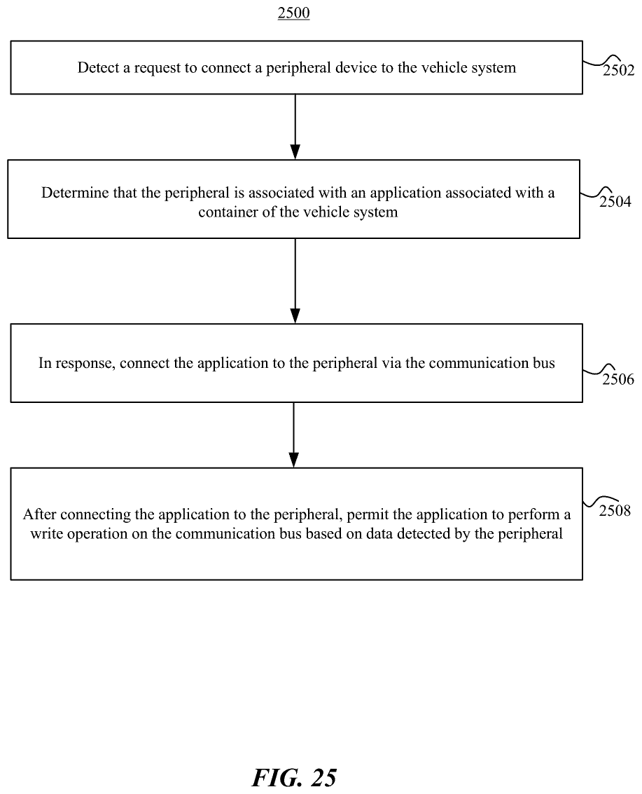

FIG. 25 is a flow diagram illustrating a method (e.g., method 2500) for connecting an application for a vehicle system after connecting a peripheral device to a vehicle system in accordance with some embodiments. In some embodiments, one or more operations described in reference to method 2500 are, optionally, combined, changed, and/or replaced by one or more operations. In some embodiments, the order of one or more operations described in reference to method 2500 are, optionally, changed. In some embodiments, one or more operations described in reference to method 2500 are optionally combined with one or more other methods and/or operations for one or more other methods described herein.

Method 2500 is performed at a vehicle system that includes a plurality of vehicle hardware components (e.g., steering wheel, engine, engine module, braking system, head unit, one or more seats, one or more mirrors, and/or one or more other systems in one or more cars, trucks, and/or sports utility vehicles) that communicates (e.g., sends and/or receives one or more messages, such as data frames and/or CAN data frames) via a communication bus (e.g., as described above in relation to FIG. 13) that is connected to (e.g., physically connected, coupled to, electronically, wirelessly coupled to, and/or plugged in).

Method 2500 includes detecting (2502) a request to connect a peripheral (e.g., a device that is not currently associated with the vehicle system, and/or a device that is not manufactured by the manufacturer of the vehicle system) (e.g., an accessory device, a fingerprint reader, an eye scanner, and/or a breathalyzer) to the vehicle system.

Method 2500 includes determining (2504) that the peripheral is associated with an application associated with a container stored in memory of the vehicle system.

Method 2500 includes, in response to determining that the peripheral is associated with an application associated with a container stored in memory of the vehicle system, connecting (2506) (e.g., directly and/or indirectly) the application to the peripheral via the communication bus (e.g., via an exclusive connection and/or direct connection).

Method 2500 includes, after connecting the application to the peripheral via the communication bus, permitting (2508) the application to perform a write operation (e.g., as described above in relation to CS3-CS4) on the communication bus based on data detected by the peripheral. In some embodiments, permitting the application to perform the write operation on the communication bus based on data detected by the peripheral includes causing the vehicle system to perform a movement operation and/or another operation when the write operation is performed.

In some embodiments, data detected by the peripheral includes authentication information (e.g., biometric authentication (e.g., face, finger printer, and/or eye), passcode authentication, password authentication, and/or two-factor authentication) (e.g., a phone and/or another personal computing device (e.g., smart watch, tablet, and/or smart ring) connected via Bluetooth (e.g., that causes one or more operations, such as regular or remote start), a fingerprint scanner, and/or a USB key). In some embodiments, performance of the write operation causes the vehicle system to start (e.g., cause an engine, lights, a processor, and/or one or more other hardware components to turn on).

In some embodiments, the plurality of vehicle hardware components includes a first vehicle hardware component. In some embodiments, the first vehicle hardware component is not permitted (e.g., is not allowed and/or cannot) obtain data (e.g., and/or read and/or write data) detected by the new peripheral.

In some embodiments, the plurality of vehicle hardware components includes a second vehicle hardware component, and wherein the second vehicle hardware component is permitted to (e.g., is allowed and/or can) obtain data detected by the new peripheral.

In some embodiments, performance of the write operation causes movement (and/or operational state (e.g., as described above in relation to FIGS. 13-24)) of the vehicle system to change based on detection of data via (e.g., detected by, detected on, detected at, and/or detected based on other data) the peripheral.

In some embodiments, method 2500 includes detecting a request to connect to a peripheral (e.g., different from the peripheral) that is not associated with the application associated with the container stored in memory of the vehicle system. In some embodiments, method 2500 includes, in response to detecting the request to connect to a peripheral that is not associated with the application associated with the container stored in memory of the vehicle system, forgoing permitting the application to perform the write operation on the communication bus based on data detected by the peripheral. In some embodiments, the application is not able to obtain and/or read data detected by the peripheral in response to detecting the request to connect to a peripheral that is not associated with the application associated with the container stored in memory of the vehicle system (because, in some embodiments, the peripheral is not associated with the application associated with the container stored in memory of the vehicle system).

In some embodiments, connecting the application to the peripheral via the communication bus includes obtaining (e.g., via a read operation and/or a listen operation) status data transmitted via the communication bus.

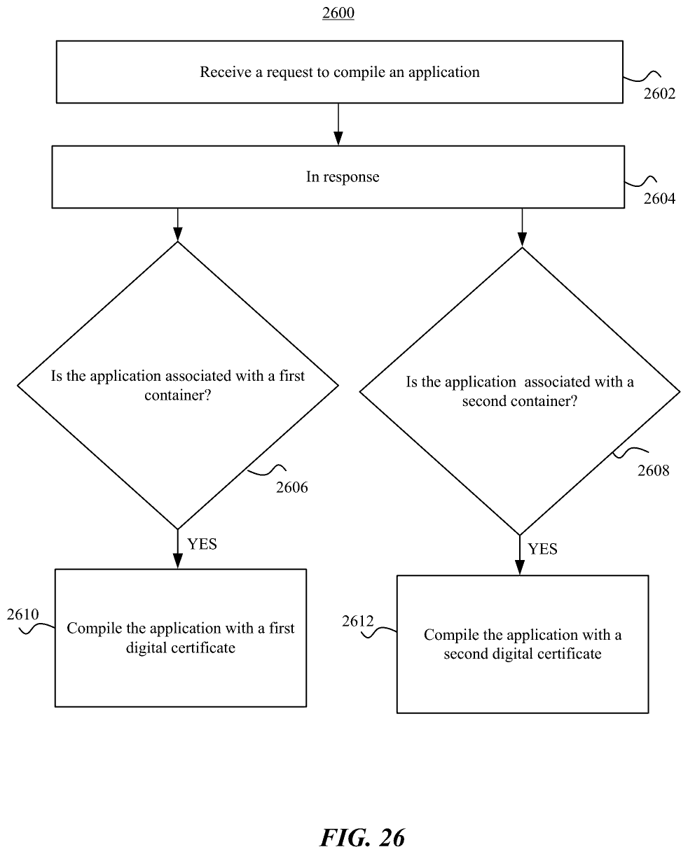

FIG. 26 is a flow diagram illustrating a method (e.g., method 2600) for compiling an application with one or more digital certificates for vehicle systems in accordance with some embodiments. In some embodiments, one or more operations described in reference to method 2600 are, optionally, combined, changed, and/or replaced by one or more operations. In some embodiments, the order of one or more operations described in reference to method 2600 are, optionally, changed. In some embodiments, one or more operations described in reference to method 2600 are optionally combined with one or more other methods and/or operations for one or more other methods described herein.

Method 2600 includes receiving (2602) a request to compile an application (e.g., in one or more software development environments and/or based on one or more software development kits) (e.g., as described above in relation to FIGS. 13-25).

Method 2600 includes, in response to (2604) the request to compile the application and according to (2606) a determination that the application should be associated with a first container of a vehicle system (e.g., as described above in relation to FIGS. 13-25) of a vehicle system (e.g., as described above in relation to FIGS. 13-25), compiling (2610) the application with a first digital certificate (e.g., as described above in relation to FIGS. 13-25).

Method 2600 includes, in response to (2604) the request to compile the application and according to (2608) a determination that the application should be associated with a second container (e.g., as described above in relation to FIGS. 13-25) of the vehicle system, different from the first container, compiling (2612) the application with a second digital certificate (e.g., as described above in relation to FIGS. 13-25) different from the first digital certificate.

In some embodiments, the first container is associated with (e.g., correspond to, stored with respect to, controls, and/or references) (e.g., includes and/or is granted via a separate manifest) the first digital certificate and not the second digital certificate, and wherein the second container is associated with the second digital certificate and not the first digital certificate.

In some embodiments, the application is associated with an application digital certificate that is different from the first digital certificate and the second digital certificate, and wherein the application digital certificate indicates a narrower set of permissions than at least one of the first digital certificate and the second digital certificate (e.g., includes and/or is granted via a separate manifest).

In some embodiments, method 2600 includes according to a determination that the application should be associated with the first container, generating (e.g., providing, displaying, outputting, and/or showing) a first set of one or more options (e.g., UI elements and/or outputting (e.g., audio, visual, and/or haptic) content) according to the first digital certificate. In some embodiments, method 2600 includes according to a determination that the application should be associated with the second container, generating a second set of one or more options according to the second digital certificate, wherein the first set of one or more options is different from (e.g., different in number, type, and/or kind) the second set of one or more options. In some embodiments, in response to detecting an input directed to a respective of one or more options, a digital certificate is changed.

In some embodiments, generating the first set of one or more options according to the first digital certificate includes displaying the first set of one or more options (e.g., via a display device, such as a display, touch sensitive display, and/or projector). In some embodiments, generating the second set of one or more options according to the second digital certificate includes displaying the second set of one or more options.

In some embodiments, determining that the application should be associated with the first container includes determining that the application is a first type of application (e.g., as described above). In some embodiments, determining that the application should be associated with the second container includes determining that the application is a second type of application different from the first type of application.

In some embodiments, compiling the application with the first digital certificate includes associating the first digital certificate with a first set of one or more permissions. In some embodiments, compiling the application with the second digital certificate includes associating the second digital certificate with a second set of one or more permissions different from the first set of one or more permissions (e.g., as described above in relation to FIGS. 13-25).

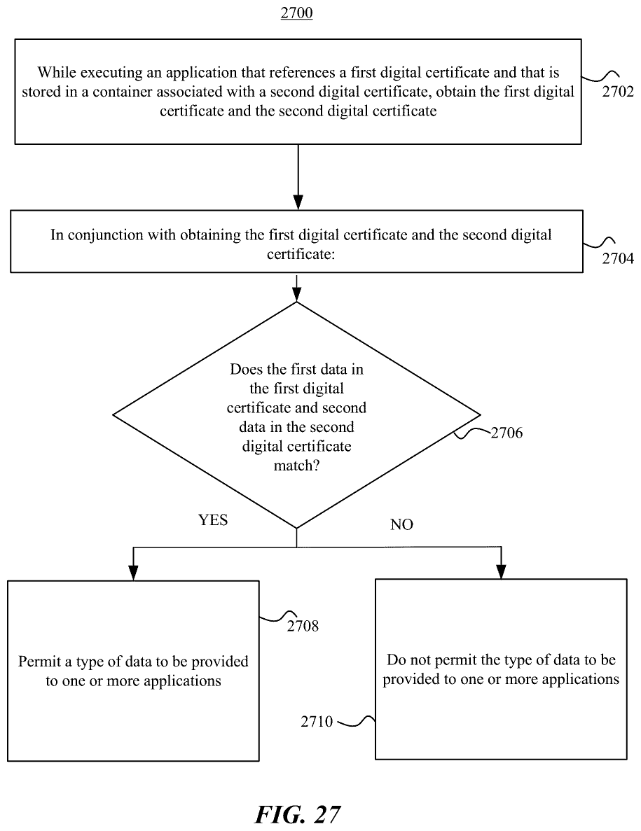

FIG. 27 is a flow diagram illustrating a method (e.g., method 2700) for managing multiple digital certificates for vehicle systems in accordance with some embodiments. In some embodiments, one or more operations described in reference to method 2700 are, optionally, combined, changed, and/or replaced by one or more operations. In some embodiments, the order of one or more operations described in reference to method 2700 are, optionally, changed. In some embodiments, one or more operations described in reference to method 2700 are optionally combined with one or more other methods and/or operations for one or more other methods described herein.

Method 2700 includes, while executing (2702) an application (e.g., as described above in relation FIGS. 13-26) that corresponds to (e.g., references, indicates and/or points to, is pointed to by, is indicated in, and/or is referred in) a first digital certificate and that is stored in a container associated with a second digital certificate different from the first digital certificate, obtaining the first digital certificate and the second digital certificate.

Method 2700 includes, in conjunction with obtaining (2704) the first digital certificate and the second digital certificate and according to (2706) a determination that first data (e.g., all and/or a portion of) in the first digital certificate and second data (e.g., all and/or a portion of) in the second digital certificate matches (e.g., within a certain threshold and/or confidence interval), permitting (2708) (sending, transmitting, and/or not preventing) a type of data (e.g., as described above in relation to FIGS. 13-25) to be provided to one or more applications.

Method 2700 includes, in conjunction with obtaining (2704) the first digital certificate and the second digital certificate and according to (2706) a determination that first data in the first digital certificate and second data in the second digital certificate do not match, forgoing permitting (2710) the type of data to be provided to one or more applications.

In some embodiments, the first data includes first version data (e.g., data that specifies that the digital certificate is a particular version, has been updated (e.g., a major update and/or a minor update) and/or revised (e.g., to include and/or exclude one or more features and/or capabilities allowed by and/or noted as being allowed by the digital certificate)). In some embodiments, the second data includes second version data. In some embodiments, the first version data is different from the second version data.

In some embodiments, the determination of whether (or not) the first data in the first digital certificate and second data in the second digital certificate matches (e.g., within a certain threshold and/or confidence interval) occurs at a first manifesto layer (e.g., of a vehicle system and/or operating system) (e.g., as described above in relation to FIGS. 13-14).

In some embodiments, permitting (sending, allowing, transmitting, and/or not preventing) the type of data to be provided to one or more applications includes permitting the application (and/or one or more applications) to read the type of data from a first communication bus (e.g., as described above in relation to FIGS. 13-22).

In some embodiments, permitting (sending, allowing, transmitting, and/or not preventing) the type of data to be provided to one or more applications includes permitting the application (and/or one or more applications) to write (and, in some embodiments, write the type of data to) a second communication bus (e.g., as described above in relation to FIGS. 13-22).

In some embodiments, method 2700 includes according to a determination that first data in the first digital certificate and second data in the second digital certificate do not match, initiating a process to re-install (and/or install for the first time and/or while an instance is not initially stored on a vehicle system, remove, or re-configure) the application (and/or one or more applications).

In some embodiments, the application is being executed at a vehicle system (and/or operating system) that includes a second manifesto layer. In some embodiments, according to a determination that first data in the first digital certificate and second data in the second digital certificate do not match, method 2700 includes initiating a process to update the second manifesto layer from a previous state (e.g., configuration, arrangement, and/or set in a certain manner) to a new state (and/or updating the manifesto layer from the previous state to a new state).

In some embodiments, the first digital certificate includes an indication that the first data is permitted (or not permitted and/or restricted) (e.g., as described above in relation to FIGS. 13-26). In some embodiments, the second digital certificate includes an indication that the second data is permitted (or not permitted and/or restricted) (e.g., as described above in relation to FIGS. 13-26). In some embodiments, the type of data is permitted by both certificates, and would otherwise be permissible, in some embodiments, except for mismatched timestamp/versioning.

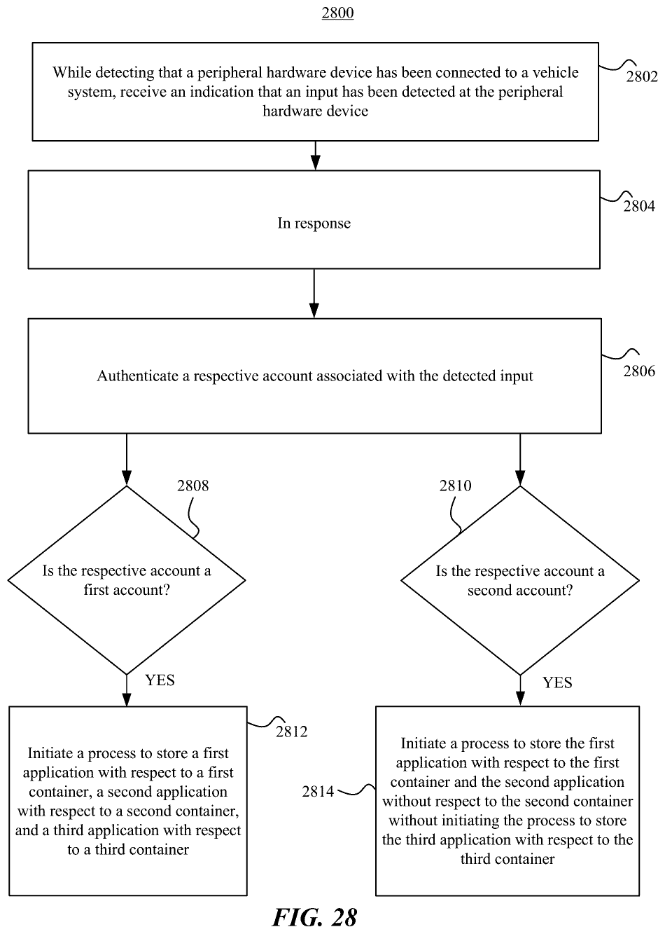

FIG. 28 is a flow diagram illustrating a method (e.g., method 2800) for connecting a peripheral to vehicle systems in accordance with some embodiments. In some embodiments, one or more operations described in reference to method 2800 are, optionally, combined, changed, and/or replaced by one or more operations. In some embodiments, the order of one or more operations described in reference to method 2800 are, optionally, changed. In some embodiments, one or more operations described in reference to method 2800 are optionally combined with one or more other methods and/or operations for one or more other methods described herein.

Method 2800 includes, while detecting that a peripheral hardware device (e.g., as described above in relation to FIGS. 13-27) has been connected to a vehicle system, obtaining (2802) an indication (e.g., as described above in relation to FIGS. 13-27) that an input has been detected at the peripheral hardware device.

Method 2800 includes, in response to (2804) obtaining the indication that the input has been detected at the peripheral hardware device, authenticating (2806) a respective account associated with the detected input.

Method 2800 includes, in response to (2804) obtaining the indication that the input has been detected at the peripheral hardware device and according to (2808) a determination that the respective account is a first account, initiating (2812) a process to store a first application with respect to (e.g., as described above in relation to FIG. 13) a first container, a second application with respect to a second container, and a third application with respect to a third container, wherein the first container, the second container, and the third container are different. In some embodiments, multiple applications of the same type are stored in and/or with respect to a single container.

Method 2800 includes, in response to (2804) obtaining the indication that the input has been detected at the peripheral hardware device and according to (2810) a determination that the respective account is a second account, different from the first account, initiating (2814) a process to store the first application with respect to the first container and the second application with respect to the second container without initiating the process to store the third application with respect to the third container. In some embodiments, initiating a process to store an application includes storing an application.

In some embodiments, the peripheral hardware device is a biometric reader, and wherein authenticating the respective account associated with the detected input includes determining whether biometric data detected via the biometric reader matches (e.g., within a certain threshold and/or confidence interval) stored biometric data (e.g., known biometric data and/or biometric data that was previously collected and/or is stored for authentication purposes).

In some embodiments, the peripheral hardware device is a first peripheral hardware device. In some embodiments, method 2800 includes detecting that a second peripheral hardware device has been connected to the vehicle system. In some embodiments, the second peripheral hardware device is detected as being connected to the vehicle system after (or before) initiating the process to store and/or after (or before) storing the first application with respect to the first container, the second application with respect to the second container, and the third application with respect to the third container. In some embodiments, method 2800 includes, while detecting that the second peripheral hardware device has been connected to the vehicle system, obtaining an indication that an input has been detected at the second peripheral hardware device. In some embodiments, method 2800 includes, in response to obtaining the indication that the input has been detected at the second peripheral hardware device and according to a determination that the respective account is a third account (e.g., the first account or another account), initiating a second process to store the first application with respect to (e.g., as described above in relation to FIG. 13) the first container, the second application with respect to the second container, and the third application with respect to the third container (and/or storing the first application with respect to the first container, the second application with respect to the second container, and the third application with respect to the third container). In some embodiments, according to a determination that the respective account is an account that is different from the third account, the vehicle system initiates the process to store the first application with respect to the first container and the second application without respect to the second container without initiating the process to store the third application with respect to the third container and/or initiates a process to store one or more other combinations of one or more applications (e.g., the first application, the second application, the third application, and/or another application).

In some embodiments, the peripheral hardware device is a third peripheral hardware device. In some embodiments, method 2800 includes detecting that a fourth peripheral hardware device has been connected to the vehicle system. In some embodiments, the fourth peripheral hardware device is detected as being connected to the vehicle system after (or before) initiating the process to store and/or after (or before) storing the first application with respect to the first container, the second application with respect to the second container, and the third application with respect to the third container. In some embodiments, the fourth peripheral device is different from the third peripheral device. In some embodiments, method 2800 includes, while detecting that the fourth peripheral hardware device has been connected to the vehicle system, obtaining an indication that an input has been detected at the fourth peripheral hardware device. In some embodiments, method 2800 includes, in response to obtaining the indication that the input has been detected at the fourth peripheral hardware device and according to a determination that the respective account is a fourth account (e.g., the first account or another account), initiating a process store at least one application that is different from the first application, the second application, and third application without initiating the process to store the first application with respect to the first container, the second application with respect to the second container, and the third application with respect to the third container. In some embodiments, according to a determination that the respective account is a fourth account, the first application is stored with respect to the first container, the second application is stored with respect to the second container, or the third application is stored with respect to the third container (but, in some embodiments, not all of the respective applications (e.g., the first application, the second application, and/or third application) is stored with respect to a targeted container (e.g., first container, the second container, and/or the third container) according to a determination that the respective account is a fourth account.

In some embodiments, method 2800 includes, in response to receiving the indication that the input has been detected at the peripheral hardware device and according to a determination that the respective account is a second account, initiating a process to store a fourth application, different from the third application, with respect to (e.g., as described above in relation to FIG. 13) the third container.

In some embodiments, the third application is the same type of application as the fourth application. In some embodiments, the third application was developed by a first developer (and/or belongs to and/or owned by a first company) and not a second developer (and/or does not belong to and/or is not owned by a second company) and the fourth application was developed by the second developer (and/or belongs to and/or owned by the second company) and not the first developer (and/or does not belong to and/or is not owned by the first company).

In some embodiments, method 2800 includes, in response to receiving the indication that the input has been detected at the peripheral hardware device: according to a determination that the respective account is the first account, concurrently displaying a representation (e.g., an icon, a selectable user interface object, an application icon, text, an image, a selectable image, and/or selectable text) of the first application, a representation of the second application, and a representation of the third application; and according to a determination that the respective account is the second account, concurrently displaying the representation of the first application and the representation of the second application without displaying the representation of the third application.

In some embodiments, the vehicle system includes a plurality of vehicle hardware components that communicate via a communication bus, and wherein, while the third application is stored with respect to the third container, the third application communicates one or more instructions via the communication bus that causes a motion characteristic (e.g., speed, velocity, acceleration, and/or direction) of the vehicle system to change (and/or a state of the vehicle system to change (e.g., whether vehicle is on, off, transitioning to standby mode)).

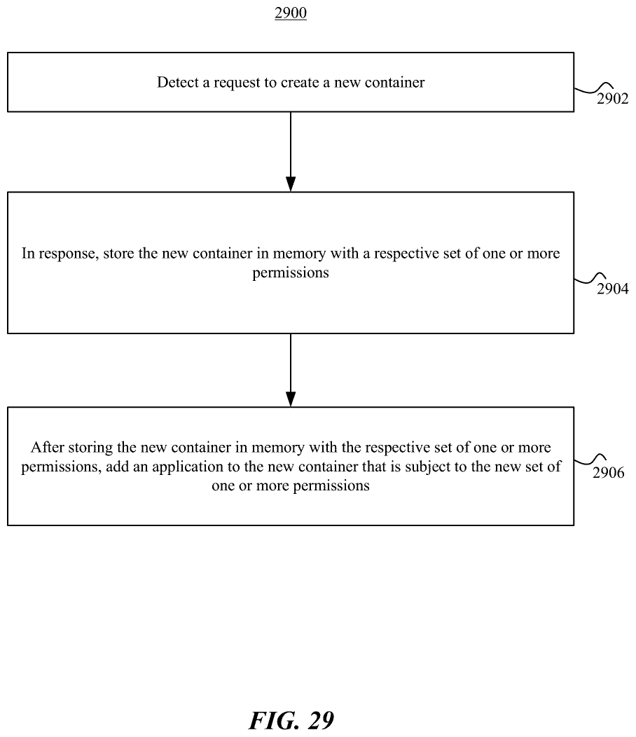

FIG. 29 is a flow diagram illustrating a method (e.g., method 2900) for creating a container in accordance with some embodiments. In some embodiments, one or more operations described in reference to method 2900 are, optionally, combined, changed, and/or replaced by one or more operations. In some embodiments, the order of one or more operations described in reference to method 2900 are, optionally, changed. In some embodiments, one or more operations described in reference to method 2900 are optionally combined with one or more other methods and/or operations for one or more other methods described herein.

Method 2900 is performed at a vehicle system that includes memory storing an operating system and one or more containers, wherein each of the one or more containers include one or more applications and has at least one set of one or more permissions.

Method 2900 includes detecting (2902) a request to create a new container (e.g., from a third-party application, from a first party application, from third party servers, and/or from first party servers).

Method 2900 includes, in response to detecting the request to create the new container, storing (2904) the new container in memory with a respective set of one or more permissions, wherein the respective set of one or more permissions is different from each of the at least one set of one or more permissions corresponding to the one or more containers/

Method 2900 includes, after storing the new container in memory with the respective set of one or more permission, adding (2906) (e.g., installing, storing, downloading, and/or uploading) an application to the new container that is subject to the new set of one or more permissions. In some embodiments, detecting the request to create the new container includes detecting a request to install and/or download the application that is added to the new container.

In some embodiments, the set of one or more permissions are indicated (e.g., defined in and/or included in) via a digital certificate stored with respect to (e.g., as described above in relation to FIG. 13) (e.g., referencing, as a part of, controlling, and/or identifying) the container.

In some embodiments, the memory includes a manifesto layer that controls whether (or not) one or more operations are permitted to be performed based on the set of one or more permissions (e.g., as described above in relation to FIGS. 13-28).

In some embodiments, storing the new container in memory with the respective set of one or more permissions includes overwriting (e.g., deleting old and installing new and/or replacing) a previous set of permissions corresponding to a first previously existing container. In some embodiments, the vehicle system responds to at least one application differently after the previous set of permissions has been overwritten by the respective set of one or more permissions.

In some embodiments, detecting the request to create the new container includes detecting an input (e.g., a rotation of a hardware input mechanism (e.g., a rotatable dial and/or a button), voice input, a gesture, an air gesture, a gaze input, and/or a touch input) directed to a portion of the vehicle system. In some embodiments, the request to create the new container is pushed from a server (and/or company) to the vehicle system (and, in some embodiments, detecting the request does not include detecting an input directed to a portion of the vehicle system).

In some embodiments, storing the new container in memory with the respective set of one or more permissions includes overwriting (and/or deleting old and installing new) at least a portion of a first previously stored container. In some embodiments, the existing container is the same type of container as the new container.

In some embodiments, storing the new container in memory with the respective set of one or more permissions does not include overwriting and/or deleting old and installing new) at least a portion of a second previously stored container (and/or no container is overwritten and/or changed). In some embodiments, the new container is a different type of container than the second previously stored container.

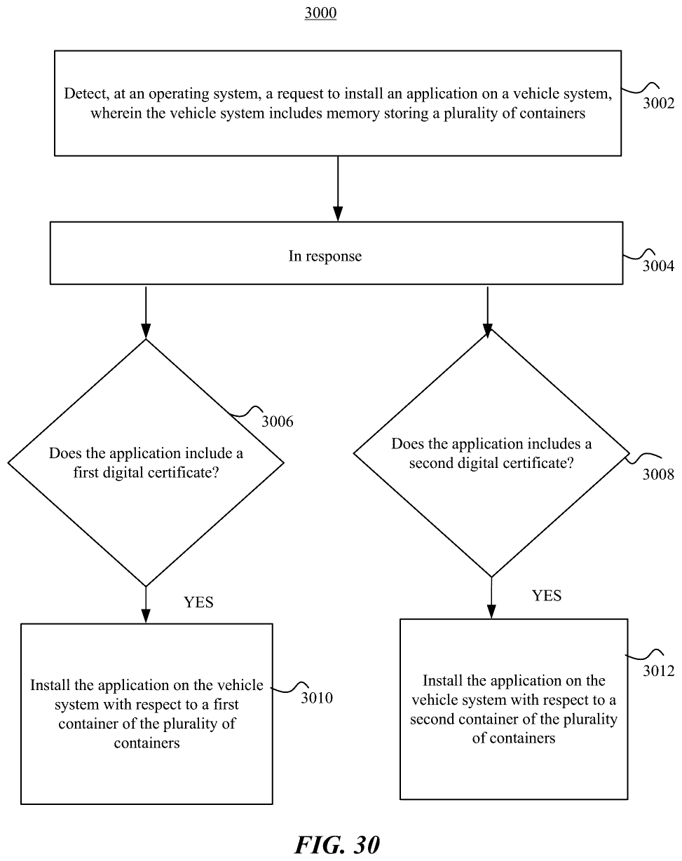

FIG. 30 is a flow diagram illustrating a method (e.g., method 3000) for installing one or more applications for vehicle systems in accordance with some embodiments. In some embodiments, one or more operations described in reference to method 3000 are, optionally, combined, changed, and/or replaced by one or more operations. In some embodiments, the order of one or more operations described in reference to method 3000 are, optionally, changed. In some embodiments, one or more operations described in reference to method 3000 are optionally combined with one or more other methods and/or operations for one or more other methods described herein.

Method 3000 includes detecting (3002), at an operating system (e.g., as described above in relation to FIG. 13), a request to install an application (e.g., as described above in relation to FIGS. 13-19) on a vehicle system (e.g., as described above in relation to CS1), wherein the vehicle system includes memory storing a plurality of containers.

Method 3000 includes in response to (3004) detecting the request to install the application on the vehicle system and according to (3006) a determination that the application corresponds to a first digital certificate, installing (3010) (and/or downloading or uploading) the application on the vehicle system with respect to (e.g., as described above in relation to FIG. 13) a first container of the plurality of containers.

Method 3000 includes in response to (3004) detecting the request to install the application on the vehicle system and according to (3008) a determination that the application corresponds to a second digital certificate, different from the first digital certificate, installing (3012) the application on the vehicle system with respect to a second container, different from the first container, of the plurality of containers.

In some embodiments, the application includes the first digital certificate when the application is a first application type, and the first digital certificate is associated with the first application type. In some embodiments, the application includes the second digital certificate when the application is a second application type, different from the first application type, and the second digital certificate is associated with the second application type.

In some embodiments, the first digital certificate corresponds to the first container (and not the second container). In some embodiments, the second digital certificate corresponds to the second container (and not the first container).

In some embodiments, the application corresponds to the first digital certificate. In some embodiments, the application corresponds to a third digital certificate different from the first digital certificate. In some embodiments, the first digital certificate is a container level digital certificate. In some embodiments, the third digital certificate is an application level digital certificate. In some embodiments, the first digital certificate is the application level digital certificate, and the third digital certificate is the container level digital certificate.

In some embodiments, while the application is installed on the vehicle system with respect to the first container of the plurality of containers, the computer system receives a request to perform an operation from the application. In some embodiments, in response to receiving the request to perform the operation from the application: according to a determination that the first digital certificate (and, in some embodiments, irrespective of the second digital certificate or another digital certificate) indicates that the operation is permitted to be performed, performing the operation; and according to a determination that the first digital certificate does not indicate that the operation is permitted to be performed, forgoing performing the operation.

In some embodiments, the application is a first application. In some embodiments, while the application is installed on the vehicle system with respect to (e.g., as described above in relation to FIG. 13) the first container of the plurality of containers, method 3000 includes detecting a request to install a second application, different from the first application, on the vehicle system. In some embodiments, method 3000 includes, in response to detecting the request to install the second application and according to a determination that the second application is associated with the first digital certificate, installing the application on the vehicle system with respect to the first container. In some embodiments, method 3000 includes, in response to detecting the request to install the second application and according to a determination that the second application is associated with the second digital certificate, installing the application on the vehicle system with respect to the second container. In some embodiments, a vehicle system and/or computer system installs a respective application and stores the respective application in same container as the first application. In some embodiments, the respective application and the first application is permitted to perform the same type of operations. In some embodiments, a vehicle system and/or computer system installs a respective application and stores the respective application in a different container as the first application. In some embodiments, the respective application and the first application is permitted to perform different types of operations (e.g., based on them being associated with different digital certificate (e.g., container level digital certificates and/or application level digital certificates).

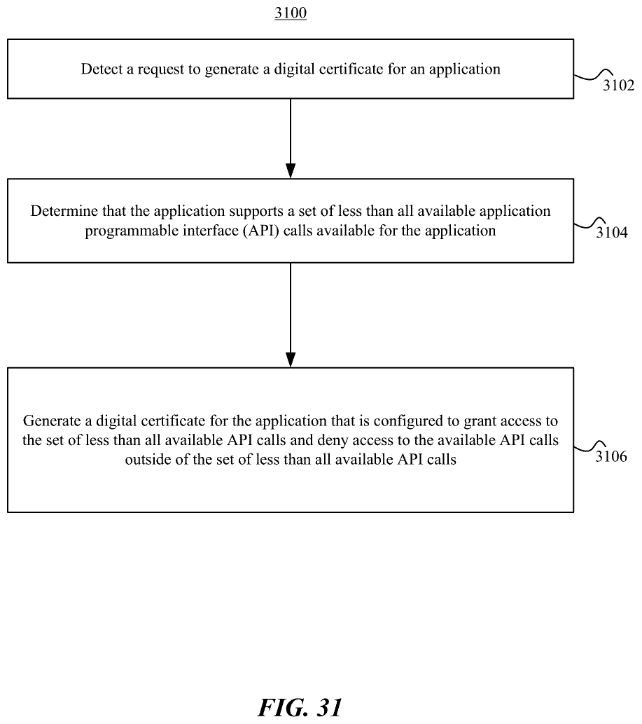

FIG. 31 is a flow diagram illustrating a method (e.g., method 3100) for generating one or more digital certificates for vehicle systems in accordance with some embodiments. In some embodiments, one or more operations described in reference to method 3100 are, optionally, combined, changed, and/or replaced by one or more operations. In some embodiments, the order of one or more operations described in reference to method 3100 are, optionally, changed. In some embodiments, one or more operations described in reference to method 3100 are optionally combined with one or more other methods and/or operations for one or more other methods described herein.

Method 3100 includes detecting (3102) (e.g., at and/or in a software development environment and/or as a part of using a software development kit) a request to generate a digital certificate for an application.

Method 3100 includes determining (3104) that the application supports a set of less than all application programmable interface calls available for the application.

Method 3100 includes, in response to determining that the application supports the set of less than all application programmable interface (API) calls available for the application, generating (3106) a digital certificate for the application that is configured to grant access to the set of less than all API calls available for the application and deny access to one or more API calls outside of the set of less than the API calls available for the application.

In some embodiments, an amount of API calls available for the application is associated with a container, and wherein the application is configured to be (will be and/or currently is) stored with respect to (e.g., as described above in relation to FIG. 13) the container.

In some embodiments, according to a determination that the application is a first application type (e.g., and/or associated with) (e.g., stored with respect to and/or configured to be stored with respect to a first container), a respective amount of API calls available for the application is a first amount (and/or or kind and/or type). In some embodiments, according to a determination that the application is a second application type, different from the first application type, the respective amount of API calls available for the application is a second amount different from the first amount.

In some embodiments, a first API call of the API calls available for the application is associated with a first data stream that includes data corresponding to a first vehicle component. In some embodiments, a second API call, different from the first API call, of the API calls available for the application is associated with a second data stream that includes data corresponding to a second vehicle component different from the first vehicle component. In some embodiments, first API call is not associated with the second data stream, the second vehicle component, and/or data corresponding to the second vehicle component. In some embodiments, second API call is not associated with the first data stream, the first vehicle component, and/or data corresponding to the first vehicle component.

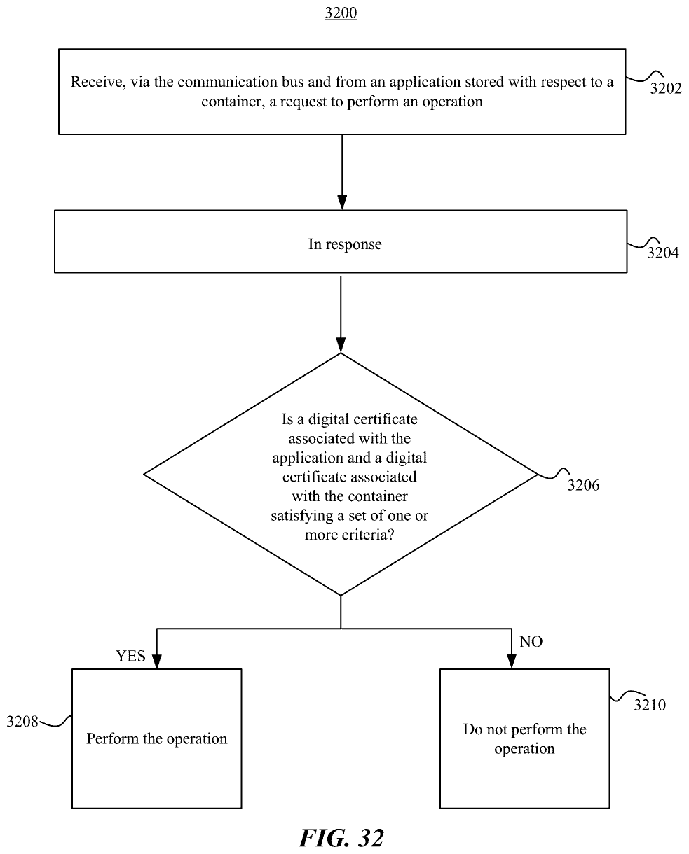

FIG. 32 is a flow diagram illustrating a method (e.g., method 3200) for managing one or more digital certificates for vehicle systems in accordance with some embodiments. In some embodiments, one or more operations described in reference to method 3200 are, optionally, combined, changed, and/or replaced by one or more operations. In some embodiments, the order of one or more operations described in reference to method 3200 are, optionally, changed. In some embodiments, one or more operations described in reference to method 3200 are optionally combined with one or more other methods and/or operations for one or more other methods described herein.

In some embodiments, method 3200 is performed at an operating system (e.g., as described above in relation to FIG. 13) of a vehicle system (e.g., as described above in relation to FIG. 13), wherein the vehicle system includes a communication bus and a container (e.g., as described above in relation to FIG. 13).

Method 3200 includes receiving (3202), via the communication bus and from an application (e.g., as described above in relation to FIG. 13) stored with respect to (e.g., as described above in relation to FIG. 13) the container (e.g., as described above in relation to FIG. 13), a request to perform an operation (e.g., as described above in relation to FIGS. 13-31).

Method 3200 includes, in response to (3204) receiving the request to perform the operation and according to (3206) a determination that a digital certificate (e.g., as described above in relation to FIG. 13) associated with the application and a digital certificate associated with the container satisfy a set of one or more criteria (e.g., whether the operation is permitted and/or not permitted by and/or as indicated by a respective digital certificate), performing (3208) the operation (e.g., as described above in relation to FIG. 13).

Method 3200 includes, in response to (3204) receiving the request to perform the operation and according to (3206) a determination that the digital certificate associated with the application and the digital certificate associated with the container does not satisfy the set of one or more criteria, forgoing performing (3210) the operation (e.g., as described above in relation to FIG. 13).

In some embodiments, performing the operation includes obtaining data (e.g., as described above in relation to FIGS. 13-31) from the communication bus (and, in some embodiments, sending the obtained data to the application and/or allowing the application to read from the communication bus).

In some embodiments, performing the operation includes writing data to the communication bus (and, in some embodiments, writing data to the communication bus based on one or more instructions and/or data sent from the application and/or allowing the application to write to the communication bus).

In some embodiments, method 3200 includes, in response to receiving the request to perform the operation and according to a determination that the digital certificate associated with the container does not satisfy the set of one or more criteria, forgoing performing the operation (e.g., irrespective of whether the digital certificate associated with the application satisfies the set of one or more criteria).

In some embodiments, method 3200 includes, in response to receiving the request to perform the operation and according to a determination that the digital certificate associated with the application does not satisfy the set of one or more criteria, forgoing performing the operation (e.g., irrespective of whether the digital certificate associated with the container satisfies the set of one or more criteria).

In some embodiments, method 3200 includes, in response to receiving the request to perform the operation and according to a determination that the digital certificate associated with the application does not satisfy the set of one or more criteria and the digital certificate associated with the container satisfies the set of one or more criteria, performing the operation.

In some embodiments, method 3200 includes, in response to receiving the request to perform the operation and according to a determination that the digital certificate associated with the application satisfies the set of one or more criteria and the digital certificate associated with the container does not satisfy the set of one or more criteria, forgoing performing the operation.

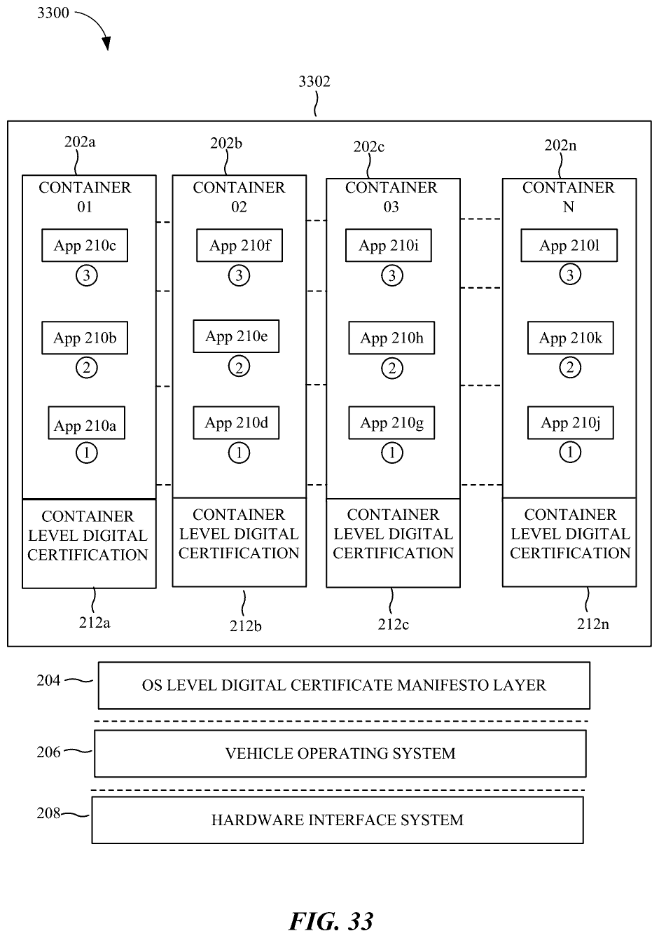

FIG. 33 is a system architecture diagram for an in-vehicle computer system of a vehicle in accordance with some embodiments. As illustrated in FIG. 33, components of in-vehicle computer system 3300 include vehicle operating system (OS) 206, hardware interface system 208, containers 202a-202n, container level digital certifications 212a-212n, applications 210a-2101 (e.g., each application running within one of containers 202a-202n), and digital certificate manifesto layer 204. In some embodiments, one or more of these components operate and/or have one or more characteristics as described above in relation to FIG. 2.

At FIG. 33, in-vehicle computer system 3300 also includes master container 3302, where containers 202a-202n are sub-containers of master container 3302. As sub-containers, an application and/or process running in one of containers 202a-202n do not have access to other applications, processes, and/or technical bandwidth (e.g., memory and/or storage) (e.g., compute resources) for another of containers 202a-202n. In some embodiments, the total amount of usable technical bandwidth for containers 202a-202n is constrained by, is less than, and/or is equal to the bandwidth of master container 3302. In some embodiments, master container 3302 manages vehicle telemetry data and transmits vehicle telemetry data and/or operations that are performed based on vehicle telemetry data between a CAN bus and an individual sub-container.

One or more processes corresponding to (e.g., stored with respect to, stored as referencing, associated with, running with respect to, and/or running inside of) master container 3302, at FIG. 33, controls resources allocated to each of containers 202a-202n. In some embodiments, the one or more processes corresponding to master container 3302 includes a set of one or more removal processes that removes one of containers 202a-202n. In some embodiments, the set of one or more removal processes causes one of containers 202a-202n to be removed when an application is not stored with respect to the removed container (e.g., before the removal of the container). In some embodiments, the set of one or more removal processes causes one of containers 202a-202n to be removed when a determination is made that one or more applications are lowered priority (e.g., mission critical applications versus non-mission critical applications) than one or more applications corresponding to a different container. In some embodiments, the set of one or more removal processes causes one of containers 202a-202n to be removed when the in-vehicle system is experiencing bandwidth constraints, such as more than an amount of memory is being used or an amount of storage is being used (e.g., 80-100%). In some embodiments, the set of one or more removal processes causes one of containers 202a-202n to be removed when multiple conditions are met (e.g., lowered priority application and bandwidth constraint conditions occur). In some embodiments, the one or more processes corresponding to master container 3302 includes a set of one or more creation processes that create a new container inside of master container 3302. In some embodiments, the new container (e.g., one of containers 202a-202n or a different container) is created when a determination is made that a new application should be installed on the in-vehicle system corresponds to the new container (and the new container currently does not exist on the in-vehicle system).

In some embodiments, in-vehicle computer system 3300 adjusts one or more types of technical bandwidth based on the operation of one or more applications corresponding to containers 202a-202n in real-time. In some embodiments, in-vehicle computer system 3300 adjusts one or more types of technical bandwidth when a determination is made that a container running a resource intensive application needs additional bandwidth, when a determination is made that a container running a less resource intensive applications needs less bandwidth, and/or when a determination is made that additional bandwidth should be allocated to a container running a mission critical application (e.g., based on time, state of the vehicle, and/or one or more other context).

In some embodiments, in-vehicle computer system 3300 can add a new container, remove an existing container, and/or adjust technical bandwidth between containers based on the overall technical bandwidth and/or system resources exceeding and/or being lower than certain limits (e.g., maximum/minimum remaining technical bandwidth, such as memory and/or storage), based on whether a container has a popular application (e.g., among a community of individuals), a recency of application use (e.g., most or least recently used application), a frequency of application use (e.g., most or least frequently used application), a designation that an application is a preferred application (e.g., that has been set by a user or an OEM), based on system context (e.g., speed of vehicle, location of vehicle, operating status of vehicle (e.g., on, off, and/or idle)), and/or user preferences associated with the vehicle (e.g., could need insurance container all of the time but may only need toll payment container in certain situations; and/or could need application related to one state (e.g., applications for police departments, medical facilities, and/or other state emergency departments) only while traveling in the state).

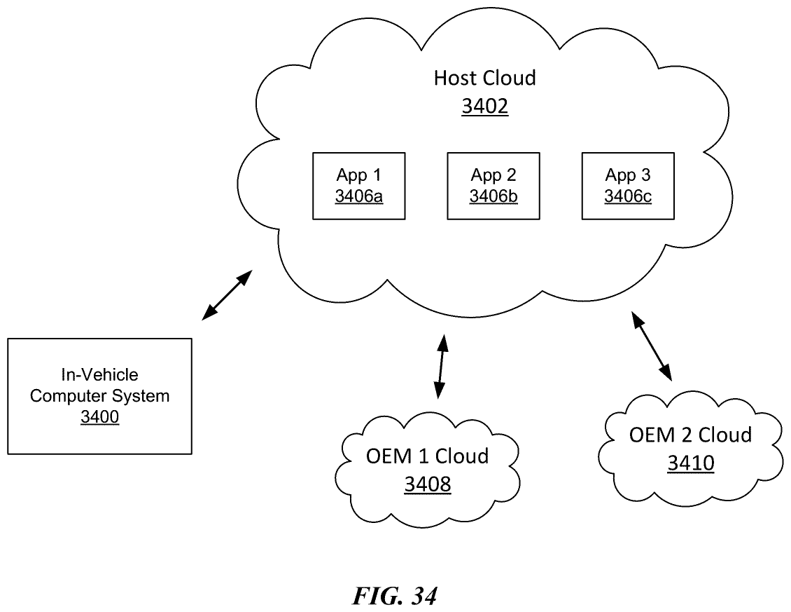

FIG. 34 is a system communication diagram in accordance with some embodiments.

FIG. 34 illustrates in-vehicle computer system 3400, which includes one or more components of in-vehicle computer system 200 and/or in-vehicle computer system 3300 described above. In addition, FIG. 34 illustrates host cloud 3402, OEM cloud 3408, and OEM cloud 3410. Host cloud 3402 includes application 3406a, application 3406b, and application 3406c, where each application is not associated with the same container. Applications 3406a-3406c can be many different applications, such as an insurance provider application, a rental car application, a delivery service application, a vehicle maintenance application, and/or a mission critical application.

Host cloud 3402, OEM cloud 3408, and/or OEM cloud 3410 are cloud servers and/or services. In some embodiments, one or more of the cloud services and/or services include one or more processes or techniques provided by Amazon AWS®, Microsoft Azure®, Google Cloud®, and/or another type of cloud service provider. In some embodiments, host cloud 3402 is operated by the same entity as OEM cloud 3408 and/or OEM cloud 3410. In some embodiments, OEM cloud 3408 is operated by an OEM that is different from the OEM that operates OEM cloud 3410. In some embodiments, other clouds owned by different operators exist, such as an insurance provider cloud and/or a service provider cloud (e.g., pest control service, valet service, and/or a delivery service cloud). In some embodiments, these other clouds operate similarly to (or different from) OEM cloud 3408 and/or OEM cloud 3410.

In some embodiments, in-vehicle computer system 3400 sends a request to download an application to host cloud 3402. In some embodiments, the request to download an application is sent based on one or more inputs (e.g., voice inputs, touch inputs, mouse inputs, and/or air gesture inputs) from a user using a head unit in a vehicle and/or using in-vehicle computer system 3400 (e.g., which may be embodied in the vehicle head unit). In some embodiments, the request is sent after detecting that the in-vehicle computer system 3400 has turned on, is turning on for the first time, and/or is being configured to be used with a new user.

In some embodiments, after receiving the request to download an application, host cloud 3402 sends a request to OEM cloud 3408 or OEM cloud 3410. In some embodiments, the OEM cloud that the request is routed to is based on one or more identifiers associated with in-vehicle computer system 3400. In some embodiments, the request to download the application includes one or more identifiers associated with in-vehicle computer system 3400, such as a VIN. In some embodiments, the request to download the application does not include one or more personal credentials associated with a user of the vehicle, such as the user's name, address, social security number, and/or other personal information.

In some embodiments, after the OEM cloud provider (e.g., OEM cloud 3408 or 3410) receives the request, the OEM cloud provider looks up information associated with the one or more identifiers associated with in-vehicle computer system 3400. In some embodiments, after looking up the information, the OEM cloud provider sends a list of applications that can be downloaded onto in-vehicle computer system 3400. In some embodiments, the OEM cloud provider does not send personal information associated with a user of the vehicle (e.g., that was not sent to OEM cloud provider by host cloud 3402). Thus, in some embodiments, host cloud 3402 cannot readily ascertain the user of the vehicle.

In some embodiments, after receiving the list of applications, host cloud 3402 causes one or more applications (e.g., one or more applications 3406a-3406c) to be installed on in-vehicle computer system 3400, where each respective application is installed in a respective container that corresponds to the respective application. In some embodiments, host cloud 3402 associated the list of applications (and/or the creators and/or businesses associated with the applications) with in-vehicle computer system 3400 (e.g., via a log and/or a database). In some embodiments, host cloud 3402 communicates with the OEM cloud provider to indicate whether installation of an application was successful or not successful. In some embodiments, to communicate with the OEM cloud provider to indicate whether installation of an application was successful or not successful, host cloud 3402 also sends one or more vehicle identifiers. It should be understood that the OEM cloud provider does not need to host particular applications that are installed in a container on in-vehicle computer system 3400. Rather, these applications can be hosted by a host cloud server, where one version of an application, such as an insurance application, can be downloaded to vehicles made by different OEM providers and, in some embodiments, without the sharing of personal information of a user and/or without the host cloud provider receiving personal information of a user (e.g., except for vehicle identifying information, such as a make, model, and/or VIN).

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1-11. (canceled)

12. A vehicle system, comprising:
one or more processors; and
memory storing one or more programs configured to be executed by the one or more processors, the one or more programs including instructions for:
obtaining an identifier corresponding to a vehicle system and a request to activate an application; and
in response to obtaining the identifier corresponding to the vehicle system and the request to activate the application:
according to a determination that the application is a first type of application, storing, via the vehicle system, the application in a manner that corresponds to a first container, wherein the first container corresponds to a first set of one or more permissions; and
according to a determination that the application is a second type of application, different from the first type of application, storing, via the vehicle system, the application in a manner that corresponds to a second container, different from the first container, wherein the second container corresponds to a second set of one or more permissions different from the first set of one or more permissions.

13. The vehicle system of claim 12, wherein the identifier corresponding to the vehicle system is a vehicle identifier number (VIN).

14. The vehicle system of claim 12, wherein the vehicle system includes a communication bus, the one or more programs further including instructions for:
while the application is stored in the manner that corresponds to the first container, receiving, from the application, a request to perform an operation via the communication bus; and
in response to receiving the request to perform the operation via the communication bus:
according to a determination that the first set of one or more permissions is in a first state with respect to performance of the operation, permitting transmission of data between the application and the communication bus; and
according to a determination that the first set of one or more permissions is in a second state, different from the first state, with respect to performance of the operation, forgoing permitting transmission of data between the application and the communication bus.

15. The vehicle system of claim 14, wherein:
the operation is a write operation;
the first set of one or more permissions is in the first state when a determination is made that the write operation is a first type of write operation; and
the second set of one or more permissions is in the second state, different from the first state, when a determination is made that the write operation is a second type of write operation different from the first type of write operation.

16. The vehicle system of claim 12, wherein performance of the write operation causes the vehicle system to perform a vehicle operation.

17. A non-transitory computer-readable storage medium storing one or more programs configured to be executed by one or more processors, the one or more programs including instructions for:
obtaining an identifier corresponding to a vehicle system and a request to activate an application; and
in response to obtaining the identifier corresponding to the vehicle system and the request to activate the application:
according to a determination that the application is a first type of application, storing, via the vehicle system, the application in a manner that corresponds to a first container, wherein the first container corresponds to a first set of one or more permissions; and
according to a determination that the application is a second type of application, different from the first type of application, storing, via the vehicle system, the application in a manner that corresponds to a second container, different from the first container, wherein the second container corresponds to a second set of one or more permissions different from the first set of one or more permissions.

18. The non-transitory computer-readable storage medium of claim 17, wherein the identifier corresponding to the vehicle system is a vehicle identifier number (VIN).

19. The non-transitory computer-readable storage medium of claim 17, wherein the vehicle system includes a communication bus, the one or more programs further including instructions for:
while the application is stored in the manner that corresponds to the first container, receiving, from the application, a request to perform an operation via the communication bus; and
in response to receiving the request to perform the operation via the communication bus:
according to a determination that the first set of one or more permissions is in a first state with respect to performance of the operation, permitting transmission of data between the application and the communication bus; and
according to a determination that the first set of one or more permissions is in a second state, different from the first state, with respect to performance of the operation, forgoing permitting transmission of data between the application and the communication bus.

20. The non-transitory computer-readable storage medium of claim 19, wherein:
the operation is a write operation;
the first set of one or more permissions is in the first state when a determination is made that the write operation is a first type of write operation; and
the second set of one or more permissions is in the second state, different from the first state, when a determination is made that the write operation is a second type of write operation different from the first type of write operation.

21. The non-transitory computer-readable storage medium of claim 17, wherein performance of the write operation causes the vehicle system to perform a vehicle operation.

22. A method, comprising:
obtaining an identifier corresponding to a vehicle system and a request to activate an application; and
in response to obtaining the identifier corresponding to the vehicle system and the request to activate the application:
according to a determination that the application is a first type of application, storing, via the vehicle system, the application in a manner that corresponds to a first container, wherein the first container corresponds to a first set of one or more permissions; and
according to a determination that the application is a second type of application, different from the first type of application, storing, via the vehicle system, the application in a manner that corresponds to a second container, different from the first container, wherein the second container corresponds to a second set of one or more permissions different from the first set of one or more permissions.

23. The method of claim 22, wherein the identifier corresponding to the vehicle system is a vehicle identifier number (VIN).

24. The method of claim 22, wherein the vehicle system includes a communication bus, the method further comprising:
while the application is stored in the manner that corresponds to the first container, receiving, from the application, a request to perform an operation via the communication bus; and
in response to receiving the request to perform the operation via the communication bus:
according to a determination that the first set of one or more permissions is in a first state with respect to performance of the operation, permitting transmission of data between the application and the communication bus; and
according to a determination that the first set of one or more permissions is in a second state, different from the first state, with respect to performance of the operation, forgoing permitting transmission of data between the application and the communication bus.

25. The method of claim 24, wherein:
the operation is a write operation;
the first set of one or more permissions is in the first state when a determination is made that the write operation is a first type of write operation; and
the second set of one or more permissions is in the second state, different from the first state, when a determination is made that the write operation is a second type of write operation different from the first type of write operation.

26. The method of claim 22, wherein performance of the write operation causes the vehicle system to perform a vehicle operation.
